(19) United States
(12) Patent Application Publication
(10) Pub. No.: US 2025/0226451 A1
(43) Pub. Date: Jul. 10, 2025

(54) LITHIUM-ION BATTERY

(71) Applicant: SEMICONDUCTOR ENERGY LABORATORY CO., LTD., Atsugi-shi, Kanagawa-ken (JP)

(72) Inventors: Daichi HIGO, Atsugi, Kanagawa (JP); Fumiko TANAKA, Atsugi, Kanagawa (JP); Kazuya SHIMADA, Atsugi, Kanagawa (JP); Shotaro MURATSUBAKI, Hachioji, Tokyo (JP); Kaori OGITA, Isehara, Kanagawa (JP); Kazutaka KURIKI, Ebina, Kanagawa (JP); Kunihiko SUZUKI, Kawasaki, Kanagawa (JP)

(21) Appl. No.: 18/849,321

(22) PCT Filed: Mar. 14, 2023
(86) PCT No.: PCT/IB2023/052424

§ 371 Date: Sep. 20, 2024

(30) Foreign Application Priority Data
Mar. 25, 2022 (JP) 2022-050552
Mar. 31, 2022 (JP) 2022-059597

(51) Int. Cl. H01M 10/0569; H01M 4/525; H01M 10/0525; H01M 50/414; H01M 50/417

(52) U.S. Cl. CPC H01M 10/0569; H01M 4/525; H01M 10/0525; H01M 50/414; H01M 50/417; H01M 2300/0034; H01M 2300/0037

(57) ABSTRACT

A lithium-ion battery including a novel electrolyte and the like is provided. The lithium-ion battery includes a positive electrode active material containing nickel, cobalt, and manganese, and an electrolyte containing a fluorinated cyclic carbonate and a fluorinated chain carbonate. A discharge capacity value obtained by placing a half cell including the positive electrode active material and the electrolyte at an ambient temperature of 25° C., performing constant current charging at a rate of 0.1 C until a voltage of 4.5 V, performing constant voltage charging at 4.5 V until a current value of 0.05 C, placing the half cell at an ambient temperature of −40° C., and performing constant current discharging at the rate of 0.1 C until a voltage of 2.5 V satisfies greater than or equal to 50% of a discharge capacity value obtained by placing the half cell at the ambient temperature of 25° C.

### TECHNICAL FIELD

One embodiment of the present invention relates to a lithium-ion battery.

One embodiment of the present invention is not limited to the above field and relates to a semiconductor device, a display device, a light-emitting device, a power storage device, a lighting device, an electronic device, a vehicle, and manufacturing methods thereof. The lithium-ion battery of one embodiment of the present invention can be used as a power supply necessary for the above semiconductor device, display device, light-emitting device, power storage device, lighting device, electronic device, and vehicle. Examples of the above electronic device include an information terminal device provided with the lithium-ion battery. Furthermore, examples of the above power storage device include a stationary power storage device.

A lithium-ion battery (sometimes referred to as a lithium-ion secondary battery) refers to a battery in which lithium ions are used as carrier ions. A lithium-ion battery is a secondary battery that can be repeatedly used by being charged and discharged. Note that the carrier ions in the present invention are not limited to lithium ions, and alkali metal ions or alkaline earth metal ions can be used as the carrier ions. Specifically, sodium ions, magnesium ions, or the like can be used. In that case, the present invention can be understood by replacing lithium ions with sodium ions, magnesium ions, or the like. Furthermore, in the case where there is no limitation by carrier ions, the term “secondary battery” is sometimes used.

### BACKGROUND ART

It is desired that a lithium-ion battery can be charged and discharged in a wide temperature range depending on the intended use. Thus, research and development for enabling charging and discharging of a lithium-ion battery at high temperatures or low temperatures has been actively conducted. Patent Document 1 proposes a fluorinated chain carboxylate ester as a nonaqueous electrolyte solution to inhibit a decrease in battery capacity at high temperatures. Non-Patent Document 1 proposes a mixture of methyl 3,3,3-trifluoropropionate (MTFP): fluoroethylene carbonate (FEC)=9:1 as an electrolyte to improve output characteristics at temperatures below freezing. Non-Patent Document 2 reports a crystal structure related to a positive electrode active material.

### REFERENCES

### Patent Document

[Patent Document 1] Japanese Published Patent Application No. 2009-289414

### Non-Patent Documents

[Non-Patent Document 1] John, H. et al, “An All-Fluorinated Ester Electrolyte for Stable High-Voltage Li Metal Batteries Capable of Ultra-Low-Temperature Operation”, ACE Energy LETTERS, 2020, 5, 1438-1447
[Non-Patent Document 2] Zhaohui Chen et al, “Staging Phase Transitions in LixCoO₂”, Journal of The Electrochemical Society, 2002, 1409 (12), A1604-A1609

### SUMMARY OF THE INVENTION

### Problems to be Solved by the Invention

Example 1 of Patent Document 1 discloses that a solid solution formed by Al and Mg in lithium cobalt oxide (LiCoO₂) with Zr added to its particle surface is used as a positive electrode active material and a mixture of 4-fluoroethylene carbonate (4-FEC) and CF₃CH₂COOCH₃ at a volume ratio of 2:8 is used as an organic solvent of a nonaqueous electrolyte solution. However, Patent Document 1 does not consider battery characteristics at temperatures below freezing.

To consider battery characteristics at temperatures below freezing, Non-Patent Document 1 discloses that the mixture of methyl 3,3,3-trifluoropropionate (MTFP) and fluoroethylene carbonate (FEC) at 9:1 is used as the organic solvent of the nonaqueous electrolyte solution, and also discloses that NMC 811 is used as a positive electrode active material in a cycle test. However, Non-Patent Document 1 does not consider battery characteristics at high temperatures.

In view of the above description, an object of the present invention is to provide a lithium-ion battery including a novel electrolyte containing an organic solvent and a novel positive electrode active material in order to enable charging and discharging in a wide temperature range from temperatures below freezing to high temperatures.

Note that the objects described above do not preclude the existence of other objects. The objects described above should be construed as being independent of one another and one embodiment of the present invention does not need to achieve all the objects described above.

Moreover, objects other than those described above can be derived from the description of the specification, the drawings, and the claims (which are referred to as “this specification and the like”).

### Means for Solving the Problems

In order to achieve the above objects, one embodiment of the present invention is a lithium-ion battery including a positive electrode containing a positive electrode active material, and an electrolyte. The positive electrode active material contains a lithium cobalt oxide containing Mg, F, Ni, and Al. The electrolyte contains a fluorinated cyclic carbonate and a fluorinated chain carbonate.

Another embodiment of the present invention is a lithium-ion battery including a positive electrode containing a positive electrode active material, and an electrolyte. The positive electrode active material contains a lithium cobalt oxide containing Mg, F, Ni, and Al. The electrolyte contains fluoroethylene carbonate and methyl trifluoropropionate. A volume ratio of the fluoroethylene carbonate to the methyl trifluoropropionate is x: 100−x (where 5≤x≤30) when a total content of the fluoroethylene carbonate and the methyl trifluoropropionate is 100 vol %.

In one embodiment of the present invention, the lithium cobalt oxide is represented by LixCoO₂. When x in the LixCoO₂ is 1, the lithium cobalt oxide has a layered rock-salt crystal structure belonging to a space group R-3m. The lithium cobalt oxide preferably has a crystal structure of a space group P2/m with a lattice constant a=0.488±0.001 nm, a lattice constant b=0.282±0.001 nm, a lattice constant c=0.484±0.001 nm, a=90°, β=109.58±0.01°, and γ=90° when the x in the LixCoO₂ is 0.1<x≤0.24, i.e., in a charged state.

In another embodiment of the present invention, the lithium cobalt oxide is represented by LixCoO₂. The lithium cobalt oxide has a layered rock-salt crystal structure belonging to a space group R-3m when x in the LixCoO₂ is 1. The lithium cobalt oxide preferably has a diffraction peak at least at 2θ of greater than or equal to 19.37° and less than or equal to 19.57° and 2θ of greater than or equal to 45.57° and less than or equal to 45.67° when the x in the LixCoO₂ is 0.1≤x≤0.24, i.e., in a charged state, and the lithium cobalt oxide is analyzed by X-ray diffraction.

In another embodiment of the present invention, a median diameter (D50) of the lithium cobalt oxide is preferably greater than or equal to 10 μm and less than or equal to 14 μm.

In another embodiment of the present invention, a median diameter (D50) of the lithium cobalt oxide is preferably greater than or equal to 5 μm and less than or equal to 9 μm.

Another embodiment of the present invention is a lithium-ion battery including a positive electrode active material containing a lithium cobalt oxide containing Mg, F, Ni, and Al, and an electrolyte containing a fluorinated cyclic carbonate and a fluorinated chain carbonate. A discharge capacity value obtained by preparing a half cell including a positive electrode containing the positive electrode active material, the electrolyte, and a counter electrode containing lithium metal, placing the half cell at an ambient temperature of 25° C., performing constant current charging at a rate of 0.1 C (where 1 C=200 mA/g (a current per positive electrode active material weight of 200 mA/g)) until a voltage of 4.6 V, performing constant voltage charging at 4.6 V until a current value of 0.05 C, placing the half cell at an ambient temperature of −40° C., and performing constant current discharging at the rate of 0.1 C until a voltage of 2.5 V is greater than or equal to 50% of a discharge capacity value obtained by placing the same half cell at the ambient temperature of 25° C., performing the constant current charging at the rate of 0.1 C (where 1 C=200 mA/g (the current per positive electrode active material weight of 200 mA/g)) until the voltage of 4.6 V, performing the constant voltage charging at 4.6 V until the current value of 0.05 C, and performing the constant current discharging at the rate of 0.1 C until the voltage of 2.5 V.

Another embodiment of the present invention is a lithium-ion battery including a positive electrode containing a positive electrode active material containing a lithium cobalt oxide containing Mg, F, Ni, and Al, and an electrolyte. A discharge capacity value obtained by preparing a half cell including the positive electrode containing the positive electrode active material, the electrolyte, and a counter electrode containing lithium metal, placing the half cell at an ambient temperature of 25° C., performing constant current charging at a rate of 0.1 C (where 1 C=200 mA/g (a current per positive electrode active material weight of 200 mA/g)) until a voltage of 4.6 V, performing constant voltage charging at 4.6 V until a current value of 0.05 C, placing the half cell at an ambient temperature of −40° C., and performing constant current discharging at the rate of 0.1 C until a voltage of 2.5 V is greater than or equal to 50% of a discharge capacity value obtained by placing the same half cell at the ambient temperature of 25° C., performing the constant current charging at the rate of 0.1 C (where 1 C=200 mA/g (the current per positive electrode active material weight of 200 mA/g)) until the voltage of 4.6 V, performing the constant voltage charging at 4.6 V until the current value of 0.05 C, and performing the constant current discharging at the rate of 0.1 C until the voltage of 2.5 V.

Another embodiment of the present invention is a lithium-ion battery including a positive electrode active material containing nickel, cobalt, and manganese, and an electrolyte containing a fluorinated cyclic carbonate and a fluorinated chain carbonate. A discharge capacity value obtained by placing a half cell including a positive electrode containing the positive electrode active material, the electrolyte, and a counter electrode containing lithium metal at an ambient temperature of 25° C., performing constant current charging at a rate of 0.1 C (where 1 C=200 mA/g (a current per positive electrode active material weight of 200 mA/g)) until a voltage of 4.5 V, performing constant voltage charging at 4.5 V until a current value of 0.05 C, placing the half cell at an ambient temperature of −40° C., and performing constant current discharging at the rate of 0.1 C until a voltage of 2.5 V satisfies greater than or equal to 50% of a discharge capacity value obtained by placing the half cell at the ambient temperature of 25° C., performing the constant current charging at the rate of 0.1 C (where 1 C=200 mA/g (the current per positive electrode active material weight of 200 mA/g)) until the voltage of 4.5 V, performing the constant voltage charging at 4.5 V until the current value of 0.05 C, and performing the constant current discharging at the rate of 0.1 C until the voltage of 2.5 V.

Another embodiment of the present invention is a lithium-ion battery including a positive electrode active material containing nickel, cobalt, and manganese, and an electrolyte. The electrolyte contains fluoroethylene carbonate and methyl trifluoropropionate. A volume ratio of the fluoroethylene carbonate to the methyl trifluoropropionate is x: 100−x (where 5≤x≤30) when a total content of the fluoroethylene carbonate and the methyl trifluoropropionate is 100 vol %. A discharge capacity value obtained by placing a half cell including a positive electrode containing the positive electrode active material, the electrolyte, and a counter electrode containing lithium metal at an ambient temperature of 25° C., performing constant current charging at a rate of 0.1 C (where 1 C=200 mA/g (a current per positive electrode active material weight of 200 mA/g)) until a voltage of 4.5 V, performing constant voltage charging at 4.5 V until a current value of 0.05 C, placing the half cell at an ambient temperature of −40° C., and performing constant current discharging at the rate of 0.1 C until a voltage of 2.5 V satisfies greater than or equal to 50% of a discharge capacity value obtained by placing the half cell at the ambient temperature of 25° C., performing the constant current charging at the rate of 0.1 C (where 1 C=200 mA/g (the current per positive electrode active material weight of 200 mA/g)) until the voltage of 4.5 V, performing the constant voltage charging at 4.5 V until the current value of 0.05 C, and performing the constant current discharging at the rate of 0.1 C until the voltage of 2.5 V.

In another embodiment of the present invention, a ratio of nickel:cobalt:manganese in the positive electrode active material preferably satisfies 8:1:1 or a neighborhood thereof.

In another embodiment of the present invention, a proportion of nickel is preferably higher than a proportion of cobalt and a proportion of manganese in the positive electrode active material.

In another embodiment of the present invention, a median diameter (D50) of the positive electrode active material is preferably greater than or equal to 4 μm and less than or equal to 7 μm.

In another embodiment of the present invention, a separator of the half cell preferably contains polyimide.

In another embodiment of the present invention, a separator of the half cell preferably contains polypropylene.

### Effect of the Invention

According to one embodiment of the present invention, a lithium-ion battery including a novel electrolyte containing an organic solvent and a novel positive electrode active material can be provided. According to one embodiment of the present invention, a lithium-ion battery capable of being charged and discharged in a wide temperature range from temperatures below freezing to high temperatures can be provided.

Note that the effects described above do not preclude the existence of other effects. The effects described above should be construed as being independent of one another and one embodiment of the present invention does not need to have all the effects described above. Moreover, effects other than those described above can be derived from the description of this specification and the like.

### BRIEF DESCRIPTION OF THE DRAWINGS

FIG. 1A and FIG. 1B are diagrams illustrating lithium-ion batteries of one embodiment of the present invention.

FIG. 2A to FIG. 2C are diagrams illustrating a method for fabricating a positive electrode of one embodiment of the present invention.

FIG. 3A to FIG. 3F are diagrams illustrating positive electrode active materials of one embodiment of the present invention.

FIG. 4 is a diagram illustrating crystal structures of a positive electrode active material of one embodiment of the present invention.

FIG. 5 is a diagram illustrating crystal structures of a positive electrode active material.

FIG. 6 is a diagram illustrating diffraction peaks of a positive electrode active material.

FIG. 7 is a diagram illustrating diffraction peaks of a positive electrode active material.

FIG. 8A and FIG. 8B are diagrams illustrating diffraction peaks of a positive electrode active material.

FIG. 9 is a diagram illustrating a method for fabricating a positive electrode of one embodiment of the present invention.

FIG. 10 is a diagram illustrating a method for fabricating a positive electrode of one embodiment of the present invention.

FIG. 11 is a diagram illustrating a method for fabricating a positive electrode of one embodiment of the present invention.

FIG. 12 is a diagram illustrating a method for fabricating a positive electrode of one embodiment of the present invention.

FIG. 13 is a diagram illustrating a method for fabricating a positive electrode of one embodiment of the present invention.

FIG. 14A to FIG. 14D are diagrams illustrating positive electrodes of one embodiment of the present invention.

FIG. 15A to FIG. 15D are diagrams illustrating a positive electrode of one embodiment of the present invention.

FIG. 16A and FIG. 16B are diagrams illustrating lithium-ion batteries of one embodiment of the present invention.

FIG. 17A to FIG. 17C are diagrams illustrating a lithium-ion battery of one embodiment of the present invention.

FIG. 18A to FIG. 18D are diagrams illustrating a lithium-ion battery and a power storage system of one embodiment of the present invention.

FIG. 19A to FIG. 19C are diagrams illustrating a lithium-ion battery of one embodiment of the present invention.

FIG. 20A to FIG. 20C are diagrams illustrating a lithium-ion battery of one embodiment of the present invention.

FIG. 21A to FIG. 21C are diagrams illustrating an electric vehicle of one embodiment of the present invention.

FIG. 22A to FIG. 22D are diagrams illustrating transport vehicles of one embodiment of the present invention.

FIG. 23A to FIG. 23C are diagrams illustrating a two-wheeled vehicle and the like of one embodiment of the present invention.

FIG. 24A to FIG. 24D are diagrams illustrating electronic devices and the like of one embodiment of the present invention.

FIG. 25A to FIG. 25D are diagrams illustrating examples of devices for space.

FIG. 26A and FIG. 26B are diagrams showing NMR of an organic solvent of an electrolyte of one embodiment of the present invention.

FIG. 27A and FIG. 27B are diagrams showing NMR of an organic solvent of an electrolyte of one embodiment of the present invention.

FIG. 28A and FIG. 28B are diagrams showing NMR of an organic solvent of an electrolyte of one embodiment of the present invention.

FIG. 29A and FIG. 29B are diagrams illustrating AC impedance measurement.

FIG. 30A to FIG. 30C are diagrams showing AC impedance measurement results of a sample including an electrolyte and a positive electrode active material of one embodiment of the present invention.

FIG. 31A to FIG. 31C are diagrams showing AC impedance measurement results of a sample including an electrolyte and a positive electrode active material of one embodiment of the present invention.

FIG. 32A and FIG. 32B are diagrams showing charge capacities and discharge capacities of samples each including an electrolyte and a positive electrode active material of one embodiment of the present invention.

FIG. 33A and FIG. 33B are diagrams showing charge capacities and discharge capacities of samples each including an electrolyte and a positive electrode active material of one embodiment of the present invention.

FIG. 34A and FIG. 34B are diagrams showing charge capacities and discharge capacities of samples each including an electrolyte and a positive electrode active material of one embodiment of the present invention.

FIG. 35A and FIG. 35B are diagrams showing charge curves and discharge curves of samples each including an electrolyte and a positive electrode active material of one embodiment of the present invention.

FIG. 36A to FIG. 36C are diagrams showing cycle performances of samples each including an electrolyte and a positive electrode active material of one embodiment of the present invention.

FIG. 37 is a diagram showing viscosities of organic solvents of an electrolyte of one embodiment of the present invention.

FIG. 38A and FIG. 38B are diagrams showing charge capacities and discharge capacities of samples each including an electrolyte and a positive electrode active material of one embodiment of the present invention.

FIG. 39A and FIG. 39B are graphs showing DSC results of organic liquids.

FIG. 40 is a diagram illustrating a model used for calculation.

FIG. 41 is a graph showing activation barriers for lithium ion diffusion.

FIG. 42A and FIG. 42B are diagrams showing charge and discharge curves (25° C.) of a full cell.

FIG. 43A and FIG. 43B are diagrams showing cycle performances (25° C.) of a full cell.

### MODE FOR CARRYING OUT THE INVENTION

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Thus, the present invention should not be construed as being limited to the description in the following embodiments. Note that in the structures of the invention described below, the same portions or portions having similar functions are denoted by the same reference numerals in different drawings, and description thereof is not repeated in some cases.

Ordinal numbers such as “first” and “second” in this specification and the like are used in order to avoid confusion among components and do not denote the priority or the sequence such as the sequence of steps or the stacking sequence. A term without an ordinal number in this specification and the like may be provided with an ordinal number in the SCOPE OF CLAIMS in order to avoid confusion among components. Furthermore, a term with an ordinal number in this specification and the like may be provided with a different ordinal number in the SCOPE OF CLAIMS. Furthermore, even when a term is provided with an ordinal number in this specification and the like, the ordinal number might be omitted in the SCOPE OF CLAIMS and the like.

In this specification and the like, a positive electrode active material refers to a compound containing a transition metal and oxygen into and from which carrier ions can be inserted and extracted. A compound containing oxygen is referred to as an oxide or a composite oxide in some cases. Although lithium ions are typically used as the carrier ions, sodium ions, magnesium ions, or the like may be used. The positive electrode active material does not include a carbonic acid, a hydroxy group, and the like which are adsorbed after fabrication of the positive electrode active material. Furthermore, an electrolyte, an organic solvent, a binder, a conductive material, and a compound originating from any of these that are attached to the positive electrode active material are not included in the positive electrode active material either.

In this specification and the like, “uniformity” refers to a phenomenon in which, in a solid made of a plurality of elements (e.g., A, B, and C), a certain element (e.g., A) is distributed with similar features in specific regions. Specifically, it is acceptable for the specific regions to have substantially the same concentration of the element. For example, it is acceptable for the specific regions to have a difference in the concentration of the element of 10% or less, which is sometimes referred to as substantially the same concentration. Examples of the specific regions include a surface portion, a projecting portion, a depressed portion, and an inner portion of an active material, and when the projecting portion and the inner portion have substantially the same concentration of the element, it can be said that the element exists uniformly in the projecting portion and the inner portion.

In this specification and the like, “segregation” refers to a phenomenon in which, in a solid made of a plurality of elements (e.g., A, B, and C), a certain element (e.g., B) is spatially non-uniformly distributed, and means that a specific region and another specific region have different concentrations of the element (e.g., B). “Segregation” can be rephrased as uneven distribution, separation, unevenness, deviation, or a mixture of a high-concentration region and a low-concentration region.

In this specification and the like, “particle” used for an active material particle or the like is not limited to referring to only a spherical shape (a circular cross-sectional shape). For example, a particle may have an elliptical or asymmetrical cross-sectional shape or the like, and different particles do not necessarily have a uniform shape and may have irregular shapes.

In this specification and the like, “temperature below freezing” means lower than or equal to 0° C., “high temperature” means higher than or equal to 25° C., and room temperature means higher than 0° C. and lower than 25° C. In this specification and the like, “temperature range from temperatures below freezing to high temperatures” includes the above-described room temperature.

“Nonaqueous electrolyte solution” contains an organic solvent exhibiting carrier ion conductivity and generally refers to a liquid solution, but is not limited to a liquid solution in the present invention. Therefore, in this specification and the like, a concept related to a nonaqueous electrolyte solution is referred to as “electrolyte”. That is, an electrolyte of one embodiment of the present invention is not limited in any way by its state, and can have a state with a viscosity increased from that of a liquid state as a result of viscosity adjustment, for example. Furthermore, the electrolyte can have a solid state or a semi-solid state. The semi-solid state refers to an intermediate state between a liquid state and a solid state. Specifically, the semi-solid state includes a flexible solid state, typically a gel state, in its category. An electrolyte in the semi-solid state is sometimes generally referred to as a semi-solid electrolyte, and the electrolyte of one embodiment of the present invention includes a semi-solid electrolyte in its category. The above-described liquid, solid, or semi-solid state or viscosity is observed when a lithium-ion battery is placed at 25° C.

In this specification and the like, “carbonate” refers to a compound containing at least one carbonic ester in its molecular structure and includes “cyclic carbonate” and “chain carbonate” in its category unless otherwise specified. “Chain” includes both straight-chain and branched-chain.

In this specification and the like, a value indicating the level of viscousness is referred to as viscosity, and appropriate viscousness refers to appropriate viscosity for a lithium-ion battery.

In this specification and the like, the expression “including A and/or B” means including A, including B, or including A and B.

In this specification and the like, a full cell means a battery cell assembled such that different electrodes are positioned as in a unit cell of a positive electrode/a negative electrode. In this specification and the like, a half cell means a battery cell assembled using lithium metal as a negative electrode (a counter electrode).

### Embodiment 1

In this embodiment, a lithium-ion battery of one embodiment of the present invention is described with reference to drawings.

### <Lithium-Ion Battery>

The lithium-ion battery of one embodiment of the present invention includes an electrolyte that enables charging and discharging in a wide temperature range including at least temperatures below freezing and further including high temperatures. In addition to the above-described electrolyte, the lithium-ion battery includes a negative electrode, a positive electrode, and a separator between the negative electrode and the positive electrode, and includes an exterior body that covers the periphery of the negative electrode and the positive electrode and the like. Depending on the form of the exterior body, the lithium-ion battery is referred to as a laminated lithium-ion battery, a coin-cell lithium-ion battery, or a cylindrical lithium-ion battery; however, the present invention is not limited in any way by the form of the exterior body. The separator can be omitted when the electrolyte is in a solid state or a semi-solid state.

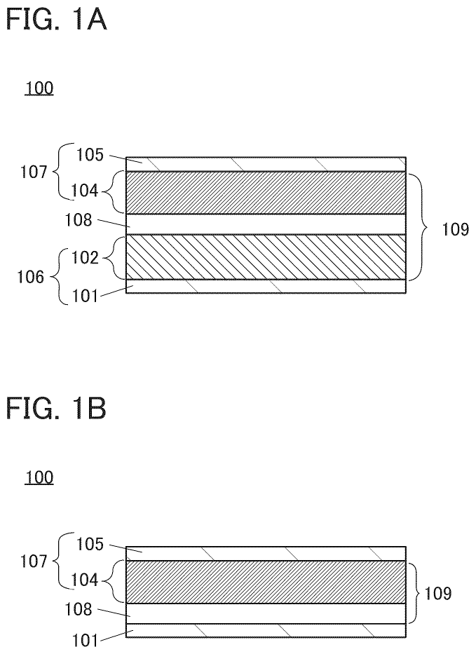

FIG. 1A illustrates components of a lithium-ion battery 100. It can be seen in a cross-sectional view that the lithium-ion battery 100 includes a negative electrode 106, a separator 108, and a positive electrode 107. In the lithium-ion battery 100, an electrolyte 109 is in a liquid state, and the electrolyte 109 exists throughout the negative electrode 106, the separator 108, and the positive electrode 107. As described above, the electrolyte 109 is not limited to a liquid state.

The negative electrode 106 includes a negative electrode current collector 101 and a negative electrode active material layer 102. The negative electrode active material layer 102 contains at least a negative electrode active material and may contain a conductive material and/or a binder. A known material can be used as the negative electrode active material, the details of which are described later. The positive electrode 107 includes a positive electrode current collector 105 and a positive electrode active material layer 104. The positive electrode active material layer 104 contains at least a positive electrode active material and may contain a conductive material and/or a binder. Although a known material may be used as the positive electrode active material, a positive electrode active material of one embodiment of the present invention can withstand high-voltage charging and increase discharge capacity of the lithium-ion battery. The positive electrode active material of one embodiment of the present invention is describe later.

The conductive material has a function of giving aid to a current path between the positive electrode active materials and/or between the positive electrode active material and the current collector. The conductive material has also a function of giving aid to a current path between the negative electrode active materials and/or between the negative electrode active material and the current collector. A known material can be used as the conductive material, the details of which are described later. The binder is also referred to as a binding agent and has a function of giving aid to adhesion between the positive electrode active materials and/or between the positive electrode active material and the current collector. The binder has also a function of giving aid to adhesion between the negative electrode active materials and/or between the negative electrode active material and the current collector. A known material can be used as the binder, the details of which are described later.

FIG. 1B illustrates an example of the lithium-ion battery 100 that does not include the negative electrode active material layer 102, which is different from that in FIG. 1A. The negative electrode active material layer 102 can be unnecessary depending on the material of the negative electrode current collector 101. The other components of the lithium-ion battery 100 in FIG. 1B are similar to those of the lithium-ion battery 100 in FIG. 1A; thus, the description thereof is omitted.

In this embodiment, a lithium-ion battery can be obtained which has excellent discharge characteristics and/or excellent charge characteristics in a wide temperature range from temperatures below freezing to high temperatures. In particular, a lithium-ion battery can be obtained which has excellent discharge characteristics and/or excellent charge characteristics at a given temperature below freezing (e.g., lower than or equal to 0° C., lower than or equal to −20° C., preferably lower than or equal to −30° C., further preferably lower than or equal to −40° C., still further preferably lower than or equal to −50° C., yet still further preferably lower than or equal to −60° C.). A description will be made focusing on components needed for such a lithium-ion battery. Specifically, the positive electrode active material and the electrolyte are mainly described. The details of components of the lithium-ion battery, other than the positive electrode active material and the electrolyte, are described after Embodiment 3.

### <Positive Electrode Active Material>

The positive electrode active material has functions of taking in and/or releasing lithium ions, which are carrier ions, in accordance with charging and discharging. For the positive electrode active material used as one embodiment of the present invention, it is possible to use a material which enables charging and discharging and shows little deterioration (or a smaller increase in resistance) due to discharging and charging even at a high charging voltage (hereinafter also referred to as “high charge voltage”) at least at a temperature below freezing. In this specification and the like, unless otherwise specified, “charge voltage” is shown with reference to the potential of lithium metal. In this specification and the like, “high charge voltage” is a charge voltage, for example, higher than or equal to 4.4 V, preferably higher than or equal to 4.5 V, further preferably higher than or equal to 4.6 V.

The positive electrode active material is not limited to one kind; two or more kinds of materials having different median diameters (D50) may be mixed or two or more kinds of materials having different compositions may be mixed as long as the materials show little deterioration due to discharging and charging even at a high charge voltage at least at a temperature below freezing. In this specification and the like, the term “having different compositions” includes not only the case where constituent elements contained in the materials are different but also the case where the constituent elements contained in the materials are the same but the proportions of the constituent elements contained in the materials are different.

As described above, “high charge voltage” in this specification and the like is higher than or equal to 4.5 V with reference to the potential of lithium metal used for the negative electrode; however, “high charge voltage” refers to a voltage higher than or equal to 4.4 V with reference to the potential of a carbon material (e.g., graphite) used for the negative electrode. In short, a charge voltage higher than or equal to 4.5 V is referred to as high charge voltage in the case of using lithium metal as the negative electrode in a half cell, and a charge voltage higher than or equal to 4.4 V is referred to as high charge voltage in the case of using a carbon material (e.g., graphite) for the negative electrode in a full cell.

A lithium-ion battery with high charge capacity and/or high discharge capacity even at a temperature below freezing can be obtained by using a material with little deterioration (or a material with a small increase in resistance) due to discharging and charging even at a high charge voltage at a given temperature below freezing. Specifically, a lithium-ion battery can be obtained in which a charge capacity and/or discharge capacity value(s) at a given temperature below freezing is greater than or equal to 50% (preferably greater than or equal to 60%, further preferably greater than or equal to 70%, most preferably greater than or equal to 80%) of a charge capacity and/or discharge capacity value(s) at 25° C.

The temperature at the time of charging or discharging described in this specification and the like refers to the temperature of an environment where a lithium-ion battery is placed (hereinafter sometimes referred to as “ambient temperature” in this specification and the like). Since a thermostatic chamber, which is stable at a desired temperature, is used for measurement of battery characteristics, the ambient temperature is equal to the temperature in the thermostatic chamber. Measurement can be started after a test cell to be measured (e.g., a full cell or a half cell) is placed in the thermostatic chamber and left for a sufficient time (e.g., one hour or longer) for the temperature of the test cell to become substantially equal to the temperature in the thermostatic chamber; however, measurement of battery characteristics is not necessarily limited to this method.

### <Electrolyte>

For the electrolyte used as one embodiment of the present invention, it is possible to use a material with high lithium ion conductivity at a given temperature below freezing (e.g., 0° C., −20° C., preferably −30° C., further preferably −40° C., still further preferably −50° C. or −60° C.).

The electrolyte contains an organic solvent; the organic solvent of the electrolyte of one embodiment of the present invention is not limited to a liquid at 25° C. and may be a solid at 25° C. or a semi-solid at 25° C. Note that the organic solvent of the electrolyte of one embodiment of the present invention is preferably a liquid at a given temperature below freezing (e.g., 0° C., −20° C., preferably −30° C., further preferably −40° C., still further preferably −50° C. or −60° C.) but is not limited thereto. The organic solvent of the electrolyte of one embodiment of the present invention may be a liquid, a solid, or a semi-solid at a given temperature below freezing.

### <Organic Solvent>

The organic solvent described in this embodiment preferably contains a fluorinated cyclic carbonate (also referred to as a cyclic carbonate fluoride in some cases) or a fluorinated chain carbonate (also referred to as a chain carbonate fluoride in some cases). The above organic solvent further preferably contains both a fluorinated cyclic carbonate and a fluorinated chain carbonate. A fluorinated cyclic carbonate and a fluorinated chain carbonate each include a substituent with an electron-withdrawing property and have a lower solvation energy of a lithium ion than an organic compound not including a substituent with an electron-withdrawing property. Accordingly, a fluorinated cyclic carbonate and a fluorinated chain carbonate are each suitable for the organic solvent.

As a fluorinated cyclic carbonate, fluoroethylene carbonate (also referred to as fluorinated ethylene carbonate, FEC, or FIEC), difluoroethylene carbonate (DFEC or F2EC), trifluoroethylene carbonate (F3EC), or tetrafluoroethylene carbonate (F4EC) or the like can be used. Note that DFEC has isomers such as a cis-4,5 isomer and a trans-4,5 isomer. Each of these fluorinated cyclic carbonates includes a substituent with an electron-withdrawing property and is thus presumed to have a low solvation energy of a lithium ion.

Structural Formula (H10) below is a structure formula of FEC. The substituent with an electron-withdrawing property in FEC is an F group.

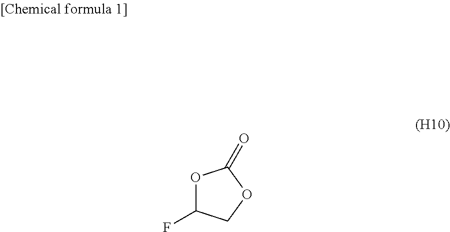

An example of the fluorinated chain carbonate is methyl 3,3,3-trifluoropropionate.

Structural Formula (H22) below is a structure formula of methyl 3,3,3-trifluoropropionate. An abbreviation of methyl 3,3,3-trifluoropropionate is “MTFP”. The substituent with an electron-withdrawing property in MTFP is a CF₃ group.

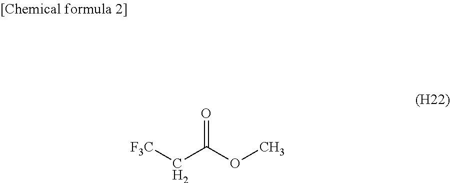

An example of the fluorinated chain carbonate is trifluoromethyl 3,3,3-trifluoropropionate. Structural Formula (H23) below is a structure formula of trifluoromethyl 3,3,3-trifluoropropionate. The substituent with an electron-withdrawing property is a CF₃ group.

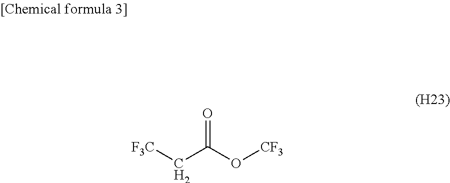 [SMILES: O=C(CC(F)(F)F)OC(F)(F)F]

An example of the fluorinated chain carbonate is trifluoromethyl propionate. Structural Formula (H24) below is a structural formula of trifluoromethyl propionate. The substituent with an electron-withdrawing property is a CF₃ group.

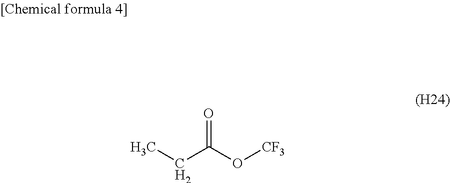

An example of the fluorinated chain carbonate is methyl 2,2-difluoropropionate. Structural Formula (H25) below is a structure formula of methyl 2,2-difluoropropionate. The substituent with an electron-withdrawing property is a CF₂ group.

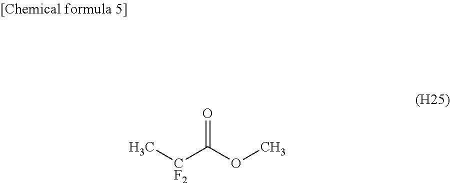

The organic solvent of the electrolyte of one embodiment of the present invention preferably contains one or more selected from the above-described fluorinated cyclic carbonates and one or more selected from the above-described fluorinated chain carbonates. For example, the organic solvent described in this embodiment preferably contains FEC and MTFP. The reason is as follows.

### <FEC and MTFP>

FEC, which is a cyclic carbonate, has a high dielectric constant and thus has an effect of promoting dissociation of a lithium salt when used in an organic solvent. Moreover, because of including the substituent with an electron-withdrawing property, FEC is readily bonded to a lithium ion by the Coulomb force or the like. Specifically, FEC has a lower solvation energy than ethylene carbonate (abbreviated as “EC”), which does not include a substituent with an electron-withdrawing property; thus, it can be said that FEC easily solvates a lithium ion. In addition, FEC is presumed to have a deep highest occupied molecular orbital (HOMO) level and is thus not easily oxidized, meaning high oxidation resistance. On the other hand, FEC has a high viscosity and is difficult to use alone as an organic solvent at a temperature below freezing. Then, the organic solvent specifically described as one embodiment of the present invention contains not only FEC but also MTFP. MTFP, which is a chain carbonate, has an effect of reducing or maintaining the viscosity of the electrolyte. Needless to say, MTFP also has a lower solvation energy than methyl propionate (abbreviated as “MP”), which does not include a substituent with an electron-withdrawing property, and thus may solvate a lithium ion.

FEC and MTFP having the above-described physical properties are preferably used as a mixture at a volume ratio of x: 100−x (where 5≤x≤30, preferably 10≤x≤20) when the total content of these two organic solvents is 100 vol %. MTFP and FEC are preferably mixed such that the amount of MTFP is larger than that of FEC in the organic solvent. Note that the above volume ratio may be a volume ratio measured before mixing the organic solvents, and the outside temperature at the time of mixing the organic solvents may be room temperature (typically 25° C.). The mixed organic solvent of FEC and MTFP is preferable because it exhibits a viscosity at which a lithium-ion battery can operate and maintains an appropriate viscosity even at a temperature below freezing.

A general organic solvent used for a lithium-ion battery solidifies at approximately −20° C.; thus, it is difficult to fabricate a lithium-ion battery that can be charged and discharged at −40° C., preferably −50° C. or −60° C. Meanwhile, the organic solvent described in this embodiment as an example can have a freezing point lower than or equal to −40° C., preferably lower than or equal to −50° C., and enables a lithium-ion battery to be charged and discharged even in an environment with a temperature below freezing. As a result, it is possible to obtain a lithium-ion battery capable of being charged and discharged in a wide temperature range including at least temperatures below freezing.

Although FEC is described above as a typical example, it can be said that any of the organic compounds given as the fluorinated cyclic carbonate has an effect of promoting dissociation of a lithium salt, easily solvates a lithium ion owing to its low solvation energy, and is difficult to use alone at a temperature below freezing owing to its high viscosity. Although MTFP is described above as a typical example, it can be said that any of the organic compounds given as the fluorinated chain carbonate has an effect of reducing or maintaining the viscosity of the electrolyte of one embodiment of the present invention. Thus, when the organic solvent of one embodiment of the present invention contains the fluorinated cyclic carbonate and the fluorinated chain carbonate, a lithium-ion battery capable of being charged and discharged in a wide temperature range including at least temperatures below freezing can be provided.

The above-described organic solvent is preferably highly purified and contains a small amount of particulate dust or an element other than the constituent elements of the organic solvent (hereinafter also simply referred to as “impurities”, which include water or moisture). Specifically, the ratio of impurities in the organic solvent is preferably less than or equal to 1 mol %, further preferably less than or equal to 0.1 mol %, still further preferably less than or equal to 0.01 mol %.

### <Lithium Salt>

For example, as a lithium salt dissolved in the above organic solvent, at least one of LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂)(CF₃SO₂), LiN(C₂F₅SO₂)₂, and lithium bis(oxalate)borate (LiBOB) can be used, or the above lithium salts may be used in a given combination at a given ratio. The lithium salt is one component of the electrolyte of one embodiment of the present invention but is not necessarily contained.

### <Additive Agent>

In order to form a coating film at the interface between the active material and the electrolyte for the purpose of improvement of the safety or the like, the organic solvent may be mixed with an additive agent. As the additive agent, one or two or more selected from vinylene carbonate (VC), propane sultone (PS), tert-butylbenzene (TBB), fluoroethylene carbonate (FEC), lithium bis(oxalate)borate (LiBOB), SUN (suberonitrile), or a dinitrile compound such as succinonitrile or adiponitrile may be used. The concentration of the additive agent in the whole organic solvent is, for example, higher than or equal to 0.1 wt % and lower than or equal to 5 wt %. The additive agent is one component of the electrolyte of one embodiment of the present invention but is not necessarily contained. As the additive agent, a material different from the organic solvent is preferably selected.

Although an example of the electrolyte that can be used for the lithium-ion battery of one embodiment of the present invention is described above, the electrolyte that can be used for the lithium-ion battery of one embodiment of the present invention should not be interpreted as being limited to the example. Another material can be used as long as it has an appropriate viscosity and a high lithium ion conductivity even at a temperature below freezing.

The lithium-ion battery of one embodiment of the present invention contains at least the above positive electrode active material and electrolyte, whereby the lithium-ion battery can be charged and discharged in a wide temperature range including at least temperatures below freezing.

### Embodiment 2

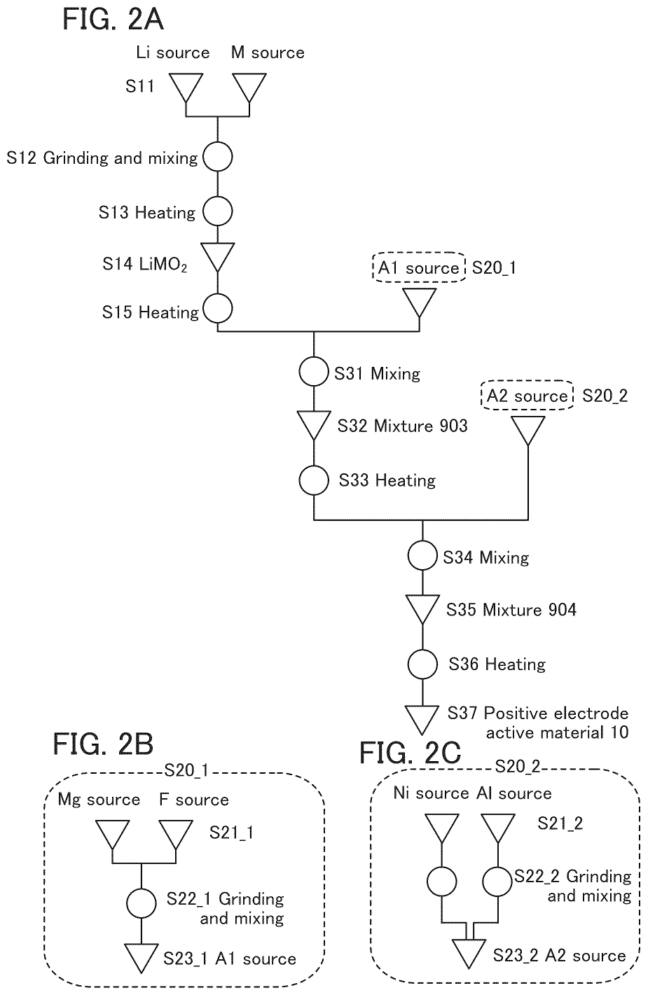

In this embodiment, a positive electrode active material that can be used in a lithium-ion battery of one embodiment of the present invention (hereinafter, sometimes referred to as “positive electrode active material that can be used as one embodiment of the present invention”) and a fabrication method thereof will be described with reference to FIG. 2A to FIG. 2C.

As described in Embodiment 1, any material can be used as the positive electrode active material that can be used in a lithium-ion battery of one embodiment of the present invention as long as the material shows little deterioration due to discharging and charging at a high charge voltage. Thus, the positive electrode active material that can be used in a lithium-ion battery disclosed in this specification and the like is not necessarily interpreted as being limited to specific materials described in this embodiment and the like. A material known at the time of filing this application as a material that shows little deterioration due to discharging and charging even at a high charge voltage (e.g., 4.5 V or higher) can also be used.

An example of a method for fabricating the positive electrode active material that can be used as one embodiment of the present invention is described below. Although the case where the positive electrode active material is manufactured by a solid phase method is described in this embodiment, a positive electrode active material manufactured by a coprecipitation method, a hydrothermal method, or the like other than the solid phase method can be used in the lithium-ion battery of the present invention. Note that a flow used for describing a manufacturing method and the like in this embodiment illustrates the order of elements that are connected by lines and does not illustrate the order of elements that are not connected by lines.

### [Method for Fabricating Positive Electrode Active Material]

An example of a fabrication flow of a positive electrode active material 10 is described with reference to FIG. 2A to FIG. 2C.

### <Step S11>

In Step S11 illustrated in FIG. 2A, a lithium source (Li source) and a transition metal M source (M source) are prepared as materials of lithium and the transition metal M which are starting materials. As the lithium source, a lithium-containing compound is preferably used and for example, lithium carbonate, lithium hydroxide, lithium nitrate, lithium fluoride, or the like can be used. As the transition metal M, one or two or more of manganese, cobalt, and nickel can be used, for example. In the case where lithium cobalt oxide (LCO) is fabricated as the positive electrode active material, cobalt is used as the transition metal M. In the case where nickel-cobalt-manganese composite oxide (NCM) is fabricated as the positive electrode active material, cobalt, manganese, and nickel are used as the transition metal M. Aluminum can also be used in addition to the transition metal M.

As the transition metal M source, a compound containing the above transition metal M is preferably used and for example, an oxide, a hydroxide, or the like of any of the metals given as examples of the transition metal M can be used. As a cobalt source, cobalt oxide, cobalt hydroxide, or the like can be used. As a manganese source, manganese oxide, manganese hydroxide, or the like can be used. As a nickel source, nickel oxide, nickel hydroxide, or the like can be used. As an aluminum source, aluminum oxide, aluminum hydroxide, or the like can be used. In the case of using two or more transition metal M sources, the two or more transition metal M sources are preferably prepared to have proportions (mixing ratio) such that a layered rock-salt crystal structure would be obtained.

### <Step S12>

Next, in Step S12 illustrated in FIG. 2A, the Li source and the M source are mixed while being ground to fabricate a mixed material. The step of mixing with grinding can be performed by a dry method or a wet method. When a wet method is employed, a solvent is prepared. As the solvent, a ketone such as acetone, an alcohol such as ethanol or isopropanol, an ether, dioxane, acetonitrile, N-methyl-2-pyrrolidone (NMP), or the like can be used. Acetone with a low moisture content lower than or equal to 10 ppm and a purity higher than or equal to 99.5% is referred to as “dehydrated acetone”, and dehydrated acetone is preferably used as the solvent.

### <Step S13>

Next, in Step S13 illustrated in FIG. 2A, the above mixed material is heated. The heating temperature is preferably higher than or equal to 800° C. and lower than or equal to 1100° C., further preferably higher than or equal to 900° C. and lower than or equal to 1000° C. An excessively low temperature might lead to insufficient decomposition and melting of the Li source, the M source, and the like. An excessively high temperature might lead to sublimation of lithium from the Li source and/or excessive reduction of the transition metal used as the M source. When the heating time is too short, a composite oxide containing lithium and the transition metal M is not synthesized, but when the heating time is too long, the productivity is lowered. Thus, the heating time is preferably longer than or equal to 1 hour and shorter than or equal to 100 hours, further preferably longer than or equal to 2 hours and shorter than or equal to 20 hours. A temperature rising rate is preferably higher than or equal to 80° C./h and lower than or equal to 250° C./h, further preferably higher than or equal to 100° C./h and lower than or equal to 250° C./h, although depending on the end-point temperature of the heating.

The heating is preferably performed in an atmosphere with little water. The atmosphere with little water can be specified using the dew point, and for example, the heating atmosphere is preferably an atmosphere with a dew point lower than or equal to −50° C., further preferably a dew point lower than or equal to −80° C. The heating atmosphere is further preferably an oxygen-containing atmosphere such as a dry air. In a method, oxygen is continuously introduced into a reaction chamber. The flow rate of oxygen in this case is preferably higher than or equal to 5 L/min and lower than or equal to 15 L/min. A state of continuously introducing oxygen into a reaction chamber to make oxygen flow therein is referred to as “flow”.

The heating atmosphere may be made the oxygen-containing atmosphere by a method, other than the above flow, in which the pressure in the reaction chamber is reduced, oxygen is introduced, and then oxygen is controlled so as not to enter or exit from the reaction chamber, for example. This is referred to as “purging”. For example, the pressure in the reaction chamber is reduced to −970 hPa, oxygen is introduced until the pressure becomes 50 hPa, and then oxygen entry and exit is stopped. Such a state is sometimes referred to as filling the reaction chamber with oxygen.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

This heating step may be performed with a rotary kiln or a roller hearth kiln. The rotary kiln is a rotating baking apparatus, which is preferable because raw materials can be heated while being stirred. The roller hearth kiln is a baking apparatus in which raw materials are transported by rollers, which is preferable because the raw materials can successively pass through a temperature-rising region, a cooling region, and the like. Needless to say, a batch-type baking apparatus may be used for this heating step.

A container in which the mixed material is put at the time of heating (specifically a container called a crucible or a saggar) is preferably made of a highly heat-resistant material such as aluminum oxide (referred to as alumina), mullite cordierite, magnesia, or zirconia. At the time of heating, the crucible or the saggar is preferably covered with a lid, in which case sublimation of the raw materials or the like can be prevented.

After the heating, the mixed material may be collected after being moved from the crucible or the saggar to a mortar and after being crushed. The mortar is preferably made of a highly heat-resistant material such as alumina, mullite cordierite, magnesia, or zirconia. Note that heating conditions equivalent to those in Step S13 can be employed in a later-described heating step other than Step S13.

The mixture collected after the heating is aggregated in some cases. The collected mixture may be crushed to alleviate the aggregated state. The collected mixture may be sieved to further alleviate the aggregated state. The sieving may be performed after the crushing is performed, the sieving may be performed while the crushing is performed, or only the sieving may be performed instead of the crushing.

### <Step S14>

Through the above steps, a composite oxide containing lithium and the transition metal M (LiMO₂) can be obtained in Step S14 illustrated in FIG. 2A. The composite oxide is represented by LiMO₂, but its composition is not strictly limited to Li:M:O=1:1:2. In the case where cobalt is used as the transition metal M, the composite oxide is referred to as a cobalt-containing composite oxide and is represented by LiCoO₂; however, its composition is not strictly limited to Li:Co:O=1:1:2.

Although the example is described in which the composite oxide is fabricated by a solid phase method as in Step S11 to Step S14, the composite oxide may be fabricated by a coprecipitation method. Alternatively, the composite oxide may be fabricated by a hydrothermal method.

### <Step S15>

Next, in Step S15 illustrated in FIG. 2A, the above composite oxide is heated. The heating in Step S15 is the first heating performed on the composite oxide and thus is sometimes referred to as initial heating. The heating is performed before Step S20 described below and thus is sometimes referred to as preheating or pretreatment.

The heating temperature in Step S15 is preferably higher than or equal to 500° C. and lower than or equal to 1000° C., further preferably higher than or equal to 500° C. and lower than or equal to 950° C., still further preferably higher than or equal to 500° C. and lower than or equal to 900° C. Furthermore, the heating temperature is preferably higher than or equal to 700° C. and lower than or equal to 1000° C., further preferably higher than or equal to 700° C. and lower than or equal to 950° C., still further preferably higher than or equal to 700° C. and lower than or equal to 900° C. Furthermore, the heating temperature is preferably higher than or equal to 800° C. and lower than or equal to 1000° C., further preferably higher than or equal to 800° C. and lower than or equal to 950° C., still further preferably higher than or equal to 800° C. and lower than or equal to 900° C. Note that the heating temperature in Step S15 is preferably lower than that in Step S13.

The initial heating may cause extraction of lithium from part of the composite oxide. In addition, an effect of increasing the crystallinity of the composite oxide can be expected. The Li source and/or M source prepared in Step S11 and the like might contain impurities. The initial heating can reduce the impurities of the composite oxide.

Through the initial heating, an effect of smoothing the surface of the composite oxide is obtained. A smooth surface refers to a state where the surface of the composite oxide has little unevenness and is rounded as a whole and its corner portion is rounded. In some cases, being smooth refers to a state where few foreign substances are attached to the surface.

For the initial heating, there is no need to prepare a raw material such as the Li source. Alternatively, there is no need to prepare a material functioning as a fusing agent (which is added to facilitate fusion and also referred to as a flux).

When the heating time in this step is too short, a sufficient effect is not obtained, but when the heating time in this step is too long, the productivity is lowered. For example, any of the heating conditions described for Step S13 can be selected to perform the heating. As a supplementary explanation of the heating conditions, the heating temperature in this step is preferably lower than that in Step S13 so that the crystal structure of the composite oxide is maintained. The heating time in this step is preferably shorter than that in Step S13 so that the crystal structure of the composite oxide is maintained. For example, the heating is preferably performed at a temperature of higher than or equal to 700° C. and lower than or equal to 1000° C. for longer than or equal to 2 hours and shorter than or equal to 20 hours.

Examples of the effect of increasing the crystallinity of the composite oxide include an effect of reducing distortion due to differential shrinkage caused by heating of the composite oxide and an effect of reducing a shift due to the differential shrinkage.

The heating in Step S13 might cause a temperature difference between the surface and the inner portion of the above composite oxide. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the composite oxide, and this causes distortion. The above energy is sometimes referred to as distortion energy. The internal stress is eliminated by the initial heating in Step S15 and in other words, the distortion energy is probably reduced by the initial heating in Step S15. When the distortion energy is reduced, the distortion in the composite oxide is relieved. This is probably why the surface of the composite oxide becomes smooth through Step S15. In other words, it can be deemed that Step S15 reduces the differential shrinkage caused in the composite oxide and makes the surface of the composite oxide smooth. Step S15 may be referred to as tempering or annealing of the composite oxide.

Such differential shrinkage might cause a micro shift in the composite oxide such as a shift in a crystal plane. To reduce the shift, this step is preferably performed. Performing this step can reduce a shift in the composite oxide. When the shift is distributed uniformly, the surface of the composite oxide might become smooth. This is also referred to as alignment of crystal grains. In other words, it can be deemed that Step S15 reduces the shift in a crystal or the like which is caused in the composite oxide and makes the surface of the composite oxide smooth.

It can be said that when surface unevenness information in one cross section of a composite oxide is quantified with measurement data, a smooth surface of the composite oxide has a surface roughness at least less than or equal to 10 nm. The one cross section is, for example, a cross section obtained in scanning transmission electron microscope (referred to as STEM) observation.

In a lithium-ion battery including a composite oxide with a smooth surface as a positive electrode active material, degradation by charging and discharging is inhibited and a crack in the positive electrode active material can be prevented.

Note that in Step S14, a composite oxide containing lithium and the transition metal M synthesized in advance may be used. In this case, Step S1i to Step S13 can be omitted. When Step S15 is performed on the pre-synthesized composite oxide, a composite oxide with a smooth surface can be obtained.

The initial heating might reduce lithium in the composite oxide. An additive element described for Step S20_1 or the like below might easily enter the composite oxide owing to the reduction in lithium. When the additive element is added to the composite oxide having a smooth surface, the additive element can be uniformly added. It is thus preferable that the initial heating precede the addition of the additive element. The step of adding the additive element is described with reference to FIG. 2B.

### <Step S20_1> and <Step S21_1>

FIG. 2B illustrates details of Step S20_1 illustrated in FIG. 2A. In Step S21_1 in FIG. 2B, an additive element A1 source (A1 source) to be added to the composite oxide is prepared. In order to compensate for lithium reduced by the initial heating, a lithium source may be prepared in addition to the additive element A1 source.

As the additive element A1, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used.

When magnesium is selected as the additive element A1, the additive element A1 source can be referred to as a magnesium source (Mg source). As the magnesium source, magnesium fluoride, magnesium oxide, magnesium hydroxide, magnesium carbonate, or the like can be used. Two or more of these magnesium sources may be used.

When fluorine is selected as the additive element A1, the additive element A1 source can be referred to as a fluorine source (F source). As the fluorine source, for example, lithium fluoride, magnesium fluoride, aluminum fluoride, titanium fluoride, cobalt fluoride, nickel fluoride, zirconium fluoride, vanadium fluoride, manganese fluoride, iron fluoride, chromium fluoride, niobium fluoride, zinc fluoride, calcium fluoride, sodium fluoride, potassium fluoride, barium fluoride, cerium fluoride, lanthanum fluoride, sodium aluminum hexafluoride, or the like can be used. In particular, lithium fluoride is preferable because it is easily melted in a heating step described later owing to its relatively low melting point of 848° C. Note that FIG. 2B illustrates an example in which the Mg source and the F source are used as the additive element A1 source.

Magnesium fluoride can be used as both the fluorine source and the magnesium source. Lithium fluoride can also be used as the lithium source. Another example of the lithium source that can be used in Step S21_1 is lithium carbonate.

In this embodiment, lithium fluoride is prepared as the fluorine source, and magnesium fluoride is prepared as the fluorine source and the magnesium source. When lithium fluoride and magnesium fluoride are mixed at approximately LiF:MgF₂=65:35 (molar ratio), the effect of lowering the melting point is maximized. Meanwhile, when the proportion of lithium fluoride increases, cycle performance might be degraded because of an excessive amount of lithium. Therefore, in this embodiment, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or the neighborhood thereof). Note that “neighborhood” means a value greater than 0.9 times and less than 1.1 times a certain value.

Meanwhile, magnesium is preferably added at greater than 0.1 at % and less than or equal to 3 at %, further preferably greater than or equal to 0.5 at % and less than or equal to 2 at %, still further preferably greater than or equal to 0.5 at % and less than or equal to 1 at %, with respect to the number of Co atoms in LiMO₂, typically LiCoO₂, in Step S14. When magnesium is added at less than or equal to 0.1 at %, the initial discharge capacity is high but repeated high-voltage charging may rapidly lower the discharge capacity. In the case where magnesium is added at greater than 0.1 at %, i.e., greater than 0.1 at % and less than or equal to 3 at %, both the initial discharge characteristics and charge and discharge cycle performance are excellent even when high-voltage charging is repeated. By contrast, in the case where magnesium is added at greater than 3 at %, the initial discharge capacity tends to be low and the charge and discharge cycle performance tends to gradually degrade.

### <Step S22_1>

Next, in Step S22_1 illustrated in FIG. 2B, the magnesium source and the fluorine source are mixed while being ground. Any of the conditions for the grinding and the conditions for the mixing that are described for Step S12 can be selected to perform this step.

A heating step may be performed after Step S22_1 as needed. Any of the heating conditions described for Step S13 can be selected to perform this heating step. The heating time is preferably longer than or equal to 2 hours and the heating temperature is preferably higher than or equal to 800° C. and lower than or equal to 1100° C.

### <Step S23_1>

Next, in Step S231 illustrated in FIG. 2B, the materials ground and mixed in the above step are collected to give the additive element A1 source (A1 source). Note that the additive element A1 source illustrated in Step S231 may contain a plurality of raw materials such as the Mg source and the F source, in which case the A1 source can be referred to as a mixture.

As for the particle diameter of the mixture, the median diameter (D50) is preferably greater than or equal to 600 nm and less than or equal to 20 μm, further preferably greater than or equal to 1 μm and less than or equal to 10 μm. Also when one kind of material is used as the additive element A1 source, the median diameter (D50) is preferably greater than or equal to 600 nm and less than or equal to 20 μm, further preferably greater than or equal to 1 μm and less than or equal to 10 μm.

The mixture (which may contain only one kind of the additive element A1) having such a median diameter (D50) is easily attached to the surface of a composite oxide uniformly in a later step of mixing with the composite oxide. The mixture is preferably attached uniformly to the surface of the composite oxide, in which case fluorine and/or magnesium are/is easily distributed or dispersed uniformly in a surface portion of the composite oxide after heating. A region where fluorine and/or magnesium are/is distributed can also be referred to as a surface portion. When there is a region not containing fluorine and/or magnesium in the surface portion, an O3′ type crystal structure, which is described later, might be unlikely to be obtained in a charged state. Note that although fluorine is used in the above description, chlorine may be used instead of fluorine, and a general term “halogen” for these elements can replace “fluorine”.

### <Step S31>

Next, in Step S31 illustrated in FIG. 2A, the composite oxide and the additive element A1 source (A1 source) are mixed. The ratio of the number A_{M} of the transition metal M atoms in the composite oxide containing lithium and the transition metal M to the number A_{Mg} of magnesium atoms in the additive element A1 is preferably A_{M}:A_{Mg}=100:y (0.1≤y≤6), further preferably A_{M}:A_{Mg}=100:y (0.3≤y≤3).

The conditions of the mixing in Step S31 are preferably milder than the conditions of the grinding and mixing in Step S12 in order not to damage the composite oxide. For example, conditions with a lower rotational frequency or a shorter time than those for the mixing in Step S12 are preferable. In addition, a dry method has a milder condition and is thus more suitable than a wet method.

The above mixing is preferably performed in an atmosphere with a dew point higher than or equal to −100° C. and lower than or equal to −10° C. For example, the mixing can be performed in a dry room. The atmosphere of the dry room preferably includes a dry air.

### <Step S32>

Next, in Step S32 in FIG. 2A, the materials mixed in the above step are collected to give a mixture 903. At the time of the collection, the mixture 903 may be crushed to alleviate an aggregated state. The mixture 903 may be sieved to further alleviate the aggregated state. The sieving may be performed after the crushing is performed, the sieving may be performed while the crushing is performed, or only the sieving may be performed instead of the crushing.

Note that in this embodiment, the method is described in which lithium fluoride as the fluorine source and magnesium fluoride as the magnesium source are added afterward to the composite oxide that has been subjected to the initial heating; however, the present invention is not limited to the above method. The magnesium source, the fluorine source, and the like can be prepared in addition to the Li source and the M source in Step S11, i.e., at the stage of the starting materials of the composite oxide, and the process can proceed to Step S12. Then, the heating in Step S13 is performed, so that LiMO₂ to which magnesium and fluorine are added can be obtained. In this case, there is no need to separately perform Step S11 to Step S14 and Step S21_1 to Step S23_1. This method can be regarded as being simple and highly productive.

Alternatively, a composite oxide to which magnesium and fluorine are added in advance may be used. When a composite oxide to which magnesium and fluorine are added is used, Step S11 to Step S32 and Step S20_1 can be skipped. This method can be regarded as being simple and highly productive.

Alternatively, in accordance with Step S20_1, a magnesium source and a fluorine source may be further added to the composite oxide to which magnesium and fluorine are added in advance. Instead of the magnesium source and the fluorine source or in addition to the magnesium source and the fluorine source, a nickel source and an aluminum source may be added.

<Step S33>Then, in Step S33 illustrated in FIG. 2A, the mixture 903 is heated. Any of the heating conditions described for Step S13 can be selected to perform the heating. The heating time is preferably longer than or equal to 2 hours.

Here, a supplementary explanation of the heating temperature is given. The lower limit of the heating temperature in Step S33 needs to be higher than or equal to the temperature at which a reaction between the composite oxide (LiMO₂) and the additive element A1 source proceeds. The temperature at which the reaction proceeds is the temperature at which interdiffusion of the elements contained in the composite oxide and the additive element A1 source occurs, and may be lower than the melting temperatures of these materials. It is known that in the case of an oxide as an example, solid phase diffusion occurs at the Tamman temperature T_{d} (a temperature obtained as 0.757 times the melting temperature Tₘ of the oxide). Accordingly, the heating temperature in Step S33 is higher than or equal to 500° C.

Needless to say, the reaction more easily proceeds at a temperature higher than or equal to the temperature at which at least part of the mixture 903 is melted. For example, in the case where LiF and MgF₂ are contained in the additive element A1 source, the lower limit of the heating temperature in Step S33 is preferably higher than or equal to 742° C. because the eutectic point of LiF and MgF₂ is around 742° C.

The mixture 903 obtained by mixing at LiCoO₂:LiF:MgF₂=100:0.33:1 (molar ratio) exhibits an endothermic peak at around 830° C. in differential scanning calorimetry measurement (DSC measurement). Therefore, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature of the composite oxide. For example, in the case of LiCoO₂, the upper limit of the heating temperature is lower than its decomposition temperature of 1130° C. At around the decomposition temperature, a slight amount of LiMO₂ might be decomposed. The decomposition of LiMO₂ is not preferable because it may cause generation of a reaction product unnecessary for the composite oxide, typically Co₃O₄ in the case of lithium cobalt oxide. Thus, the upper limit of the heating temperature is preferably lower than or equal to 1000° C., further preferably lower than or equal to 950° C., still further preferably lower than or equal to 920° C.

In view of the above, the heating temperature in Step S33 is preferably higher than or equal to 500° C. and lower than 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 920° C., yet still further preferably higher than or equal to 500° C. and lower than or equal to 900° C. Furthermore, the heating temperature is preferably higher than or equal to 742° C. and lower than 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 920° C., yet still further preferably higher than or equal to 742° C. and lower than or equal to 900° C. Furthermore, the heating temperature is preferably higher than or equal to 800° C. and lower than 1130° C., further preferably higher than or equal to 800° C. and lower than or equal to 1000° C., still further preferably higher than or equal to 800° C. and lower than or equal to 950° C., yet still further preferably higher than or equal to 800° C. and lower than or equal to 920° C., yet still further preferably higher than or equal to 800° C. and lower than or equal to 900° C. Furthermore, the heating temperature is preferably higher than or equal to 830° C. and lower than 1130° C., further preferably higher than or equal to 830° C. and lower than or equal to 1000° C., still further preferably higher than or equal to 830° C. and lower than or equal to 950° C., yet still further preferably higher than or equal to 830° C. and lower than or equal to 920° C., yet still further preferably higher than or equal to 830° C. and lower than or equal to 900° C.

Note that the heating temperature in Step S33 is preferably lower than that in Step 513. This is to prevent the composite oxide (LiMO₂) from being decomposed. Note that the heating temperature in Step S33 is preferably higher than that in Step S15.

In addition, at the time of heating the mixture 903, the partial pressure of fluorine or a fluoride originating from the fluorine source or the like in a treatment chamber or in a crucible is preferably controlled to be within an appropriate range. In the fabrication method described in this embodiment, some of the materials, e.g., LiF as the fluorine source, function as a fusing agent in some cases. Owing to this function, the heating temperature can be lower than the decomposition temperature of the composite oxide (LiMO₂), e.g., a temperature higher than or equal to 742° C. and lower than or equal to 950° C., which allows distribution of the additive element A1 such as magnesium in the surface portion and fabrication of the positive electrode active material having favorable characteristics.

Note that LiF may be sublimated by the heating and the specific gravity of LiF in a gas state is lighter than that of oxygen; thus, LiF in the mixture 903 might be reduced. As a result, the function of a fusing agent deteriorates. Thus, the heating needs to be performed while the sublimation of LiF is inhibited. Note that even when LiF is not used as the fluorine source or the like, Li at the surface of LiMO₂ and F of the fluorine source might react to produce LiF, which might be sublimated. Therefore, such inhibition of sublimation is needed also when a fluoride having a higher melting point than LiF is used.

In view of this, the mixture 903 is preferably heated in an atmosphere containing LiF, i.e., the mixture 903 is preferably heated in a state where the partial pressure of LiF in the treatment chamber is high. Such heating can inhibit sublimation of LiF in the mixture 903. In addition, covering the container with a lid as described above can inhibit sublimation of LiF in the mixture 903.

This heating step is preferably performed such that the mixtures 903 are not adhered to each other. Adhesion of the mixtures 903 during the heating might decrease the area of contact with oxygen in the atmosphere and inhibit a path of diffusion of the additive element A1 (e.g., magnesium and/or fluorine), thereby hindering diffusion of the additive element A1 (e.g., magnesium and/or fluorine).

It is considered that uniform distribution of the additive element A1 (e.g., fluorine) in the surface portion leads to a smooth positive electrode active material with little unevenness. Thus, it is preferable that the mixtures 903 not be adhered to each other in order to allow the smooth surface obtained through the heating in Step S15 to be maintained or to be smoother in this step.

A supplementary explanation of the heating time is given here. The heating time depends on conditions such as the heating temperature and the size and composition of LiMO₂ in Step S14. In the case where the median diameter (D50) of LiMO₂ is small, the heating is preferably performed at a lower temperature or for a shorter time than heating in the case where the median diameter (D50) is large, in some cases. The median diameter (D50) can be obtained with a laser diffraction particle size distribution measurement apparatus.

In the case where lithium cobalt oxide is used as LiMO₂ in Step S14 in FIG. 2A and the median diameter (D50) of lithium cobalt oxide is approximately 12 μm, e.g., greater than or equal to 10 μm and less than or equal to 14 μm, the heating temperature in Step S33 is preferably higher than or equal to 800° C. and lower than or equal to 920° C., further preferably higher than or equal to 850° C. and lower than or equal to 920° C., for example. The heating time in Step S33 is further preferably longer than or equal to 10 hours, still further preferably longer than or equal to 20 hours, and may be longer than or equal to 60 hours, for example. The larger the median diameter (D50) is, the larger the volume of the composite oxide (LiMO₂) is. Thus, more heating time may be needed to achieve a state where the internal stress is relieved or the internal stress is removed in a bulk layer of the composite oxide or the like. When the median diameter (D50) is large, it takes time to uniformly distribute the additive element A1 such as magnesium in the surface portion; thus, the heating time sometimes becomes long as described above. Although the median diameter (D50) of lithium cobalt oxide is increased through the heat treatment in some cases, it is preferable that the median diameter (D50) after the heat treatment satisfy greater than or equal to m and less than or equal to 14 μm. That is, it is preferable that the median diameter (D50) of the positive electrode active material satisfy greater than or equal to 10 μm and less than or equal to 14 μm.

In the case where lithium cobalt oxide is used as LiMO₂ in Step S14 and the median diameter (D50) of lithium cobalt oxide is approximately 7 μm, e.g., greater than or equal to 5 m and less than or equal to 9 μm, the heating temperature in Step S33 is preferably in the same range as the heating temperature of the case where the median diameter (D50) is approximately 12 μm. Meanwhile, the heating time in Step S33 can be shorter than the heating time of the case where the median diameter (D50) is approximately 12 μm. The heating time is preferably longer than or equal to 1 hour and shorter than or equal to 10 hours, further preferably longer than or equal to 5 hours and shorter than or equal to 10 hours, for example. The smaller the median diameter (D50) is, the shorter the time for distributing the additive element A1 such as magnesium in the surface portion is. Thus, the heating time can be shortened as described above. The smaller the median diameter (D50) is, the smaller the volume of the composite oxide (LiMO₂) is. Thus, the time for tempering or annealing the bulk layer of the composite oxide or the like can be short. Although the median diameter (D50) of lithium cobalt oxide is increased through the heat treatment in some cases, it is preferable that the median diameter (D50) after the heat treatment satisfy greater than or equal to 5 μm and less than or equal to 9 μm. That is, it is preferable that the median diameter (D50) of the positive electrode active material satisfy greater than or equal to m and less than or equal to 9 μm.

After Step S33, a step of further adding an additive element different from the above-described additive element A1 is preferably provided. This step is described with reference to FIG. 2C.

### <Step S20_2> and <Step S21_2>

FIG. 2C illustrates details of Step S20_2 illustrated in FIG. 2A. In Step S21_2 in FIG. 2C, an additive element A2 source (A2 source) to be added to the composite oxide is prepared. A lithium source may be prepared in addition to the additive element A2 source.

As the additive element A2, one or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic can be used. As the additive element A2, it is preferable to use at least an element that is not selected as the additive element A1, but the element that is selected as the additive element A1 may be contained. Note that FIG. 2C illustrates an example in which a Ni source and an A1 source are used as the additive element A2 source.

In this embodiment, nickel hydroxide is prepared as the nickel source, and aluminum hydroxide is prepared as the aluminum source. Nickel oxide or nickel carbonate may be used instead of nickel hydroxide. Aluminum oxide or aluminum carbonate may be used instead of aluminum hydroxide.

### <Step S22_2>

Next, in Step S22_2 illustrated in FIG. 2C, the nickel source is mixed while being ground and the aluminum source is mixed while being ground. Any of the conditions for the grinding and the conditions for the mixing that are described for Step S12 can be selected to perform this step. Note that in this step, the nickel source and the aluminum source may be combined and then mixed while being ground, as in Step S22_1 in FIG. 2B.

A heating step may be performed after Step S22_2 as needed. Any of the heating conditions described for Step S13 can be selected to perform this heating step.

### <Step S23_2>

Next, in Step S232 illustrated in FIG. 2C, the materials ground or mixed in the above step are collected to give the additive element A2 source (A2 source).

### <Step S34>

Next, in Step S34 illustrated in FIG. 2A, the composite oxide that has been subjected to the heating in Step S33 and the additive element A2 source (A2 source) are mixed. As described above, a plurality of additive element A2 sources (A2 sources) may be prepared. The ratio of the number A_{M} of the transition metal M atoms in the composite oxide to the number A_{Ni} of nickel atoms in the additive element A2 is preferably A_{M}:A_{Ni}=100:y (0.1≤y≤3), further preferably A_{M}:A_{Ni}=100:y (0.3≤y≤1). The ratio of the number A_{M} of the transition metal M atoms in the composite oxide to the number A_{Al} of aluminum atoms in the additive element A2 is preferably A_{M}:A_{Al}=100:y (0.1≤y≤3), further preferably A_{M}:A_{Al}=100:y (0.3≤y≤1).

The mixing conditions in Step S34 can be selected from the mixing conditions described for Step S31.

### <Step S35>

Next, in Step S35 in FIG. 2A, the materials mixed in the above step are collected to give a mixture 904. At the time of the collection, the mixture 904 may be crushed to alleviate an aggregated state. The mixture 904 may be sieved to further alleviate the aggregated state. The sieving may be performed after the crushing is performed, the sieving may be performed while the crushing is performed, or only the sieving may be performed instead of the crushing.

### <Step S36>

Then, in Step S36 illustrated in FIG. 2A, the mixture 904 is heated. Any of the heating conditions described for Step S33 can be selected to perform the heating. The heating time is preferably longer than or equal to 2 hours.

As in Step S33, the heating temperature in Step S36 is preferably higher than or equal to 500° C. and lower than or equal to 1130° C., further preferably higher than or equal to 500° C. and lower than or equal to 1000° C., still further preferably higher than or equal to 500° C. and lower than or equal to 950° C., yet still further preferably higher than or equal to 500° C. and lower than or equal to 900° C. Furthermore, the heating temperature is preferably higher than or equal to 742° C. and lower than or equal to 1130° C., further preferably higher than or equal to 742° C. and lower than or equal to 1000° C., still further preferably higher than or equal to 742° C. and lower than or equal to 950° C., yet still further preferably higher than or equal to 742° C. and lower than or equal to 900° C. Furthermore, the heating temperature is preferably higher than or equal to 800° C. and lower than or equal to 1100° C., further preferably higher than or equal to 830° C. and lower than or equal to 1130° C., still further preferably higher than or equal to 830° C. and lower than or equal to 1000° C., yet still further preferably higher than or equal to 830° C. and lower than or equal to 950° C., yet still further preferably higher than or equal to 830° C. and lower than or equal to 900° C. Note that the heating temperature in Step S36 is preferably lower than that in Step S13. Note that the heating temperature in Step S36 is preferably lower than that in Step S33.

This heating step is preferably performed such that the mixtures 904 are not adhered to each other. Adhesion of the mixtures 904 during the heating might decrease the area of contact with oxygen in the atmosphere and inhibit a path of diffusion of the additive element A2, thereby hindering distribution of the additive element A2.

### <Step S37>

Next, the heated material is collected in Step S37 illustrated in FIG. 2A, in which crushing is performed as needed, to give the positive electrode active material 10. Here, the collected positive electrode active material 10 is preferably sieved. Through the above process, the positive electrode active material 10 of one embodiment of the present invention can be fabricated. The positive electrode active material of one embodiment of the present invention has a smooth surface. The above is an example of the method for fabricating the positive electrode active material.

### [Positive Electrode Active Material]

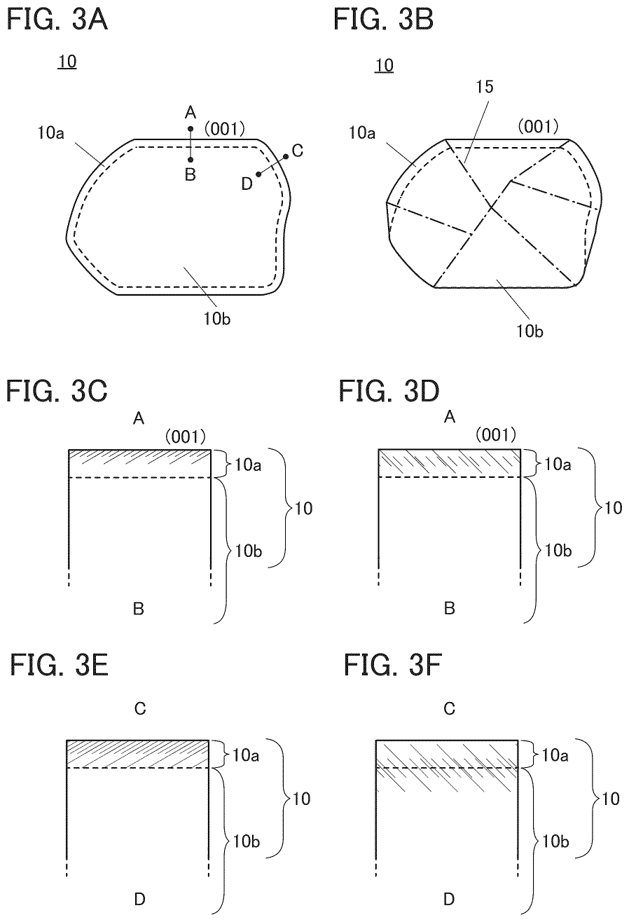

A cross section of the positive electrode active material 10 that can be obtained by the above fabrication method is described with reference to FIG. 3A. Unlike FIG. 3A, FIG. 3B illustrates a cross section of the positive electrode active material 10 in which a crystal grain boundary 15 is indicated by dashed-dotted lines. The positive electrode active material 10 illustrated in each of FIG. 3A and FIG. 3B includes a surface portion 10a and an inner portion (the inner portion is referred to as “bulk portion”) 10b, and a boundary therebetween is indicated by a dashed line. Note that the surface portion 10a preferably covers higher than or equal to 90% of the bulk portion 10b. Note that the dashed line in each of FIG. 3A and FIG. 3B is one example, the dashed-dotted lines in FIG. 3B are one example, and the proportion of the covering surface portion is also one example.

The surface portion 10a does not necessarily cover the entire bulk portion 10b. FIG. 3A and FIG. 3B each illustrate the positive electrode active material 10 in which the surface portion 10a covers higher than or equal to 50%, specifically higher than or equal to 65% and lower than or equal to 75% of the perimeter of the bulk portion 10b. For example, as illustrated in FIG. 3B, the positive electrode active material 10 may have a region where the bulk portion 10b is exposed.

The crystal grain boundary 15 illustrated in FIG. 3B refers to, for example, a portion where the positive electrode active materials 10 adhere to each other, or a portion where a crystal orientation changes inside the positive electrode active material 10, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, and the defect can be referred to as a structure including another element between lattices, a cavity, or the like. In other words, the crystal grain boundary 15 can be regarded as a plane defect. The vicinity of the crystal grain boundary 15 refers to a region that extends less than or equal to 20 nm, preferably less than or equal to 10 nm, with the crystal grain boundary 15 positioned in the middle, and the vicinity of the grain boundary exists both inside the grain and outside the grain. These can be distinguished from each other by being referred to as the vicinity of the grain boundary inside the grain and the vicinity of the grain boundary outside the grain.

Since the positive electrode active material 10 contains a composite oxide containing oxygen and a transition metal into and from which lithium can be inserted and extracted, an interface between a region where the transition metal M (e.g., Co, Ni, Mn, Fe, or the like) that becomes oxidized or reduced due to insertion and extraction of lithium is present and a region where the transition metal M is absent can be considered as the “surface” of the positive electrode active material. In some cases, the additive element is present in the region where the transition metal M is absent. A plane newly generated by slipping and/or a crack can also be considered as the surface of the positive electrode active material in some cases.

As described above, in this specification and the like, the surface portion 10a is a region to less than or equal to 50 nm, preferably less than or equal to 35 nm, further preferably less than or equal to 20 nm, most preferably less than or equal to 10 nm inward from the surface, for example. Alternatively, the surface portion may be rephrased as the vicinity of the surface, a region in the vicinity of the surface, or a shell. Note that the region to less than or equal to 50 nm, preferably less than or equal to 35 nm, further preferably less than or equal to 20 nm, most preferably less than or equal to 10 nm inward from the surface corresponds to a distance from the surface in the perpendicular or substantially perpendicular depth direction. The direction perpendicular or substantially perpendicular to the surface refers to a direction at an angle greater than or equal to 800 and less than or equal to 100° with respect to a tangent to the surface. The bulk portion 10b refers to a region deeper than the surface portion 10a. The bulk portion 10b is sometimes referred to as an inner portion and may be rephrased as a core. The bulk portion 10b may include a center portion of the positive electrode active material.

In the positive electrode active material 10, a region into and from which lithium is inserted and extracted may be the “surface”. Thus, the “surface” can be regarded as a region of the positive electrode active material 10 that is in contact with an electrolyte solution. For example, the surface of the positive electrode active material 10 includes the surface of the surface portion 10a, and may be the surface of the bulk portion 10b in the region where the bulk portion 10b is exposed.

A carbonate group, a hydroxy group, or the like chemically adsorbed on the positive electrode active material 10 after fabrication can be regarded as a region into and from which lithium cannot be inserted and extracted, and these do not constitute the surface of the positive electrode active material 10. Similarly, an electrolyte, a binder, a conductive material, or a compound originating from any of these that is attached to the positive electrode active material 10 does not constitute the surface of the positive electrode active material 10.

The “surface” of the positive electrode active material 10 in, for example, a cross-sectional STEM (scanning transmission electron microscope) image is a boundary between a region where a combined image of an electron beam is observed and a region where the image is not observed, and can be determined as the outermost surface of a region where a bright spot derived from an atomic nucleus of a metal element that has a larger atomic number than lithium is observed. The surface in a cross-sectional STEM image or the like may be determined also on the basis of higher spatial-resolution analysis results, e.g., electron energy loss spectroscopy (EELS).

The positive electrode active material needs to contain a transition metal which can undertake an oxidation-reduction reaction in order to maintain a neutrally charged state even when lithium ions are inserted and extracted. Although cobalt is mainly used as the transition metal M, which undertakes an oxidation-reduction reaction, in the positive electrode active material 10 of one embodiment of the present invention, at least one or two or more selected from nickel and manganese may be used in addition to cobalt. Using cobalt at higher than or equal to 75 at %, preferably higher than or equal to 90 at %, further preferably higher than or equal to 95 at % as the transition metal M contained in the positive electrode active material 10 brings many advantages such as relatively easy synthesis, easy handling, and excellent cycle performance, which is preferable.

Using nickel at higher than or equal to 33 at %, preferably higher than or equal to 60 at %, further preferably higher than or equal to 80 at % as the transition metal M contained in the positive electrode active material 10 is preferable because the cost of the raw materials can be lower than that in the case of using a large amount of cobalt and discharge capacity per weight can be increased in some cases.

As the additive element A (the additive element A1 and the additive element A2) contained in the positive electrode active material 10, one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic are preferably used as described above.

That is, the positive electrode active material 10 can refer to lithium cobalt oxide to which the additive element A is added. As described later, the additive element A can further stabilize the crystal structure of the positive electrode active material 10.

Note that one or two or more selected from nickel, cobalt, magnesium, calcium, chlorine, fluorine, aluminum, manganese, titanium, zirconium, yttrium, vanadium, iron, chromium, niobium, lanthanum, hafnium, zinc, silicon, sulfur, phosphorus, boron, and arsenic are not necessarily contained as the additive element A.

For example, when the positive electrode active material 10 is substantially free from manganese as the additive element A, the above advantages such as relatively easy synthesis, easy handling, and excellent cycle performance are enhanced. The weight of manganese contained in the positive electrode active material 10 is preferably less than or equal to 600 ppm, further preferably less than or equal to 100 ppm, for example. The weight of manganese can be analyzed with a glow discharge mass spectrometer (GD-MS), for example.

### <Crystal Structure>

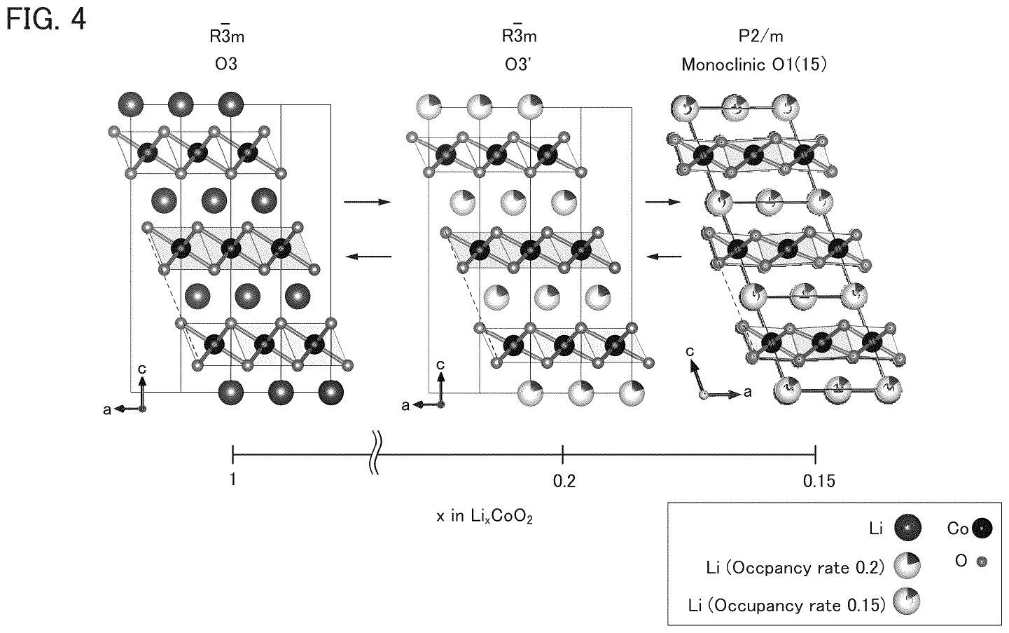

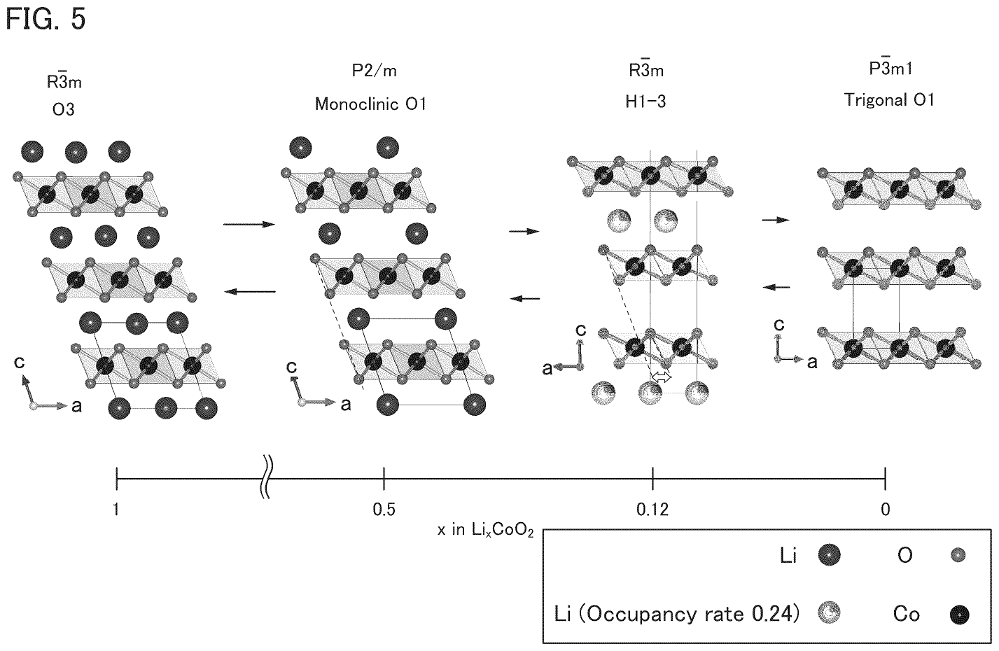

On the basis of comparison between a conventional positive electrode active material and the positive electrode active material 10 that can be used as one embodiment of the present invention, changes in crystal structures owing to a change in x in LixCoO₂ will be described with reference to FIG. 4 to FIG. 8. FIG. 4 illustrates the crystal structures of the positive electrode active material 10 that can be used as one embodiment of the present invention, and FIG. 5 illustrates the crystal structures of a conventional positive electrode active material. Note that the conventional positive electrode active material illustrated in FIG. 5 is lithium cobalt oxide (LiCoO₂) without an additive element in particular. Note that in this specification and the like, “without an additive element in particular” refers to the case where the amount of any additive element measured with an analysis means is lower than or equal to the lower detection limit, or refers to the case where any additive element is contained to such an extent that the presence or absence of an operation effect is not affected when the amount of the additive element is extremely close to the lower detection limit.

<<x in LiₓCoO₂ being 1>>

The positive electrode active material 10 that can be used as one embodiment of the present invention preferably has a layered rock-salt crystal structure belonging to the space group R-3m in the case where x in LiₓCoO₂ is 1, i.e., in a discharged state. In this crystal structure, lithium occupies octahedral sites and a unit cell includes three CoO₂ layers. Thus, this crystal structure is referred to as an O3 type crystal structure in some cases. Note that the CoO₂ layer has a structure in which an octahedral structure with cobalt coordinated to six oxygen atoms continues on a plane in an edge-shared state. The CoO₂ layer is sometimes referred to as a layer formed of octahedrons of cobalt and oxygen. In FIG. 4, the crystal structure with x in LiₓCoO₂ being 1 is denoted by R-3m (O3). Also in FIG. 5, the crystal structure with x in LiₓCoO₂ being 1 is the same as the crystal structure illustrated in FIG. 4 and is similarly denoted by R-3m (O3).

A composite oxide having a layered rock-salt structure excels as a positive electrode active material of a lithium-ion battery because it has high discharge capacity and a two-dimensional diffusion path for lithium ions and is thus suitable for an insertion/extraction reaction of lithium ions. For this reason, it is preferable that the bulk portion 10b, which accounts for the majority of the positive electrode active material 10, have a layered rock-salt crystal structure.

The surface portion 10a of the positive electrode active material 10 that can be used as one embodiment of the present invention does not necessarily have the layered rock-salt crystal structure. The surface portion 10a preferably has a function of reinforcing the layered structure, which is formed of octahedrons of cobalt and oxygen, of the bulk portion 10b so that the layered structure does not break even when lithium is extracted from the positive electrode active material 10 by charging. Alternatively, the surface portion 10a preferably functions as a barrier film of the positive electrode active material 10. Alternatively, the surface portion 10a, which is the outer portion of the positive electrode active material 10, preferably reinforces the positive electrode active material 10. Here, the term “reinforce” means inhibition of a change in the structures of the surface portion 10a and the bulk portion 10b of the positive electrode active material 10 such as extraction of oxygen and/or inhibition of oxidative decomposition of an electrolyte on the surface of the positive electrode active material 10.

The surface portion 10a is a region from which lithium ions are extracted initially in charging, and is a region that tends to have a lower concentration of lithium than the bulk portion 10b. Bonds between atoms on the surface of the positive electrode active material 10 included in the surface portion 10a are partly cut when lithium ions are extracted. Thus, the surface portion 10a is regarded as a region that tends to be unstable and tends to start a change, i.e., deterioration of the crystal structure. Meanwhile, when the surface portion 10a can be made sufficiently stable, the layered structure of the CoO₂ layers of the bulk portion 10b is unlikely to be broken even with small x in LiₓCoO₂, e.g., with x of less than or equal to 0.24. Furthermore, a shift in CoO₂ layers of the bulk portion 10b can be inhibited.

In order that the surface portion 10a can have a stable composition and a stable crystal structure, the surface portion 10a preferably contains an additive element A, further preferably contains a plurality of additive elements A. The surface portion 10a preferably has a higher concentration of one or two or more selected from the additive elements A than the bulk portion 10b. The one or two or more selected from the additive elements A contained in the positive electrode active material 10 preferably have a concentration gradient. In addition, it is further preferable that the additive elements A contained in the positive electrode active material 10 be differently distributed. For example, it is further preferable that the additive elements A exhibit concentration peaks at different depths from a surface. The concentration peak here refers to the local maximum value of the concentration in the surface portion 10a or a region to less than or equal to 50 nm inward from the surface.

Here, the above-described concentration gradient, concentration peak, and the like are described using also conceptual diagrams in FIG. 3C to FIG. 3F.

FIG. 3C and FIG. 3D illustrate enlarged views of the vicinity of A-B in FIG. 3A. FIG. 3C and FIG. 3D can each be regarded as a cross-sectional view of a surface portion having a (001) plane (hereinafter referred to as a (001) plane or sometimes referred to as a c-plane or a basal plane), that is, a cross-sectional view of a (001)-oriented region. In a layered rock-salt crystal structure, cations are arranged parallel to the (001) plane. In other words, CoO₂ layers and lithium layers are alternately stacked parallel to the (001) plane. Accordingly, a diffusion path for lithium ions exists parallel to the (001) plane. Since the CoO₂ layer is relatively stable, the (001) plane having the CoO₂ layer existing at the surface is relatively stable and a main diffusion path for lithium ions in charging and discharging is not exposed at the (001) plane.

FIG. 3C illustrating such a (001) plane illustrates distribution of magnesium or the like as an example of the additive element A. Gradation in FIG. 3C corresponds to a change in magnesium concentration. Since the CoO₂ layer is relatively stable at the (001) plane, the additive element A is not detected in some cases. As an example of distribution of the additive element A in the case where the additive element A is detected, FIG. 3C illustrates a state where the additive element A exists at the highest concentration at the surface of the surface portion 10a or in the vicinity of the surface and the concentration of the additive element A decreases toward the bulk portion 10b. It can be said that the concentration peak of magnesium or the like is at a position showing the highest concentration. A state where the concentration decreases is referred to as a concentration gradient in some cases. Note that in this specification and the like, the additive element A showing such a distribution as in FIG. 3C at the (001) plane is referred to as an additive element X.

FIG. 3D illustrates distribution of aluminum as another example of the additive element A. Gradation in FIG. 3D corresponds to a change in aluminum concentration. Since the CoO₂ layer is relatively stable at the (001) plane, the additive element A is not detected in some cases. As an example of distribution of the additive element A in the case where the additive element A is detected, FIG. 3D illustrates a state where the additive element A exists at the highest concentration at a deeper position than the surface of the surface portion 10a or the vicinity of the surface and the concentration of the additive element A decreases toward the surface and the bulk portion 10b. It can be said that the concentration peak of aluminum is at a position showing the highest concentration, and unlike the above-described concentration peak of magnesium or the like, the concentration peak of aluminum is at a slightly deeper position in some cases. A state where the concentration decreases is referred to as a concentration gradient in some cases. Note that in this specification and the like, the additive element A showing such a distribution as in FIG. 3D at the (001) plane is referred to as an additive element Y.

Depending on the element, the additive element A may show a distribution like that of the additive element X or a distribution like that of the additive element Y, and the distributions may be different from each other. In addition, depending on the element, the additive element A may have a concentration peak position like that of the additive element X or a concentration peak position like that of the additive element Y, and the concentration peak positions may be different from each other.

FIG. 3E and FIG. 3F illustrate enlarged views of the vicinity of C-D in FIG. 3A. FIG. 3E and FIG. 3F can each be regarded as a cross-sectional view of a surface portion having a plane other than the (001) plane (hereinafter sometimes referred to as an ab plane or an edge plane), and the plane other than the (001) plane in a layered rock-salt crystal structure is a plane where a diffusion path for lithium ions exists.

FIG. 3E illustrating such a plane other than the (001) plane illustrates distribution of magnesium or the like as an example of the additive element X. In some cases, the concentration of the additive element X is higher at the plane other than the (001) plane in FIG. 3E than at the (001) plane in FIG. 3C. The concentration peak of magnesium or the like is sometimes positioned at the surface of the surface portion 10a or in the vicinity of the surface, and sometimes shows a higher intensity than the concentration peak at the (001) plane in FIG. 3C. In addition, the additive element X is sometimes distributed in a wide range at the plane other than the (001) plane in FIG. 3E.

FIG. 3F illustrates distribution of aluminum or the like as an example of the additive element Y. The concentration peak of aluminum at either the (001) plane in FIG. 3D or the plane other than the (001) plane in FIG. 3F is preferably positioned in a region to greater than or equal to 5 nm and less than or equal to 50 nm inward from the surface. Depending on the heat treatment conditions, the concentration peak of aluminum is sometimes deeper at the plane other than the (001) plane in FIG. 3F than at the (001) plane in FIG. 3D.

In this manner, the distribution of the additive element may differ depending on the plane direction of the positive electrode active material.

As described above, the diffusion path for lithium ions exists at a surface corresponding to the plane other than the (001) plane, and the diffusion path for lithium ions is exposed at the surface corresponding to the plane other than the (001) plane. Thus, the surface portion 10a corresponding to the plane other than the (001) plane as illustrated in FIG. 3E and FIG. 3F easily loses stability because it is a region where lithium ions are extracted initially, while it is an important region for maintaining the diffusion path for lithium ions. Thus, it is preferable that the plane other than the (001) plane and the surface portion 10a corresponding thereto be preferentially reinforced in order to maintain the crystal structure of the entire positive electrode active material 10. That is, it is preferable that the additive element A preferentially exist at the plane other than the (001) plane and in the surface portion 10a corresponding thereto.

As described in the above manufacturing method, the fabrication method in which LiCoO₂ formed through the initial heating is mixed with the additive element and then heated allows the additive element to spread through the diffusion path for lithium ions. Thus, distribution of the additive element at the plane other than the (001) plane illustrated in FIG. 3C and FIG. 3D and the surface portion 10a corresponding to that plane can easily fall within a preferred range.

The positive electrode active material 10 preferably has a smooth surface with little unevenness as described above; however, it is not necessary that the whole positive electrode active material 10 be smooth. For example, the positive electrode active material 10 may have unevenness due to slipping caused at a plane parallel to the (001) plane, e.g., a plane where lithium atoms are arranged. Slipping is also referred to as a stacking fault. For example, pressing is performed at the time of fabricating the positive electrode, and the pressing may deform LiCoO₂ along the lattice fringe direction (the ab plane direction). This deformation is also included in the slipping. The deformation includes forward and backward shifts of lattice fringes. When lattice fringes are shifted forward and backward from each other, steps are generated on the surface which is in the perpendicular direction with respect to the lattice fringes (the c-axis direction).

A surface generated as a result of slipping and the surface portion 10a thereof is often the (001) plane, and in the surface portion 10a corresponding to the (001) plane, the additive element is not present or is present at a concentration lower than or equal to the lower detection limit in some cases. Since the diffusion path for lithium ions is not exposed at the (001) plane and the (001) plane is relatively stable as described above, substantially no problem is caused even when the additive element is not present or is present at a concentration lower than or equal to the lower detection limit.

Note that in a composite oxide whose composition is LiCoO₂ and which has a layered rock-salt crystal structure belonging to R-3m, cobalt atoms are arranged parallel to the (001) plane. In a High-Angle Annular Dark Field Scanning TEM (HAADF-STEM) image, the luminance of cobalt, which has the largest atom number in LiCoO₂, is the highest. Thus, in a HAADF-STEM image, arrangement of atoms with high luminance can be regarded as arrangement of cobalt atoms. Repetition of such arrangement with a high luminance can be rephrased as crystal fringes or lattice fringes.

Next, the additive element is described. Magnesium, which is an example of the additive element X, is divalent, and a magnesium ion is more stable in lithium sites than in cobalt sites in the layered rock-salt crystal structure and thus is likely to enter the lithium sites. An appropriate concentration of magnesium in the lithium sites of the surface portion 10a facilitates reinforcement of the layered rock-salt crystal structure in the bulk portion 10b or the like. This is probably because magnesium in the lithium sites serves as a column supporting the CoO₂ layers. Moreover, magnesium can inhibit extraction of oxygen therearound in a state where x in LiₓCoO₂ is, for example, 0.24 or less, which is described later. Magnesium can also be expected to increase the density of the positive electrode active material 10. In addition, a high concentration of magnesium in the surface portion 10a can be expected to increase the corrosion resistance to hydrofluoric acid generated by the decomposition of the electrolyte solution.

An appropriate concentration of magnesium does not have an adverse effect on insertion and extraction of lithium in charging and discharging, and the above-described advantages can be obtained. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide or a fluoride) which is substituted for neither the lithium site nor the cobalt site might segregate at the surface of the positive electrode active material or the like to serve as a resistance component of a lithium-ion battery. As the concentration of magnesium in the positive electrode active material increases, the discharge capacity of the positive electrode active material decreases in some cases. This is probably because excess magnesium enters the lithium sites and the amount of lithium contributing to charging and discharging decreases.

Thus, the entire positive electrode active material 10 preferably contains an appropriate amount of magnesium. For example, the number of magnesium atoms is preferably greater than or equal to 0.001 times and less than or equal to 0.1 times, further preferably greater than 0.01 times and less than 0.04 times, still further preferably approximately 0.02 times the number of cobalt atoms. The amount of magnesium contained in the entire positive electrode active material 10 here may be a value obtained by element analysis on the entire positive electrode active material 10 using GD-MS (glow discharge mass spectrometry), ICP-MS (Inductively Coupled Plasma Mass Spectrometry), or the like, or may be a value based on the ratio of the raw materials compounded in the fabrication process of the positive electrode active material 10, for example.

Nickel, which is an example of the additive element X, can exist in both the cobalt site and the lithium site. Nickel preferably exists in the cobalt site because an oxidation-reduction potential can be lower than the case of cobalt, leading to an increase in discharge capacity.

In addition, when nickel is present in lithium sites, a shift in the layered structure formed of octahedrons of cobalt and oxygen can be inhibited. Moreover, a change in volume in charging and discharging is inhibited. Furthermore, an elastic modulus becomes large, i.e., hardness increases. This is probably because nickel in the lithium sites serves as a column supporting the CoO₂ layers.

Meanwhile, excess nickel increases the influence of distortion due to the Jahn-Teller effect, which is not preferable. Moreover, excess nickel might adversely affect insertion and extraction of lithium.

Thus, the entire positive electrode active material 10 preferably contains an appropriate amount of nickel. For example, the number of nickel atoms contained in the positive electrode active material 10 is preferably greater than 0% and less than 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than 7.5%. Alternatively, it is preferably greater than or equal to 0.05% and less than or equal to 2%. Alternatively, it is preferably greater than or equal to 0.1% and less than 7.5%. Alternatively, it is preferably greater than or equal to 0.1% and less than or equal to 4%. The amount of nickel described here may be a value obtained by element analysis on the entire positive electrode active material by GD-MS, ICP-MS, or the like, or may be a value based on the ratio of the raw materials compounded in the process of fabricating the positive electrode active material, for example.

Aluminum, which is an example of the additive element Y, can exist in the cobalt site in a layered rock-salt crystal structure. Since aluminum is a trivalent representative element and its valence does not change, lithium around aluminum is unlikely to move even in charging and discharging. Thus, aluminum and lithium therearound serve as columns to inhibit a change in the crystal structure. Furthermore, aluminum has effects of inhibiting elution of cobalt around aluminum and improving continuous charge tolerance. Moreover, an Al-O bond is stronger than a Co-O bond and thus extraction of oxygen around aluminum can be inhibited. These effects improve thermal stability. Hence, a lithium-ion battery including a positive electrode active material containing aluminum as the additive element can have improved safety. Furthermore, the positive electrode active material 10 can have a crystal structure that is unlikely to be broken even with repeated charging and discharging.

Moreover, it is preferable that aluminum, which is an example of the additive element Y, exist at a position slightly deeper than the surface (specifically, the concentration peak of aluminum be positioned in a region deeper than a region of the concentration peak of the additive element X). Alternatively, it is preferable that the presence of aluminum, which is an example of the additive element Y, be observed in a region deeper than the deepest position where the presence of the additive element X is observed. This is because lithium existing near aluminum substituted for lithium sites is fixed and thus aluminum substituted for lithium ions at the surface, if any, might block the diffusion path for lithium.

Meanwhile, excess aluminum might adversely affect insertion and extraction of lithium. Thus, the entire positive electrode active material 10 preferably contains an appropriate amount of aluminum. For example, in the entire positive electrode active material 10, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum contained in the entire positive electrode active material 10 may be a value obtained by element analysis on the entire positive electrode active material 10 with GD-MS, ICP-MS, or the like or may be a value based on the ratio of the raw materials compounded in the process of fabricating the positive electrode active material 10, for example.

Fluorine, which is an example of the additive element X, is a monovalent anion; when fluorine is substituted for part of oxygen in the surface portion 10a, the lithium extraction energy is lowered. This is because the change in valence of cobalt ions associated with lithium extraction is from trivalent to tetravalent in the case of not containing fluorine and is from divalent to trivalent in the case of containing fluorine, and the oxidation-reduction potentials in these cases differ from each other. It can thus be said that when fluorine is substituted for part of oxygen in the surface portion 10a of the positive electrode active material 10, lithium ions near fluorine are likely to be extracted and inserted smoothly. Thus, a lithium-ion battery including such a positive electrode active material 10 can have improved charge and discharge characteristics, improved large current characteristics, or the like. When fluorine is present in the surface portion 10a, which has a surface in contact with the electrolyte solution, the corrosion resistance to hydrofluoric acid can be effectively increased. As will be described in the following embodiment, a fluoride such as lithium fluoride that has a lower melting point than another additive element source can serve as a fusing agent (also referred to as a flux agent) for lowering the melting point of the other additive element source.

In the case where the surface portion 10a contains both magnesium and nickel, divalent magnesium might be able to be present more stably in the vicinity of divalent nickel. Thus, elution of magnesium might be inhibited even when x in LiₓCoO₂ is small. This can contribute to stabilization of the surface portion 10a.

Additive elements that are differently distributed, such as the additive element X and the additive element Y, are preferably contained at a time, in which case the crystal structure in a wider region can be stabilized. For example, in the case where the positive electrode active material 10 contains magnesium and nickel as the additive element X, and contains aluminum as the additive element Y, the crystal structure in a wide region can be stabilized as compared with the case where only the additive element X or the additive element Y is contained. In the case where the positive electrode active material 10 contains both the additive element X and the additive element Y as described above, the surface can be sufficiently stabilized by the additive element X such as magnesium; thus, the additive element Y such as aluminum is not necessary for the surface. It is preferable that aluminum be widely distributed in a deep region, for example, a region to greater than or equal to 5 nm and less than or equal to 50 nm in depth from the surface, in which case the crystal structure in a wider region can be stabilized.

When a plurality of the additive elements are contained as described above, the effects of the additive elements can contribute synergistically to further stabilization of the surface portion 10a. In particular, magnesium, nickel, and aluminum are preferably contained because a high effect of stabilizing the composition and crystal structure can be obtained.

Note that the surface portion 10a occupied by only a compound of an additive element and oxygen is not preferred because this surface portion 10a would make insertion and extraction of lithium difficult. For example, it is not preferable that the surface portion 10a be occupied by only MgO, a structure in which MgO and NiO(II) form a solid solution, and/or a structure in which MgO and CoO(II) form a solid solution. Thus, it is preferable that the surface portion 10a contain at least cobalt, also contain lithium in a discharged state, and have a secured path through which lithium is inserted and extracted.

To secure the sufficient path through which lithium is inserted and extracted, the concentration of cobalt is preferably higher than that of magnesium in the surface portion 10a. Alternatively, the concentration of cobalt is preferably higher than that of nickel in the surface portion 10a. Alternatively, the concentration of cobalt is preferably higher than that of aluminum in the surface portion 10a. Alternatively, the concentration of cobalt is preferably higher than that of fluorine in the surface portion 10a.

Moreover, excess nickel might hinder diffusion of lithium; thus, the concentration of magnesium is preferably higher than that of nickel in the surface portion 10a.

It is preferable that some additive elements, in particular, magnesium and nickel have higher concentrations in the surface portion 10a than in the bulk portion 10b and exist randomly also in the bulk portion 10b to have low concentrations. It is also preferable that aluminum, which is one of the additive elements, exist randomly also in the bulk portion 10b to have a low concentration. When magnesium and aluminum exist in the lithium sites of the bulk portion 10b at appropriate concentrations, an effect of facilitating maintenance of the layered rock-salt crystal structure can be obtained in a manner similar to the above. When nickel exists in the bulk portion 10b at an appropriate concentration, a shift in the layered structure formed of octahedrons of cobalt and oxygen can be inhibited in a manner similar to the above. Also in the case where both magnesium and nickel are contained, a synergistic effect of suppressing elution of magnesium can be expected in a manner similar to the above.

It is preferable that the crystal structure of lithium cobalt oxide continuously change from the bulk portion 10b toward the surface portion 10a owing to the concentration gradients of the additive elements. In that case, the surface portion 10a preferably has a more stable composition and a more stable crystal structure than those of the bulk portion 10b at room temperature (25° C.). For example, at least part of the surface portion 10a of the positive electrode active material 10 that can be used as one embodiment of the present invention preferably has the rock-salt crystal structure. Alternatively, the surface portion 10a preferably has both a layered rock-salt crystal structure and a rock-salt crystal structure. Alternatively, the surface portion 10a preferably has features of both a layered rock-salt crystal structure and a rock-salt crystal structure.

Alternatively, it is preferable that the surface portion 10a and the bulk portion 10b have substantially the same crystal orientation owing to the concentration gradients of the additive elements. Alternatively, it is preferable that the surface portion 10a and the bulk portion 10b be topotaxy.

In this specification and the like, topotaxy refers to having similarity in a three-dimensional structure such that crystal orientations are substantially aligned with each other, or to having the same orientations crystallographically. Note that epitaxy refers to similarity in structures of two-dimensional interfaces.

By the surface portion 10a and the bulk portion 10b having a topotaxy relationship, distortion in a crystal structure and/or a shift in atomic arrangement of crystal structure can be reduced. This can prevent the cause of a pit. In this specification and the like, a pit refers to a hole formed by progress of a defect in a positive electrode active material.

<<x in LiₓCoO₂ being Small>>

The crystal structure in a charged state, i.e., in a state where x in LiₓCoO₂ is small, of the positive electrode active material 10 that can be used as one embodiment of the present invention is different from that of a conventional positive electrode active material because the positive electrode active material 10 has the above-described additive element distribution and/or crystal structure. In this specification and the like, “x is small” means 0.1<x≤0.24 as described above.

First, conventional LiₓCoO₂ with x=0.5, which corresponds to the case where x is slightly small, has an improved symmetry of lithium and have a monoclinic crystal structure belonging to the space group P2/m as illustrated in FIG. 5. This structure includes one CoO₂ layer in a unit cell. Thus, this crystal structure is referred to as a monoclinic O1 type structure or an O1 type structure in some cases. In FIG. 5, the crystal structure with x=0.5 is denoted by P2/m (monoclinic O1).

Furthermore, conventional LiₓCoO₂ with x=0 has a trigonal crystal structure belonging to a space group P-3m1 and includes one CoO₂ layer in a unit cell as illustrated in FIG. 5. Thus, this crystal structure is referred to as a trigonal O1 type structure or an O1 type structure in some cases. Moreover, in some cases, this crystal structure is referred to as a hexagonal O1 type structure when the trigonal crystal is converted into a composite hexagonal lattice. In FIG. 5, the crystal structure with x=0 is denoted by P-3m1 (trigonal O1).

Conventional LiₓCoO₂ with x=0.12, which corresponds to the case where x is small, has a crystal structure belonging to the space group R-3m as illustrated in FIG. 5. This structure can also be regarded as a structure in which CoO₂ structures such as trigonal O1 type structures and LiCoO₂ structures such as R-3m (O3) are alternately stacked. Thus, this crystal structure is referred to as an H1-3 type crystal structure in some cases. Note that the number of cobalt atoms per unit cell in the actual H1-3 type crystal structure is twice that in other structures. However, in this specification and the like, including FIG. 5, the c-axis of the H1-3 type crystal structure is half that of the unit cell for easy comparison with the other crystal structures. In FIG. 5, the crystal structure with x=0.12 is denoted by R-3m1 (H1-3).

For the H1-3 type crystal structure, the coordinates of cobalt and oxygen in the unit cell can be represented by Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a certain crystal structure can be determined by the Rietveld analysis of X-ray diffraction (referred to as XRD), for example. In the Rietveld analysis, a unit cell is selected such that the value of GOF (goodness of fit) is small.

When charging that makes x in LiₓCoO₂ be 0.12 or less, which corresponds to the case where x is small, and discharging are repeated, the crystal structure of conventional lithium cobalt oxide repeatedly changes between the R-3m (O3) type crystal structure in a discharged state and the H1-3 type crystal structure (i.e., an unbalanced phase change) as illustrated in FIG. 5.

However, there is a large shift in the CoO₂ layers between these two crystal structures. As indicated by the dotted lines and the arrow in the crystal structure denoted by R-3m1 (H1-3) in FIG. 5, the CoO₂ layer in the H1-3 type crystal structure largely shifts from R-3m (O3) in a discharged state. Such a dynamic structural change can adversely affect the stability of the crystal structure.

A difference in volume is also large between these two crystal structures causing such a dynamic structure change. The difference in volume per the same number of cobalt atoms between the R-3m (O3) type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.12 or less and discharging are repeated, the crystal structure of conventional lithium cobalt oxide is gradually broken. The broken crystal structure triggers degradation of the cycle performance. This is because the broken crystal structure has a smaller number of sites where lithium can exist stably and makes it difficult to insert and extract lithium. Note that the breakdown of the crystal structure frequently occurs not only when charging that makes x be 0.12 or less and discharging are repeated but also when x is actually 0.24 or less, causing the degradation of cycle performance. Thus, charging and discharging of a lithium-ion battery are repeated in practical use while the conventional lithium cobalt oxide is controlled such that x exceeds 0.24.

On the other hand, in the positive electrode active material 10 that can be used as one embodiment of the present invention illustrated in FIG. 4, a change in the crystal structure between a discharged state with x in LiₓCoO₂ being 1 and a state with x=0.2 or a state with x=0.15, which corresponds to x of 0.24 or less, is smaller than that in the conventional positive electrode active material. Specifically, in the positive electrode active material 10, a shift in the CoO₂ layers between the state with x of 1 and the state with x of 0.24 or less can be small. Furthermore, in the positive electrode active material 10, a change in the volume per the same number of cobalt atoms can be small. Thus, the positive electrode active material 10 can have a crystal structure that is difficult to break even when charging that makes x be 0.24 or less and discharging are repeated, and enables excellent cycle performance. In addition, the positive electrode active material 10 with x in LiₓCoO₂ being 0.24 or less can have a more stable crystal structure than the conventional positive electrode active material. Thus, in the case where the state with x in LiₓCoO₂ being 0.24 or less is maintained in the positive electrode active material 10, a short circuit is less likely to occur and the safety of the lithium-ion battery is improved.

FIG. 4 illustrates the crystal structures of the positive electrode active material 10 with x=0.2 and x=0.15, which fall within 0.1<x≤0.24. The positive electrode active material 10 with x=0.2 and x=0.15 has crystal structures different from the H1-3 type crystal structure of the conventional lithium cobalt oxide.

Specifically, the positive electrode active material 10 with x=0.2 has a trigonal crystal structure belonging to the space group R-3m. The symmetry of the CoO₂ layers of this structure is the same as that of O3. Thus, this crystal structure is referred to as “O3′ type crystal structure” in this specification and the like. In FIG. 4, the crystal structure with x=0.2 is denoted by R-3m (O3)′. Although the positive electrode active material 10 with x=0.2 is described as having the O3′ type crystal structure, the positive electrode active material 10 can have the O3′ type crystal structure when x is approximately 0.2. The case where x is approximately 0.2 can be expressed as, for example, 0.18≤x≤0.24, typically 0.18≤x≤0.22.

In the unit cell of the O3′ type crystal structure, the coordinates of cobalt and oxygen can be represented by Co (0, 0, 0.5) and 0 (0, 0, x) within the range of 0.20≤x≤0.25. In the unit cell, the lattice constant a is preferably 0.2797 a 0.2837 (nm), further preferably 0.2807≤a≤0.2827 (nm), typically a=0.2817 (nm). The lattice constant c is preferably 1.368≤c≤1.388 (nm), further preferably 1.375≤c≤1.381 (nm), typically, c=1.378 (nm).

The positive electrode active material 10 with x=0.15 as an example of 0.1<x≤0.24 has a monoclinic crystal structure belonging to the space group P2/m. This structure includes one CoO₂ layer in a unit cell. Thus, this crystal structure is referred to as “monoclinic O1(15) type crystal structure” in this specification and the like. In FIG. 4, the crystal structure with x=0.15 is denoted by P2/m (monoclinic O1(15)). Although the positive electrode active material 10 with x=0.15 is described as having the monoclinic O1(15) type crystal structure, the positive electrode active material 10 can have the monoclinic O1(15) type crystal structure when x is approximately 0.15. The case where x is approximately 0.15 can be expressed as, for example, 0.13≤x≤0.24, typically 0.13≤x≤0.18.

In the unit cell of the monoclinic O1(15) type crystal structure, the coordinates of cobalt and oxygen can be represented by Co1 (0.5, 0, 0.5), Co2 (0, 0.5, 0.5), O1 (X_{O1}, 0, Z_{O1}) within the ranges of 0.23≤X_{O1}≤0.24 and 0.61≤Z_{O1}≤0.65, and O2 (X_{O2}, 0.5, Z_{O2}) within the ranges of 0.75≤X_{O2}≤0.78 and 0.68≤Z_{O2}≤0.71. In the unit cell, the lattice constant a is a=0.488±0.001 (nm), the lattice constant b is b=0.282±0.001 (nm), and c=0.484±0.001 (nm). Angles representing the monoclinic structure are α=90°, β=109.58±0.01°, and γ=90°.

Note that this crystal structure can be fitted even when belonging to the space group R-3m if a certain range of error is allowed. The coordinates of cobalt and oxygen in the unit cell in this case can be represented by Co (0, 0, 0.5) and 0 (0, 0, Z_{O}) within the range of 0.21≤Z_{O}≤0.23. In the unit cell, the lattice constant a is a=0.2817±0.002 (nm), and the lattice constant c is c=1.368±0.002 (nm).

In both of the O3′ type crystal structure and the monoclinic O1(15) type crystal structure, an ion of cobalt, nickel, magnesium, or the like occupies a site coordinated to six oxygen atoms. Note that a light element such as lithium sometimes occupies a site coordinated to four oxygen atoms.

As indicated by the dotted lines along the end portions of the CoO₂ layers in FIG. 4, the CoO₂ layers hardly shift between the R-3m (O3) type crystal structure in a discharged state, the O3′ type crystal structure, and the monoclinic O1(15) type crystal structure. The R-3m (O3) type crystal structure in a discharged state and the O3′ type crystal structure which contain the same number of cobalt atoms have a difference in volume of 2.5% or less, specifically 2.2% or less, typically 1.8%. The R-3m (O3) type crystal structure in a discharged state and the monoclinic O1(15) type crystal structure which contain the same number of cobalt atoms have a difference in volume of 3.3% or less, specifically 3.0% or less, typically 2.5%.

In the positive electrode active material 10, it can be found that a change in the crystal structure caused when x in LiₓCoO₂ is small, i.e., when a large amount of lithium is extracted, is smaller than that in a conventional positive electrode active material. In addition, a change in the volume per the same number of cobalt atoms is inhibited. This indicates that the crystal structure of the positive electrode active material 10 is less likely to be broken even when charging that makes x be 0.24 or less and discharging are repeated, so that a decrease in charge and discharge capacities of the positive electrode active material 10 in charge and discharge cycles is inhibited. Furthermore, the positive electrode active material 10 can stably use a larger amount of lithium than the conventional positive electrode active material and thus has high discharge capacity per weight and per volume. Thus, with use of the positive electrode active material 10, a lithium-ion battery with high discharge capacity per weight and per volume can be fabricated.

Note that the positive electrode active material 10 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. In addition, the positive electrode active material 10 is confirmed to have the monoclinic O1(15) type crystal structure in some cases when x in LiₓCoO₂ is greater than 0.1 and less than or equal to 0.2, typically greater than or equal to 0.13 and less than or equal to 0.18. However, the crystal structure is influenced by not only x in LiₓCoO₂ but also the number of charge and discharge cycles, a charge current and a discharge current, temperature, an electrolyte, and the like, so that the range of x is not limited to the above.

Thus, when x in LiₓCoO₂ is greater than 0.1 and less than or equal to 0.24, the positive electrode active material 10 may have only the O3′ type crystal structure, only the monoclinic O1(15) type crystal structure, or both of them. The entire bulk portion 10b of the positive electrode active material 10 does not necessarily have the O3′ type crystal structure and/or the monoclinic O1(15) type crystal structure. The positive electrode active material may include another crystal structure or may be partly amorphous.

In order to make x in LiₓCoO₂ small, charging at a high charge voltage is necessary in general. Thus, the state where x in LiₓCoO₂ is small can be rephrased as a state where charging at a high charge voltage has been performed. In other words, the positive electrode active material 10 is preferable because the R-3m (O3) type crystal structure can be maintained even when charging at a high charge voltage of 4.6 V or higher is performed at 25° C., for example. In other words, the positive electrode active material 10 is preferable because the O3′ type crystal structure can be obtained when charging at a higher charge voltage of higher than or equal to 4.65 V and lower than or equal to 4.7 V is performed at 25° C., for example. In other words, the positive electrode active material 10 is preferable because the monoclinic O1(15) type crystal structure can be obtained when charging at an even higher charge voltage of higher than 4.7 V and lower than or equal to 4.8 V is performed at 25° C., for example.

In the positive electrode active material 10, when the charge voltage is further increased, the H1-3 type crystal is eventually observed in some cases. As described above, the crystal structure is influenced by the number of charge and discharge cycles, a charge current and a discharge current, an electrolyte, and the like, so that the positive electrode active material 10 that can be used as one embodiment of the present invention sometimes has the O3′ type crystal structure even at a lower charge voltage of higher than or equal to 4.5 V and lower than 4.6 V at 25° C., for example. Similarly, the positive electrode active material 10 may sometimes have the monoclinic O1(15) type crystal structure at a charge voltage of higher than or equal to 4.65 V and lower than or equal to 4.7 V at 25° C.

Note that in the case where graphite is used as a negative electrode active material in a lithium-ion battery, for example, the voltage of the lithium-ion battery is lower than the above-mentioned voltage by the potential of graphite. The potential of graphite is approximately 0.01 V to 0.7 V with reference to the potential of lithium metal. Thus, for a lithium-ion battery using graphite as a negative electrode active material, a similar crystal structure is obtained at a voltage obtained by subtracting the potential of the graphite from the above-described voltage.

Although a chance of the existence of lithium is the same in all lithium sites in the O3′ type crystal structure and the monoclinic O1(15) type crystal structure in FIG. 4, one embodiment of the present invention is not limited thereto. Lithium may exist unevenly in only some of the lithium sites. Distribution of lithium can be analyzed by neutron diffraction, for example.

The O3′ type crystal structure and the monoclinic O1(15) type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ type crystal structure in general.

The additive element concentration gradient is preferably similar in a plurality of portions of the surface portion 10a of the positive electrode active material 10. In other words, it is preferable that the reinforcement derived from the additive element uniformly occurs in the surface portion 10a. When the surface portion 10a partly has reinforcement, stress might be concentrated on parts that do not have reinforcement. The concentration of stress on part of the positive electrode active material 10 might cause defects such as cracks from that part, leading to breakage of the positive electrode active material and a decrease in discharge capacity. Note that the additive elements do not necessarily have similar concentration gradients throughout the surface portion 10a of the positive electrode active material 10.

### <<Crystal Grain Boundary>>

It is further preferable that the additive element contained in the positive electrode active material 10 that can be used as one embodiment of the present invention be distributed as described above and unevenly distributed at least partly at the crystal grain boundary 15 illustrated in FIG. 3B and in the vicinity thereof.

For example, the magnesium concentration at the crystal grain boundary 15 and in the vicinity thereof in the positive electrode active material 10 is preferably higher than that in the other region of the bulk portion 10b. In addition, the fluorine concentration at the crystal grain boundary 15 and in the vicinity thereof is preferably higher than that in the other region of the bulk portion 10b. In addition, the nickel concentration at the crystal grain boundary 15 and in the vicinity thereof is preferably higher than that in the other region of the bulk portion 10b. In addition, the aluminum concentration at the crystal grain boundary 15 and in the vicinity thereof is preferably higher than that in the other region of the bulk portion 10b.

The crystal grain boundary 15 is a plane defect, and thus tends to be unstable and tends to start a change in the crystal structure like the surface. Thus, the concentration of the additive element at the crystal grain boundary 15 and in the vicinity thereof is increased, so that a change in the crystal structure can be further effectively inhibited.

When the magnesium concentration and the fluorine concentration are high at the crystal grain boundary 15 and in the vicinity thereof, the magnesium concentration and the fluorine concentration in the vicinity of a surface generated by a crack are also high even when the crack is generated along the crystal grain boundary 15 in the positive electrode active material 10 that can be used as one embodiment of the present invention. Thus, the positive electrode active material including a crack can also have an increased corrosion resistance to hydrofluoric acid.

### <Analysis Method>

Whether or not a given positive electrode active material is the positive electrode active material 10 that can be used as one embodiment of the present invention, which has the O3′ type crystal structure and/or monoclinic O1(15) type crystal structure when x in LiₓCoO₂ is small, can be determined by analyzing a positive electrode including the positive electrode active material in a charged state with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt contained in the positive electrode active material can be analyzed with high resolution, the degrees of crystallinity and the crystal orientations can be compared, the distortion of lattice periodicity and the crystallite size can be analyzed, and a positive electrode itself obtained by disassembling a lithium-ion battery can be measured with sufficient accuracy, for example. A diffraction peak reflecting the crystal structure of the bulk portion 10b of the positive electrode active material 10, which accounts for the majority of the volume of the positive electrode active material 10, is obtained through XRD, in particular, powder XRD.

In the case where the measurement sample is a powder, measurement is sometimes referred to as the aforementioned powder XRD, and the powder can be set by, for example, being put in a glass sample holder or being sprinkled on a reflection-free silicon plate to which grease is applied. In the case where the measurement sample is a positive electrode, the positive electrode can be set by being attached to a substrate with a double-sided adhesive tape such that the position of the positive electrode active material layer can be adjusted to the measurement plane required by the apparatus.

In addition, in the case where x is too small, e.g., 0.1 or less, or under the condition where charge voltage is higher than 4.9 V, even the positive electrode active material 10 that can be used as one embodiment of the present invention sometimes has the H1-3 type crystal structure or the trigonal O1 type crystal structure. Thus, determining whether or not a positive electrode active material is the positive electrode active material 10 that can be used as one embodiment of the present invention requires analysis of the crystal structure by XRD and other methods and data such as charge capacity or charge voltage.

A positive electrode active material with small x sometimes causes a change in the crystal structure when exposed to the air. For example, the O3′ type crystal structure and the monoclinic O1(15) type crystal structure change into the H1-3 type crystal structure in some cases. For that reason, all samples subjected to analysis of crystal structures are preferably handled in an inert atmosphere such as an argon atmosphere.

Whether or not the additive element contained in a given positive electrode active material is in the above-described state can be determined by, for example, analysis using XPS, energy dispersive X-ray spectroscopy (EDX), EPMA (Electron Probe Micro Analysis), or the like.

The crystal structure of the surface portion 10a, the crystal grain boundary 15, or the like can be analyzed by electron diffraction of a cross section of the positive electrode active material 10, for example.

### <<Evaluation Conditions>>

An example of evaluation conditions for determining whether or not a given composite oxide is the positive electrode active material 10 that can be used as one embodiment of the present invention is a method where a coin cell (e.g., CR2032 type with a diameter of 20 mm and a height of 3.2 mm) including lithium metal as a counter electrode is fabricated and charged under predetermined conditions. An example of evaluation conditions for determining whether or not a given electrolyte is the electrolyte that can be used as one embodiment of the present invention is a method where a coin cell (e.g., CR2032 type with a diameter of 20 mm and a height of 3.2 mm) including lithium metal as a counter electrode is fabricated and charged under predetermined conditions.

A procedure 1 described below is an example for observing the physical properties of the positive electrode active material 10 that can be used as one embodiment of the present invention. Thus, an electrolyte is different from that in the lithium-ion battery of one embodiment of the present invention.

### <<Evaluation Procedure 1>>

A given lithium-ion battery is disassembled, a positive electrode immersed in an electrolyte is taken out, and the positive electrode is punched out to a size that fits into a prepared coin cell. The positive electrode includes a conductive material and a binder in addition to the positive electrode active material. The electrolyte or the like is removed before the positive electrode is punched out. For example, after the positive electrode is taken out, the positive electrode may be cleaned with an organic solvent or the like.

The coin cell includes lithium metal as a counter electrode. Note that a material other than lithium metal may be used as the counter electrode. Unless otherwise specified, a potential in this specification and the like refers to a potential of a positive electrode in the case where a counter electrode is lithium metal.

The coin cell may include, as the electrolyte, a solution of 1 mol/L of lithium hexafluorophosphate (LiPF₆) dissolved in an organic solvent that is a mixture of ethylene carbonate (EC) and diethyl carbonate (DEC) at EC:DEC=3:7 (volume ratio) and vinylene carbonate (VC) at 2 wt %.

The coin cell includes a 25-μm-thick polypropylene porous film as a separator.

The coin cell includes stainless steel (SUS) as a positive electrode can and includes stainless steel (SUS) as a negative electrode can.

In this manner, an evaluation coin cell A is prepared.

The evaluation coin cell A fabricated under the above conditions is subjected to constant current charging (also referred to as CC charging) at a current value of 10 mA/g (corresponding to 0.05 C when 1 C per positive electrode active material weight is 200 mA/g) to a given voltage (e.g., 4.5 V, 4.55 V, 4.6 V, 4.65 V, 4.7 V, 4.75 V, or 4.8 V). To observe a phase change of the positive electrode active material, charging with such a small current value is preferably performed.

The temperature at the time of charging the evaluation coin cell A can be set to 25° C. The temperature at the time of charging may be the temperature of a thermostatic chamber where the coin cell A is placed.

After charging is performed under the above conditions, the coin cell A is disassembled in a glove box with an argon atmosphere to take out the positive electrode, whereby the positive electrode active material with a given charge capacity can be obtained. In order to inhibit a reaction with components in the external environment, the positive electrode is preferably enclosed in an argon atmosphere in performing various analyses later. For example, XRD can be performed on the positive electrode active material enclosed in an airtight container with an argon atmosphere. After charging is completed, the positive electrode is preferably taken out and subjected to analysis immediately. Specifically, the positive electrode is preferably subjected to analysis within an hour, further preferably within 30 minutes after the completion of charging.

### <<Evaluation Procedure 2>>

A given lithium-ion battery is disassembled, a positive electrode immersed in an electrolyte is taken out, and the electrolyte is subjected to measurement by nuclear magnetic resonance spectroscopy (e.g., ¹H NMR) to identify at least an organic solvent. The mixing ratio (volume ratio) of the organic solvent can also be identified by nuclear magnetic resonance spectroscopy. In addition, a lithium salt, an additive agent, or the like included in the electrolyte can also be identified.

After that, the positive electrode is punched out to a size that fits into a coin cell. The positive electrode includes a conductive material and a binder in addition to a positive electrode active material. The electrolyte or the like is removed after measurement by nuclear magnetic resonance spectroscopy and before the positive electrode is punched out. For example, after the positive electrode is taken out, the positive electrode may be cleaned with an organic solvent or the like.

The coin cell includes lithium metal as a counter electrode. Note that a material other than lithium metal may be used as the counter electrode.

As an electrolyte in the coin cell, an electrolyte identified by nuclear magnetic resonance spectroscopy is prepared. This electrolyte is the electrolyte of one embodiment of the present invention.

The coin cell includes a 25-μm-thick polypropylene porous film as a separator.

The coin cell includes stainless steel (SUS) as a positive electrode can and includes stainless steel (SUS) as a negative electrode can.

In this manner, an evaluation coin cell B is prepared.

The evaluation coin cell B fabricated under the above conditions is charged to a given voltage (e.g., 4.5 V, 4.55 V, 4.6 V, 4.65 V, 4.7 V, 4.75 V, or 4.8 V) and then discharged. For charging conditions, the following examples and the like can be referred to. For discharge conditions, the following examples and the like can be referred to.

The temperature at the time of charging the evaluation coin cell B can be set to 25° C. and a temperature below freezing, so that it is possible to observe how much charge and discharge capacities at the temperature below freezing are with respect to charge and discharge capacities at 25° C.

### <<XRD>>

XRD measurement can be performed on the coin cell A or the like using the following apparatus and conditions. Note that the apparatus and conditions for the XRD measurement are not limited to the following.
XRD apparatus: D8 ADVANCE produced by Bruker AXS
X-ray source: CuKα₁ radiation
Output: 40 KV, 40 mA

### <Powder XRD Pattern>

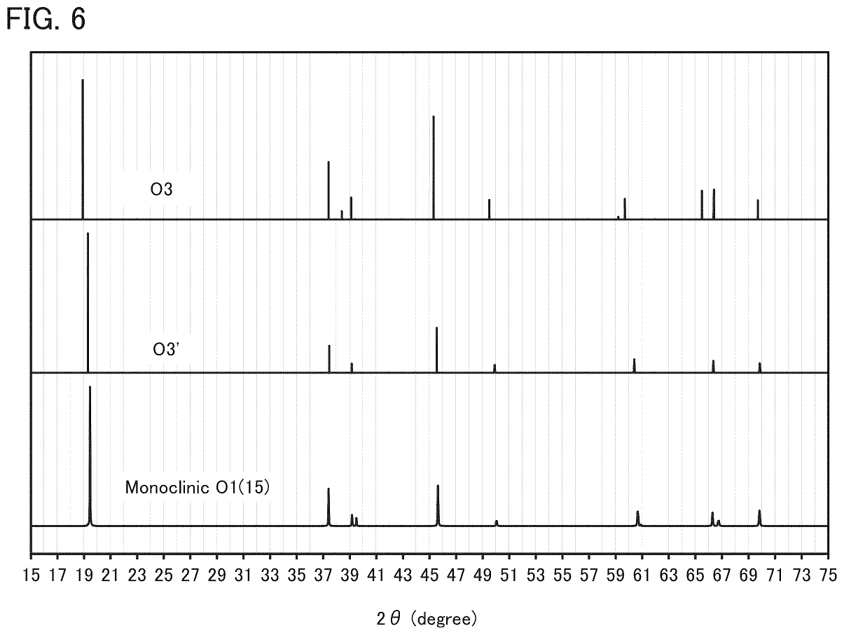

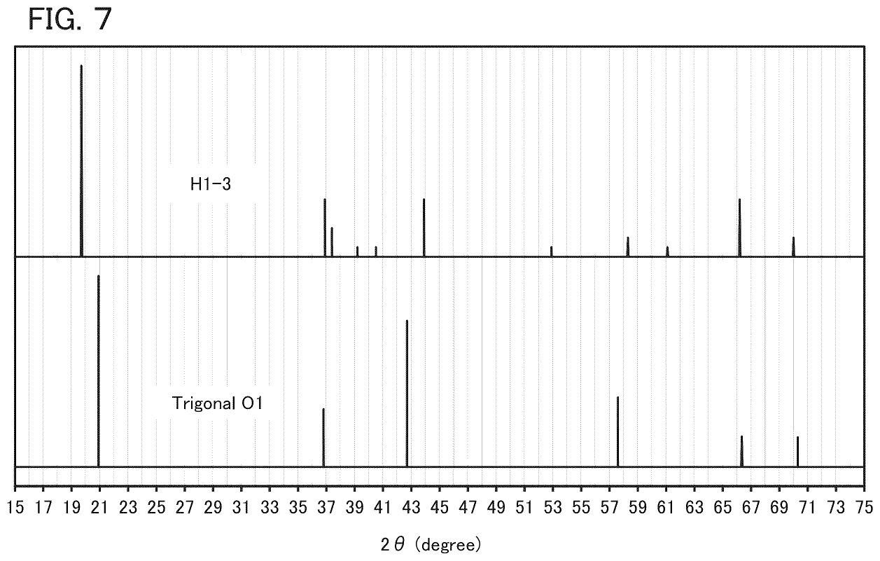

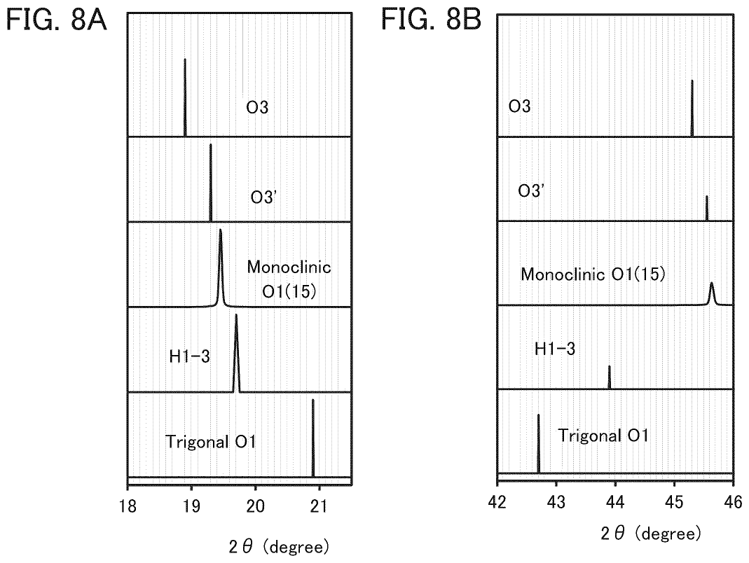

FIG. 6, FIG. 7, FIG. 8A, and FIG. 8B show ideal XRD patterns with CuKα₁ radiation that are calculated from models of the O3′ type crystal structure, the monoclinic O1(15) type crystal structure, and the H1-3 type crystal structure. For comparison, ideal XRD patterns calculated from the O3 crystal structure of LiCoO₂ with x=1 in LiₓCoO₂ and the trigonal O1 crystal structure with x=0 are also shown. FIG. 8A and FIG. 8B each show the XRD patterns of the O3′ type, monoclinic O1(15) type, and H1-3 type crystal structures, and FIG. 8A and FIG. 8B are enlarged diagrams showing, respectively, a range of 2θ greater than or equal to 18° and less than or equal to 21° and a range of 2θ greater than or equal to 420 and less than or equal to 46°. Note that the patterns of LiCoO₂ (O3) and CoO₂ (O1) are made from crystal structure data obtained from ICSD (Inorganic Crystal Structure Database) using Reflex Powder Diffraction, which is a module of Materials Studio (BIOVIA). The 20 range is from 15° to 75°, the step size is 0.01°, the wavelength λ1 is 1.540562×10⁻¹⁰ m, and a single monochromator is used. The pattern of the H1-3 type crystal structure is similarly made from the crystal structure data disclosed in Non-Patent Document 2. The O3′ type crystal structure and the monoclinic O1(15) type crystal structure are estimated from the XRD pattern of the positive electrode active material that can be used as one embodiment of the present invention, the crystal structure is fitted with TOPAS ver. 3 (crystal structure analysis software produced by Bruker Corporation), and the XRD patterns of the O3′ type crystal structure and the monoclinic O1(15) type crystal structure are made in a manner similar to that for other structures.

As shown in FIG. 6, FIG. 8A, and FIG. 8B, the O3′ type crystal structure exhibits diffraction peaks at 2θ=19.25±0.12° (greater than or equal to 19.13° and less than 19.37°) and 2θ=45.47±0.10° (greater than or equal to 45.370 and less than 45.57°) when analyzed by X-ray diffraction.

Furthermore, the monoclinic O1(15) type crystal structure exhibits diffraction peaks at 2θ=19.47±0.10° (greater than or equal to 19.37° and less than or equal to 19.57°) and 2θ=45.62±0.050 (greater than or equal to 45.570 and less than or equal to 45.67°) when analyzed by X-ray diffraction.

Meanwhile, as shown in FIG. 7, FIG. 8A, and FIG. 8B, the H1-3 type crystal structure and the trigonal O1 do not exhibit peaks at these positions. Thus, it can be said that exhibiting peaks at greater than or equal to 19.13 and less than 19.37 and/or greater than or equal to 19.37° and less than or equal to 19.57° and at greater than or equal to 45.370 and less than 45.57° and/or greater than or equal to 45.570 and less than or equal to 45.670 in a state with small x in LiₓCoO₂ is the feature of the positive electrode active material 10 that can be used as one embodiment of the present invention.

It can also be said that the positions of the XRD diffraction peaks exhibited by the crystal structure with x=1 and the crystal structure with x≤0.24 are close to each other. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 420 and less than or equal to 46°, is 0.7° or less, preferably 0.5° or less.

Although the positive electrode active material 10 that can be used as one embodiment of the present invention has the O3′ type crystal structure and/or the monoclinic O1(15) type crystal structure when x in LiₓCoO₂ is small, the entire positive electrode active material 10 does not necessarily have the O3′ type crystal structure and/or the monoclinic O1(15) type crystal structure. The positive electrode active material may include another crystal structure or may be partly amorphous. Note that when the XRD patterns are subjected to the Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% can have sufficiently good cycle performance.

Furthermore, even after 100 or more cycles of charging and discharging after the measurement starts, the O3′ type crystal structure and/or the monoclinic O1(15) type crystal structure preferably account(s) for more than or equal to 35%, further preferably more than or equal to 40%, still further preferably more than or equal to 43% when the Rietveld analysis is performed.

Sharpness of a diffraction peak in an XRD pattern indicates the degree of crystallinity. It is thus preferable that the diffraction peaks after charging be sharp, in other words, have a small half width. Even peaks that are derived from the same crystal phase have different half widths depending on the XRD measurement conditions or the 20 value. In the case of the above-described measurement conditions, the peak observed at 20 of greater than or equal to 430 and less than or equal to 460 preferably has a half width of less than or equal to 0.2°, further preferably less than or equal to 0.15°, still further preferably less than or equal to 0.12°. Note that not all peaks need to fulfill the requirement. A crystal phase can be regarded as having high crystallinity when one or more peaks fulfill the requirement. Such high crystallinity sufficiently contributes to stability of the crystal structure after charging.

The crystallite sizes of the O3′ type crystal structure and the monoclinic O1(15) type crystal structure included in the positive electrode active material 10 are only decreased to approximately 1/20 of that of LiCoO₂ (O3) in a discharged state. Thus, a clear peak of the O3′ type crystal structure can be observed when x in LiₓCoO₂ is small, even under the same XRD measurement conditions as those of a positive electrode before the charging and discharging. By contrast, conventional LiCoO₂ has a small crystallite size and a broad and small peak even when it can have a structure part of which is similar to the O3′ type crystal structure. The crystallite size can be calculated from the half width of the XRD peak.

### <<Surface Roughness and Specific Surface Area>>

The positive electrode active material 10 that can be used as one embodiment of the present invention preferably has a smooth surface with little unevenness. A smooth surface with little unevenness indicates that an effect of a fusing agent described later has adequately functioned and the surfaces of the additive element source and the lithium cobalt oxide have melted (have formed a solid solution). Thus, it is one indication of favorable distribution of the additive element in the surface portion 10a.

A smooth surface with little unevenness can be determined from, for example, a cross-sectional scanning electron microscope (referred to as SEM) image or a cross-sectional TEM image of the positive electrode active material 10 or the specific surface area of the positive electrode active material 10.

### <Additional Feature>

The positive electrode active material 10 may have a coating portion outside the surface portion 10a. The coating portion does not necessarily cover the entire positive electrode active material. The coating portion is an inorganic compound formed at the time of fabricating the positive electrode active material in some cases, or is formed by deposition of a decomposition product of an electrolyte and an organic electrolyte solution due to charging and discharging in other cases.

In the case where the coating portion contains the decomposition product of the electrolyte and the organic electrolyte solution, the coating portion preferably contains carbon, oxygen, and fluorine. A high-quality coating film can be easily obtained when part of the electrolyte solution contains LiBOB and/or SUN (suberonitrile), for example. Accordingly, the coating portion containing one or two or more selected from boron, nitrogen, sulfur, and fluorine is preferable because it can be a high-quality coating film in some cases.

This embodiment can be freely combined with the other embodiments.

### Embodiment 3

In this embodiment, a method for manufacturing a positive electrode active material that can be used for the lithium-ion battery of the present invention will be described. Although the case where the positive electrode active material is manufactured by a coprecipitation method is described in this embodiment, a positive electrode active material manufactured by a solid phase method, a hydrothermal method, or the like other than the coprecipitation method can be used in the lithium-ion battery of the present invention. Note that a flowchart used for describing a manufacturing method and the like in this embodiment illustrates the order of elements that are connected by lines and does not illustrate the order of elements that are not connected by lines. In this embodiment, in the case where an oxide is manufactured as the positive electrode active material, the predecessor of the oxide, e.g., a hydroxide in the previous step, is referred to as a precursor.

### <Manufacturing Method 1>

In this manufacturing method 1, a method including a heating step of one embodiment of the present invention is described.

### <Step S201: Prepare Raw Materials>

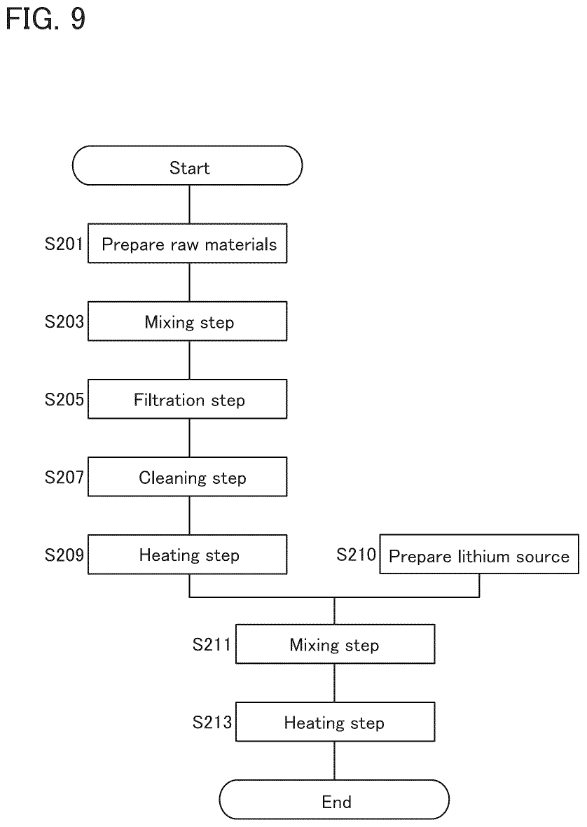

First, in Step S201 in FIG. 9, raw materials are prepared depending on the kind of the positive electrode active material. In this manufacturing method 1, at least an aqueous solution in which a transition metal salt is dissolved is prepared. The aqueous solution in which the transition metal salt is dissolved can be referred to as a transition metal source. In the case where the pH value of the aqueous solution in which the transition metal salt is dissolved is smaller than 7, preferably larger than or equal to 1 and smaller than or equal to 6, the aqueous solution exhibits acidity and thus can be referred to as an acidic aqueous solution.

A transition metal is described here. As a transition metal in the present invention, one or more selected from manganese, cobalt, and nickel can be used. Specifically, as the transition metal, cobalt alone; nickel alone; two elements of cobalt and manganese; two elements of cobalt and nickel; or three elements of cobalt, manganese, and nickel may be used.

A composite oxide obtained using three elements of nickel, cobalt, and manganese is referred to as nickel-cobalt-manganese composite oxide in some cases. The nickel-cobalt-manganese composite oxide refers to a predecessor of lithium-nickel-cobalt-manganese composite oxide before mixing with lithium. In this specification and the like, “lithium-nickel-cobalt-manganese composite oxide” is referred to as “NCM”. NCM can be represented by a chemical formula LiNiₓCo_{y}Mn_{z}O₂ (x>0, y>0, 0.8<x+y+z<1.2). In NCM according to the above chemical formula, Li is not limited to 1, and Li can satisfy greater than or equal to 0.58 and less than or equal to 1.10, preferably greater than or equal to 0.90 and less than or equal to 1.05, further preferably greater than or equal to 0.92 and less than or equal to 1.01. Note that NCM may further contain an element other than nickel, cobalt, and manganese.

In the above chemical formula LiNiₓCo_{y}Mn_{z}O₂, a relational expression of numerical values that can be represented by x, y, and z preferably satisfies 0.1x<y<8x and 0.1x<z<8x, for example. Specific numerical values that can be represented by x, y, and z preferably satisfy x:y:z=1:1:1 or values in the neighborhood thereof. As another specific example of the numerical values, x, y, and z preferably satisfy x:y:z=5:2:3 or values in the neighborhood thereof. As another specific example of the numerical values, x, y, and z preferably satisfy x:y:z=8:1:1 or values in the neighborhood thereof. As another specific example of the numerical values, x, y, and z preferably satisfy x:y:z=9:0.5:0.5 or values in the neighborhood thereof. As another specific example of the numerical values, x, y, and z preferably satisfy x:y:z=6:2:2 or values in the neighborhood thereof. As another specific example of the numerical values, x, y, and z preferably satisfy x:y:z=1:4:1 or values in the neighborhood thereof. In this paragraph, “neighborhood thereof” includes values in the range of 10%; for example, the neighborhood of x:y:z=8:1:1 means that x is greater than or equal to 7.2 and less than or equal to 8.8 and y and z are each greater than or equal to 0.9 and greater than or equal to 1.1.

The above values of x, y, and z are sometimes referred to as a mixing ratio of nickel to cobalt to manganese, and the mixing ratio is the proportion of each element used at least in weighing the raw materials. The above mixing ratio expressed with x, y, and z above is preferably satisfied, in which case a layered rock-salt crystal structure can be obtained.

The proportions of the elements that can be measured by analysis of NCM by X-ray photoelectron spectroscopy (XPS), inductively coupled plasma mass spectrometry (ICP-MS), or energy dispersive X-ray spectroscopy (TEM-EDX), i.e., values corresponding to x, y, and z, are referred to as the ratio of nickel to cobalt to manganese, and the ratio is not necessarily equal to the mixing ratio. For example, in the case where an unreacted raw material remains in the manufacturing process, the mixing ratio is different from the ratio in some cases. When part of the raw material of nickel remains unreacted, the ratio of nickel is lower than the mixing ratio of nickel.

The proportion of nickel among the transition metals is preferably high because an inexpensive positive electrode active material can be provided and the positive electrode active material can have a high potential or a high capacity. For example, given that the sum of the numbers of nickel, cobalt, and manganese atoms included in the positive electrode active material is 100, the number of nickel atoms is preferably greater than or equal to 33, further preferably greater than or equal to 50, still further preferably greater than or equal to 80. However, when the proportion of nickel is too high, the chemical stability and heat resistance might decrease. For this reason, given that the sum of the numbers of nickel, cobalt, and manganese atoms included in the positive electrode active material is 100, the number of nickel atoms is preferably less than or equal to 95.

Cobalt is preferably contained as the transition metal, in which case the average discharge voltage is high and a secondary battery can have improved cycle performance and high reliability because cobalt contributes to stabilization of a layered rock-salt structure. Meanwhile, the price of cobalt is higher and more unstable than those of nickel and manganese; thus, a too high proportion of cobalt might increase the manufacturing cost. For this reason, for example, given that the sum of the numbers of nickel, cobalt, and manganese atoms included in the positive electrode active material is 100, the number of cobalt atoms is preferably greater than or equal to 2.5 and less than or equal to 34.

Manganese is preferably contained as the transition metal, in which case the heat resistance and chemical stability are improved. However, a too high proportion of manganese tends to decrease discharge voltage and discharge capacity. For this reason, for example, given that the sum of the numbers of nickel, cobalt, and manganese atoms included in the positive electrode active material is 100, the number of manganese atoms is preferably greater than or equal to 2.5 and less than or equal to 33.

The aqueous solution in which the transition metal salt is dissolved is described here. As the aqueous solution in which the transition metal salt is dissolved in the present invention, an aqueous solution in which the nickel salt is dissolved or an aqueous solution containing a water-soluble nickel salt can be used, and typically, an aqueous solution in which nickel sulfate, nickel nitrate, or the like is dissolved in water can be used. In such an aqueous solution, nickel ions may exist, and nickel may exist as a complex. In addition, as the aqueous solution in which the transition metal salt is dissolved in the present invention, an aqueous solution in which a cobalt salt is dissolved or an aqueous solution containing a water-soluble cobalt salt can be used, and typically, an aqueous solution in which cobalt sulfate, cobalt nitrate, or the like is dissolved in water can be used. In such an aqueous solution, cobalt ions may exist, and cobalt may exist as a complex. In addition, as the aqueous solution in which the transition metal salt is dissolved in the present invention, an aqueous solution in which a manganese salt is dissolved or an aqueous solution containing a water-soluble manganese salt can be used, and an aqueous solution in which manganese sulfate, manganese nitrate, or the like is dissolved in water can be used. In such an aqueous solution, manganese ions may exist, and manganese may exist as a complex.

The aqueous solution in which the transition metal salt is dissolved preferably has a high purity, and pure water is preferably used for the aqueous solution. The concentration of transition metal ions in the aqueous solution in which the transition metal salt is dissolved is higher than or equal to 1 mol/L and lower than or equal to 5 mol/L, preferably higher than or equal to 2 mol/L and lower than or equal to 3 mol/L. In the case where the aqueous solution contains a plurality of transition metal salts, the total concentration of the transition metal ions falls within the above range.

In the case where three transition metal elements of cobalt, manganese, and nickel are used as the transition metal in the present invention, an aqueous solution in which a cobalt salt, a manganese salt, and a nickel salt are dissolved can be used as the aqueous solution in which the transition metal salt is dissolved. Typically, an aqueous solution in which nickel sulfate, cobalt sulfate, and manganese sulfate are dissolved can be used as the aqueous solution in which the transition metal salt is dissolved.

Furthermore, in Step S201 in FIG. 9, an aqueous solution exhibiting alkalinity (referred to as an alkaline aqueous solution) is prepared. The alkaline aqueous solution refers to an aqueous solution whose pH value is larger than 7, preferably larger than or equal to 8. As the alkaline aqueous solution in the present invention, an aqueous solution containing sodium hydroxide, potassium hydroxide, lithium hydroxide, or ammonia can be used. For example, an aqueous solution in which sodium hydroxide, potassium hydroxide, lithium hydroxide, or ammonia is dissolved in water can be used. An aqueous solution in which two or more selected from sodium hydroxide, potassium hydroxide, lithium hydroxide, and ammonia are dissolved in water may be used. Pure water is preferably used as the water. The concentration of an alkali in the alkaline aqueous solution is higher than or equal to 1 mol/L and lower than or equal to 10 mol/L, preferably higher than or equal to 3 mol/L and lower than or equal to 7 mol/L. In the case where the aqueous solution contains a plurality of alkalis, the total concentration of the alkalis falls within the above range.

Pure water used for the aqueous solution in which the transition metal salt is dissolved and the alkaline aqueous solution is preferably water having a resistivity of 1 MΩ·cm or higher, further preferably water having a resistivity of 10 MΩ·cm or higher, still further preferably water having a resistivity of 15 MΩ·cm or higher. Water satisfying the above-described resistivity has high purity and contains an extremely small amount of impurities.

### <Step S203: Mixing Step>

Next, in Step S203 in FIG. 9, the above two aqueous solutions are mixed to manufacture a mixed aqueous solution (referred to as a mixed solution or a coprecipitated mixed solution). In this step, pure water may be prepared separately from the two aqueous solutions, and the mixed aqueous solution may be manufactured in the pure water. In this step, the aqueous solution in which the transition metal salt is dissolved and the alkaline aqueous solution can be reacted with each other. This reaction is referred to as a neutralization reaction, an acid-base reaction, or a coprecipitation reaction in some cases. As the reaction proceeds in this step, a coprecipitated substance is separated out. In this specification and the like, a product of the reaction (a reaction product) is referred to as a coprecipitated substance. When the aqueous solution in which the transition metal salt is dissolved and the alkaline aqueous solution are mixed, a hydroxide is formed as the coprecipitated substance. In order to promote the reaction, the temperature of the mixed solution and the pH value of the mixed solution are preferably constant, and further preferably, the mixed solution is stirred. The above temperature is preferably higher than or equal to 40° C. and lower than or equal to 90° C., further preferably higher than or equal to 45° C. and lower than or equal to 70° C. The pH value preferably falls within the range from greater than or equal to 9.0 to less than or equal to 13.0, further preferably from greater than or equal to 10.5 to less than or equal to 11.5. The rotational frequency for the stirring is preferably greater than or equal to 800 rpm and less than or equal to 1200 rpm, further preferably greater than or equal to 900 rpm and less than or equal to 1100 rpm.

As described above, in this step, the coprecipitated substance is separated out in the mixed solution as a reaction product. The coprecipitated substance is sometimes precipitated in the mixed solution and is referred to as a precipitate in some cases. When the coprecipitated substance starts to be separated out, the mixed solution sometimes becomes a suspension. Note that the suspension refers to a liquid in which particles of the coprecipitated substance are dispersed.

### <Step S205: Filtration Step>

Next, in Step S205 in FIG. 9, the above mixed solution is filtered to obtain the coprecipitated substance from the mixed solution. Specifically, the coprecipitated substance is extracted from the mixed solution. Suction filtration is preferably used as the filtration. The coprecipitated substance has a size (major axis) greater than or equal to 1 μm and less than or equal to 20 μm. The coprecipitated substance obtained by filtration may be provided with an ordinal number so as to be distinguished from the coprecipitated substance in the mixed solution, and is sometimes referred to as a filtrated powder.

As the coprecipitated substance, a hydroxide containing the transition metal is obtained. When an aqueous solution containing a nickel salt, a cobalt salt, and a manganese salt is used as the aqueous solution containing the transition metal, a hydroxide containing cobalt, manganese, and nickel (referred to as a composite hydroxide containing cobalt, manganese, and nickel) is obtained as the coprecipitated substance. The coprecipitated substance obtained by filtration, typically the hydroxide, contains impurities such as water.

The hydroxide obtained as the coprecipitated substance may be a secondary particle in which primary particles are aggregated. Note that a primary particle refers to a particle (lump) of the smallest unit found when observed, for example, at a magnification of 20000 times with a SEM (scanning electron microscope) or the like. That is, the primary particle is a particle of the smallest unit. A secondary particle refers to a particle in which the primary particles are aggregated, partially sharing the grain boundary (the circumference and the like of the primary particle), and are not easily separated from each other (a particle independent of the other particles).

### <Step S207: Cleaning Step>

Next, in Step S207 in FIG. 9, the coprecipitated substance is cleaned to obtain a hydroxide from which impurities are removed. In this cleaning step, cleaning using water can be employed. Cleaning using water is referred to as water cleaning in some cases. Note that the water cleaning can be performed once or repeated a plurality of times. By the water cleaning, impurities and the like can be removed from the coprecipitated substance to some extent. Distilled water or pure water is preferably used as water. The description of Step S201 can be referred to for pure water. In this step, the water cleaning of the coprecipitated substance may be followed by suction filtration. When the water cleaning is repeated a plurality of times, suction filtration is preferably performed after the water cleaning.

In the above cleaning step, cleaning using an organic solvent can also be employed. Note that cleaning using an organic solvent can be performed once or repeated a plurality of times. By the cleaning using an organic solvent, the coprecipitated substance can be subjected to drying treatment. The drying treatment includes removing water or moisture attached by the prior water cleaning or the like. As the organic solvent, acetone or an alcohol such as isopropanol (typically, isopropyl alcohol) is preferably used. In this step, the cleaning of the coprecipitated substance using an organic solvent may be followed by suction filtration. When the cleaning using an organic solvent is repeated a plurality of times, suction filtration is preferably performed after the cleaning using the organic solvent.

In the above cleaning step, a combination of water cleaning and cleaning using an organic solvent can also be employed. Suction filtration is preferably used. For example, a step of water cleaning followed by suction filtration can be performed, and then a step of cleaning using an organic solvent followed by suction filtration can be performed. In that case, the number of times of the water cleaning is preferably larger than the number of times of the cleaning using an organic solvent.

### <Step S209: Heating Step>

Step S209 in FIG. 9 is a step of performing heating on the coprecipitated substance, whereby impurities can be sufficiently removed. This step may be omitted when the amount of impurities is small, for example. Specifically, this step can remove hydrogen and oxygen as water from the coprecipitated substance. Removing hydrogen and oxygen as water is referred to as dehydration; thus, this heating step includes a dehydration step. In addition, this step can remove water or moisture contained in the coprecipitated substance. Removing water, moisture, or the like is referred to as drying; thus, this heating step includes a drying step. Note that this heating step can also remove impurities as a gas in addition to water, moisture, or the like. For example, this heating step can also remove the organic solvent used in Step S207.

A supplementary explanation of the temperature in this step is given here. The upper limit of the heating temperature in this step is preferably lower than a temperature at which the hydroxide, which is the coprecipitated substance, starts to change to an oxide. That is, this step preferably does not cause a change from the hydroxide to an oxide. Note that the temperature at which the hydroxide changes to an oxide can be obtained by thermogravimetry-differential thermal analysis (TG-DTA). When Ni_{0.8}Co_{0.1}Mn_{0.1}(OH)₂ is used as the hydroxide, in a region where a TG curve indicates a reduction in mass, a DTA curve starts to decrease at higher than or equal to 210° C. and lower than or equal to 230° C., typically 220° C. or the vicinity thereof, and the maximum endothermic peak is observed at 260° C. or the vicinity thereof. From this result, the temperature at which the hydroxide starts to be decomposed, dehydrated, or reduced, i.e., the temperature at which the hydroxide starts to change to an oxide can be calculated to be 220° C., and the upper temperature limit of the heat treatment can be set to 220° C.

Note that a higher temperature of the heating treatment is preferable because it promotes the treatment, shortens the treatment time, and enables high productivity.

The lower temperature limit of the heat treatment is higher than or equal to a temperature at which water or moisture of the hydroxide can be removed. Removing water or moisture is also referred to as drying.

In view of the above description, a specific temperature of the heat treatment is preferably higher than or equal to 130° C. and lower than or equal to 220° C., further preferably higher than or equal to 150° C. and lower than or equal to 220° C., still further preferably higher than or equal to 180° C. and lower than or equal to 220° C.

The duration of the heat treatment in this step is preferably longer than or equal to 3 hours and shorter than or equal to 15 hours, further preferably longer than or equal to 8 hours and shorter than or equal to 15 hours, still further preferably longer than or equal to 10 hours and shorter than or equal to 13 hours, yet still further preferably longer than or equal to 11 hours and shorter than or equal to 12 hours.

The atmosphere of the heat treatment in this step is preferably an atmosphere that does not contain oxygen. The atmosphere that does not contain oxygen is referred to as a non-oxygen atmosphere. As the non-oxygen atmosphere, a dry atmosphere, a vacuum atmosphere, or an inert atmosphere (typically, a nitrogen atmosphere or an argon atmosphere) can be employed. In the case where the heating is performed in a dry atmosphere, the dew point in a container is preferably lower than or equal to −40° C., further preferably lower than or equal to −80° C. In the case where the heating is performed in a vacuum atmosphere, a bell jar type vacuum apparatus including a container (referred to as a bell jar) the inside of which can be evacuated to a vacuum and a vacuum pump connected to the bell jar can be used. In the case where the heating is performed in a vacuum atmosphere, a vacuum drying furnace may be used, and the vacuum drying furnace includes a vacuum pump connected to the drying furnace. As the vacuum pump included in the bell jar type vacuum apparatus or the vacuum drying furnace, a dry pump, a turbomolecular pump, an oil rotary pump, a cryopump, or a mechanical booster pump can be used. The vacuum atmosphere in the bell jar type vacuum apparatus or the vacuum drying furnace includes an atmosphere where the pressure is reduced such that a differential pressure gauge of each apparatus becomes higher than or equal to −0.1 MPa and lower than −0.08 MPa. In the case where the heating is performed in a nitrogen atmosphere, a gas containing nitrogen is supplied into the container of the bell jar type vacuum apparatus or the vacuum drying furnace.

The heat treatment in this step may be performed in multiple steps. For example, the heat treatment can be performed at a first temperature for a first duration and then at a second temperature for a second duration. The second temperature falls within the above-described temperature range of the heat treatment. The first temperature is lower than the second temperature and is, for example, a temperature in a range from higher than or equal to 80° C. to lower than 90° C. The second duration falls within the above-described duration range of the heat treatment. The first duration is shorter than the second duration and is, for example, longer than or equal to 0.5 hours and shorter than or equal to 1 hour. The multi-step treatment is preferable because impurities can easily be removed from the hydroxide.

### <Step S210: Prepare Lithium Source>

Next, in Step S210 in FIG. 9, a lithium source is prepared. The ratio of the lithium source to the hydroxide (lithium source/hydroxide) is greater than or equal to 0.90 and less than or equal to 1.05, preferably greater than or equal to 0.92 and less than or equal to 1.01. In the present invention, a lithium compound can be used as the lithium source. Lithium hydroxide, lithium carbonate, or lithium nitrate can be given as the lithium compound. The lithium source preferably has a high purity. The lithium source is preferably ground to promote a solid phase reaction.

Lithium hydroxide has a melting point of 462° C., which is low among lithium compounds. In the case of manufacturing a positive electrode active material with a high nickel proportion, heating needs to be performed at a low temperature in order to inhibit cation mixing. Thus, a lithium compound having a low melting point, such as lithium hydroxide, is preferably used for the manufacturing of the positive electrode active material with a high nickel proportion.

### <Step S211: Mixing Step>

Next, in Step S211 in FIG. 9, the hydroxide is mixed with the lithium source to manufacture a mixture. In this specification and the like, a predecessor of an oxide is referred to as a precursor. For distinction from the prior mixing step, this mixing step is sometimes provided with an ordinal number. In the present invention, this mixing step is preferably performed by a dry method or a wet method.

A ball mill, a bead mill, a kneader, or the like can be used as a means of the mixing and the like. When a ball mill is used, zirconia balls are preferably used as media, for example.

### <Step S213: Heating Step>

Next, in Step S213 in FIG. 9, the mixture is heated. Since the mixture becomes an oxide after this heating step, the mixture is referred to as a precursor. Note that for distinction from the prior heating step, this heating step is sometimes provided with an ordinal number.

As heating conditions in this step, heating is preferably performed at a first temperature and then at a second temperature. In some cases, the heating at the first temperature is referred to as first baking, and the heating at the second temperature is referred to as second baking. Note that in the present invention, the second baking may be performed without performing the first baking. That is, this step may be one-step baking.

In this step, the second temperature is preferably higher than the first temperature. In that case, the heating at the first temperature is sometimes referred to as pre-baking, and the heating at a second temperature is sometimes referred to as main baking. Note that in the present invention, main baking may be performed without performing pre-baking. Meanwhile, pre-baking is preferably performed in the case where lithium hydroxide is used as the lithium source.

The first temperature in this step is preferably higher than the melting point of the lithium source. Typically, the first temperature is preferably higher than or equal to 500° C. and lower than or equal to 700° C. The second temperature in this step is preferably higher than 500° C. and lower than or equal to 1050° C., and in the case where the second temperature is higher than the first temperature, the second temperature is preferably higher than 700° C. and lower than or equal to 1050° C.

The durations of the heating at the first temperature and the heating at the second temperature in this step are each preferably longer than or equal to 1 hour and shorter than or equal to 20 hours. The duration of the heating at the first temperature may be equal to, longer than, or shorter than the duration of the heating at the second temperature.

In the present invention, the heating at the first temperature and the heating at the second temperature are each preferably performed in an oxygen atmosphere, and are each particularly preferably performed while oxygen is supplied. Oxygen is preferably supplied at, for example, greater than or equal to 2 L/min and 15 L/min, further preferably 5 L/min 10 L/min per liter of furnace inner capacity. The heating atmosphere at the first temperature may be the same as or different from the heating atmosphere at the second temperature.

As a baking apparatus used for the heating at the first temperature and the second temperature in the present invention, an electric furnace or a rotary kiln furnace can be used. The baking apparatus used for the heating at the first temperature may be the same as or different from the baking apparatus used for the heating at the second temperature.

At the time of the heating in the present invention, the mixture is preferably put in a crucible or a saggar. The crucible or the saggar is preferably made of a highly heat-resistant material such as alumina (aluminum oxide), mullite cordierite, magnesia, or zirconia. Among those materials, aluminum oxide is preferable because it is also a material which impurities are less likely to enter. For example, it is preferable to use a crucible or a saggar made of alumina with a purity of 99% or higher, further preferably 99.5% or higher. In this embodiment, a crucible made of aluminum oxide with a purity of 99.9% is used. Furthermore, the heating is preferably performed with the crucible or the saggar covered with a lid, in which case the materials contained in the mixture can be prevented from subliming. The lid may be placed such that the inside of the crucible is shut off from the inner atmosphere of the furnace, or may be placed to be partly open such that the inside of the crucible can be in contact with the inner atmosphere of the furnace.

In the present invention, grinding or crushing in a mortar is preferably performed between the heating step at the first temperature and the heating step at the second temperature. The adhered state of the mixtures or the aggregated state of the mixtures can be alleviated by the grinding or crushing. Since adhesion of the mixtures during the heating may result in a decrease in the area of contact with oxygen in the atmosphere, grinding or crushing is preferably performed as described above. Furthermore, after the grinding or crushing, classification may be performed using a sieve.

It is suitable to collect the heated materials after the materials are transferred from the crucible to the mortar in order to prevent impurities from entering the materials. The mortar is suitably made of a material which is less likely to release impurities. Specifically, it is suitable to use a mortar made of alumina with a purity of 90% or higher, preferably 99% or higher.

In this manner, a lithium composite oxide can be manufactured as the positive electrode active material. Note that according to the manufacturing method 1, NCM can be obtained as the positive electrode active material from the prepared raw materials. NCM obtained is preferably used because high discharge capacity can be obtained as a battery characteristic. Furthermore, the median diameter (D50) of NCM is greater than or equal to 3 μm and less than or equal to 13 μm, or greater than or equal to 4 μm and less than or equal to 10 μm. The smaller the median diameter (D50) is, the higher the discharge capacity is; thus, the median diameter (D50) of NCM is preferably greater than or equal to 4 μm and less than or equal to 7 μm.

### <Manufacturing Method 2>

In this manufacturing method 2, the case where a complexing agent, typically a chelate agent, is prepared in preparing raw materials is described. This manufacturing method 2 includes steps similar to those of the manufacturing method 1 and thus is described with reference to the flowchart in FIG. 9.

### <Step S201: Prepare Raw Materials>

As the raw materials prepared in Step S201 in FIG. 9, a complexing agent is preferably added. The complexing agent is a compound that can form a complex with ions of the transition metal in an aqueous solution. Examples of the complexing agent include ammonia and an ammonium salt. Note that an aqueous solution obtained by dissolving any of these in water, e.g., pure water is a complexing agent. In the case where ammonia is used, the aqueous solution can be referred to as an ammonia aqueous solution.

Furthermore, as the raw materials prepared in Step S201 in FIG. 9, a chelate agent, which is a complexing agent to form a chelate compound, may be prepared. Examples of the chelate agent include glycine, oxine, 1-nitroso-2-naphthol, 2-mercaptobenzothiazole, and EDTA (ethylenediaminetetraacetic acid). Note that two or more kinds selected from glycine, oxine, 1-nitroso-2-naphthol, and 2-mercaptobenzothiazole may be used. Note that an aqueous solution obtained by dissolving any of these in water, e.g., pure water is a chelate agent. In the case where glycine is used, the aqueous solution can be referred to as a glycine aqueous solution.

In this step, the aqueous solution in which the transition metal salt is dissolved and the chelate agent are preferably mixed. That is, an aqueous solution containing the transition metal and glycine is preferably prepared. The aqueous solution containing the transition metal and glycine preferably has a glycine concentration higher than or equal to 0.05 mol/L and lower than or equal to 0.15 mol/L, further preferably higher than or equal to 0.07 mol/L and lower than or equal to 0.12 mol/L.

The use of the chelate agent inhibits unnecessary generation of crystal nuclei, so that a hydroxide with favorable particle size distribution can be obtained. Furthermore, the use of the chelate agent can slow an acid-base reaction, so that the reaction gradually proceeds to form a nearly spherical secondary particle. Thus, the chelate agent is further preferably a general complexing agent such as an ammonia aqueous solution.

Furthermore, in Step S201 in FIG. 9, another complexing agent, specifically, a chelate agent may be prepared. This complexing agent, specifically, the chelate agent, is preferably put in a reaction vessel. For distinction from the complexing agent or the chelate agent mixed with the aqueous solution in which the transition metal salt is dissolved, this complexing agent or chelate agent is sometimes provided with an ordinal number. Materials and the like that can be used as the complexing agent or the chelate agent are described above. In the case where a glycine aqueous solution is prepared as the chelate agent, the glycine aqueous solution preferably has a glycine concentration higher than or equal to 0.05 mol/L and lower than or equal to 0.15 mol/L, further preferably higher than or equal to 0.07 mol/L and lower than or equal to 0.12 mol/L. The glycine concentration of this glycine aqueous solution is preferably equal to the concentration of glycine mixed with the aqueous solution in which the transition metal salt is dissolved.

After that, Step S203 and the subsequent steps are performed as in the manufacturing method 1.

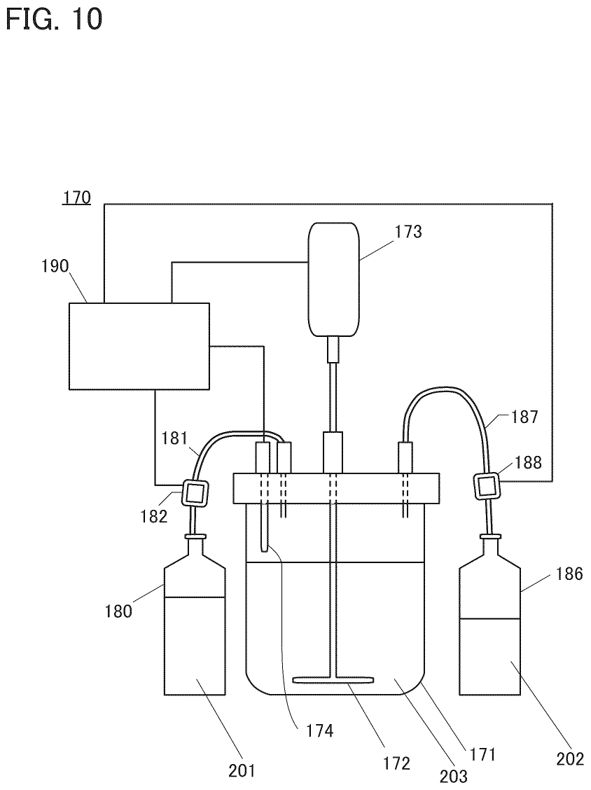

Here, a coprecipitation synthesis apparatus 170 used in the manufacturing method 2 is described with reference to FIG. 10. The coprecipitation synthesis apparatus 170 can be provided in a fume hood and includes at least a reaction vessel 171. A reaction container can be used as the reaction vessel 171. A separable flask is preferably used in the lower part of the reaction container, and a separable cover is preferably used in the upper part of the reaction container. The separable flask may be cylindrical or round type. A cylindrical separable flask has a flat bottom. The separable cover includes a plurality of inlets, for example, four inlets.

The atmosphere of the reaction vessel 171 can be controlled with at least one of the inlets of the separable cover. For example, the atmosphere is preferably controlled to contain nitrogen. In that case, the atmosphere is preferably controlled such that nitrogen flows into the reaction vessel 171. At this time, the amount of stream is preferably large enough to eject a gas generated by a thermal decomposition reaction. Furthermore, bubbling with nitrogen may be performed in an aqueous solution 203 put in the reaction vessel 171. The coprecipitation synthesis apparatus 170 may be equipped with a reflux condenser connected to another inlet of the separable cover. This reflux condenser allows an atmosphere gas in the reaction vessel 171, e.g., nitrogen, to be ejected and water to return to the reaction vessel 171.

The above-described chelate agent is put as the aqueous solution 203. Note that an aqueous solution put in the reaction vessel 171 in advance, such as the aqueous solution 203, is referred to as a filling liquid in some cases. The filling liquid is referred to as an adjustment liquid in some cases. The filling liquid and the adjustment liquid refer to an aqueous solution before a reaction, that is, an aqueous solution in an initial state.

The aqueous solution in which the transition metal salt is dissolved is prepared as an aqueous solution 201. The aqueous solution 201 is put in a first tank 180. In addition, the alkaline aqueous solution is prepared as an aqueous solution 202. The alkaline aqueous solution is used to keep a constant pH value and is thus sometimes referred to as a pH adjustment liquid. The aqueous solution 202 is put in a second tank 186. It is preferable that bubbling with nitrogen be performed in the first tank 180 and the second tank 186 to remove oxygen in each aqueous solution. Furthermore, a tank different from the first tank 180 and the second tank 186 may be prepared, and the above-described chelate agent may be put in the tank.

The first tank 180 has a pump 182 and a tube (also referred to as a pipe) 181 connected to the pump 182. The pipe 181 is fixed to the inlet of the separable cover, and the aqueous solution 201 can be dropped into the reaction vessel 171 from the end of the pipe 181. The second tank 186 has a pump 188 and a pipe 187 connected to the pump 188. The pipe 187 is fixed to the inlet of the separable cover, and the aqueous solution 202 is dropped into the reaction vessel 171 from the end of the pipe 187. The ends of the pipe 181 and the pipe 187 may be soaked in the aqueous solution 203, and also in this case, the aqueous solution 201 and the aqueous solution 202 are described as being dropped into the reaction vessel 171. In this manner, the raw materials are prepared in the reaction vessel 171, the first tank 180, and the second tank 186 according to Step S201.

### <Step S203: Mixing Step>

Next, the mixing step in Step S203 is described. First, conditions of a coprecipitation method related to this step are described.

### <Conditions of Coprecipitation Method>

The pH value of the aqueous solution 203 in the reaction vessel 171 falls within the range from higher than or equal to 9.0 to lower than or equal to 13.0, preferably from higher than or equal to 10.5 to lower than or equal to 11.5. The temperature of the aqueous solution 203 in the reaction vessel 171 is higher than or equal to 40° C. and lower than or equal to 90° C., preferably higher than or equal to 45° C. and lower than or equal to 70° C. The water temperature can be controlled in accordance with the temperature in the reaction vessel 171. The temperature in the reaction vessel 171 is equal to the water temperature or different therefrom by less than 5° C., preferably less than 2° C. in some cases. Thus, the temperature in the reaction vessel 171 is higher than or equal to 35° C. and lower than or equal to 95° C., preferably higher than or equal to 40° C. and lower than or equal to 75° C. The rotational frequency for stirring the aqueous solution 203 in the reaction vessel 171 is greater than or equal to 800 rpm and less than or equal to 1200 rpm, preferably greater than or equal to 900 rpm and less than or equal to 1100 rpm. The concentration of transition metal ions in the aqueous solution 201 is higher than or equal to 1 mol/L and lower than or equal to 5 mol/L, preferably higher than or equal to 2 mol/L and lower than or equal to 3 mol/L. In the case where a plurality of transition metals are contained, the total concentration of the transition metal ions falls within the above range. The dropping rate of the aqueous solution 201 is higher than or equal to 0.03 mL/min and lower than or equal to 1.0 mL/min, preferably higher than or equal to 0.03 m/min and 0.5 m/min. When the dropping rate is low, the size of the hydroxide, i.e., the median diameter (D50) thereof can be decreased, and when the dropping rate is high, the size of the hydroxide, i.e., the median diameter (D50) thereof can be increased. The smaller the hydroxide is, the smaller the positive electrode active material is. The larger the hydroxide is, the larger the positive electrode active material is. The hydroxide that affects the size of the positive electrode active material that is a lithium composite oxide may be referred to as a precursor.

The concentration of the alkali in the aqueous solution 202 is higher than or equal to 1 mol/L and lower than or equal to 10 mol/L, preferably higher than or equal to 3 mol/L and lower than or equal to 7 mol/L. The concentration of the chelate agent in the aqueous solution 203 is higher than or equal to 0.05 mol/L and lower than or equal to 0.15 mol/L, preferably higher than or equal to 0.07 mol/L and lower than or equal to 0.12 mol/L.

The structure and the like of the coprecipitation synthesis apparatus 170 with which a coprecipitated substance can be obtained under the above conditions are described with reference to FIG. 10. A stirrer 172 is provided in the reaction vessel 171 in FIG. 10. The stirrer 172 can stir the aqueous solution 203 in the reaction vessel 171, and a stirrer motor 173 is further provided as a power source that makes the stirrer 172 rotate. The stirrer 172 includes a paddle-type agitator blade (denoted as a paddle blade), and the paddle blade includes two to six blades. The blades may have an inclination of greater than or equal to 40 degrees and less than or equal to 70 degrees. The above-described blades of the stirrer 172 may be moved up and down. In the mixing step in Step S203, the rotational frequency of the stirrer 172, specifically, the rotational frequency of the paddle blade is preferably greater than or equal to 800 rpm and less than or equal to 1200 rpm, further preferably greater than or equal to 900 rpm and less than or equal to 1100 rpm. Although not illustrated, a baffle plate may be provided in the reaction vessel 171.

A thermometer 174 is provided in order to measure the temperature of the reaction vessel 171 or the water temperature of the aqueous solution 203. The temperature of the reaction vessel 171 can be controlled using a thermoelectric element such that the temperature of the aqueous solution 203 is constant. An example of the thermoelectric element is a Peltier element. In the case of measuring the water temperature of the aqueous solution 203, the end of the thermometer 174 is preferably soaked in the aqueous solution 203. In the mixing step in Step S203, the aqueous solution 203 is preferably heated to higher than or equal to 40° C. and lower than or equal to 90° C., further preferably higher than or equal to 45° C. and lower than or equal to 70° C. In order to control the water temperature of the aqueous solution 203, the temperature of the reaction vessel 171 may be controlled with the thermometer 174.

The coprecipitation synthesis apparatus 170 includes a control device 190 and the like to control the conditions of dropping from each pump or the conditions of stirring. The control device 190 can control the rotational frequency of the stirrer 172, the dropping amount of each aqueous solution, and the like in consideration of information obtained from the thermometer 174. In the mixing step in Step S203, the dropping rate of the aqueous solution 201 is preferably greater 20 than or equal to 0.05 mL/min and less than or equal to 1.0 m/min, further preferably greater than or equal to 0.08 m/min and 0.5 m/min, for example. The concentration of transition metal ions in the aqueous solution 201 is preferably higher than or equal to 1 mol/L and lower than or equal to 5 mol/L, further preferably higher than or equal to 2 mol/L and lower than or equal to 3 mol/L. In the case where a plurality of transition metals are contained, the total concentration of the transition metal ions preferably falls within the above range.

Although not illustrated, a pH meter is also provided in the reaction vessel 171, and the pH of the aqueous solution 203 can be measured. In the mixing step in Step S203, the pH value preferably falls within the range from greater than or equal to 9.0 to less than or equal to 13.0, further preferably from greater than or equal to 10.5 to less than or equal to 11.5. The concentration of the chelate agent in the aqueous solution 203 is preferably higher than or equal to 0.05 mol/L and lower than or equal to 0.15 mol/L, further preferably higher than or equal to 0.07 mol/L and lower than or equal to 0.12 mol/L.

The aqueous solution 202 is dropped when the pH value varies from a desired value. The concentration of the alkali in the aqueous solution 202 is preferably higher than or equal to 1 mol/L and lower than or equal to 10 mol/L, further preferably higher than or equal to 3 mol/L and lower than or equal to 7 mol/L.

Through the mixing step in Step S203, a reaction product is precipitated in the reaction vessel 171. The reaction product is a coprecipitated substance, specifically, a hydroxide.

The subsequent steps, specifically Step S205 and the subsequent steps, are similar to those of the manufacturing method 1; thus, the description thereof is omitted.

In this manner, the positive electrode active material can be manufactured. Note that according to the manufacturing method 2, NCM with favorable particle size distribution can be obtained as the positive electrode active material. NCM obtained is preferably used because the discharge capacity can be increased among battery characteristics. Furthermore, NCM obtained is preferably used because a variation in discharge capacity can be inhibited among battery characteristics.

### <Manufacturing Method 3>

In the present invention, NCM described above may contain one or two or more selected from calcium and aluminum at a concentration higher than or equal to 0.1 atm % and lower than or equal to 5 atm % with respect to NCM. Calcium or aluminum at the above concentration is sometimes referred to as an additive element. The additive element is often positioned in a surface portion of the active material. The surface portion refers to a region from a surface of the active material to 50 nm, preferably to 30 nm, further preferably to 10 nm. The surface portion can be regarded as being positioned similarly both in the case where the active material is a primary particle and in the case where the active material is a secondary particle, and a region from a surface of the primary particle or a surface of the secondary particle to 50 nm, preferably to 30 nm, further preferably to 10 nm is referred to as the surface portion. Note that the surface of the primary particle or the surface of the secondary particle corresponds to an interface between a region where a transition metal (e.g., Co, Ni, Mn, or Fe) that becomes oxidized or reduced due to insertion and extraction of lithium is present and a region where such a transition metal is not present.

When containing aluminum as its main component, NCM described above is sometimes referred to as NCMA. NCMA is sometimes referred to as a lithium composite oxide containing Ni, Co, Mn, and Al.

In addition, a lithium composite oxide containing Ni and Co and containing aluminum as its main component is sometimes referred to as NCA. NCA is sometimes referred to as a lithium composite oxide containing Ni, Co, and Al.

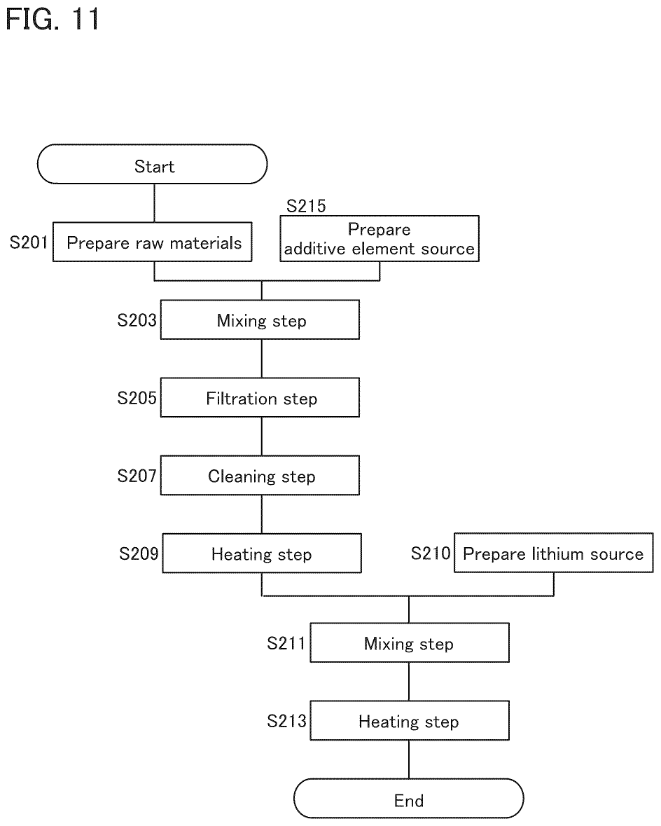

In this manufacturing method 3, the case where the additive element source is added in the same step, i.e., at the same time, as the raw materials prepared in Step S201 is described with reference to FIG. 11. This manufacturing method 3 illustrated in FIG. 11 is similar to the manufacturing method 1 from Step S203 to Step S213, but additionally includes Step S215.

### <Step S215: Prepare Additive Element Source>

In Step S215 in FIG. 11, an additive element source is prepared. As the additive element source, an aqueous solution in which a salt of the additive element source is dissolved can be used. As the aqueous solution, an aqueous solution in which aluminum sulfate, aluminum chloride, aluminum nitrate, calcium oxide, calcium carbonate, calcium hydroxide, or calcium sulfate is dissolved can be used. The additive element source is weighed such that the additive element is greater than or equal to 0.1 atm % and less than or equal to 5 atm % of NCM A plurality of additive elements may be contained. In the case where a plurality of additive elements are contained, the total concentration of the additive elements satisfies greater than or equal to 0.1 atm % and less than or equal to 5 atm % of NCM.

### <Step S203: Mixing Step>

In Step S203 in FIG. 11, the aqueous solution in which the transition metal salt is dissolved, the alkaline aqueous solution, and the aqueous solution in which the salt of the additive element source is dissolved are mixed to manufacture a mixed solution. This mixing step is similar to Step S203 of the manufacturing method 1.

The subsequent steps, specifically Step S205 and the subsequent steps, are similar to those of the manufacturing method 1; thus, the description thereof is omitted.

In this manner, the positive electrode active material can be manufactured. Note that according to the manufacturing method 3, NCM containing the additive element can be obtained as the positive electrode active material. The additive element is preferably positioned in a surface portion of NCM. According to the manufacturing method 3, NCMA or NCA can also be obtained as the positive electrode active material.

### <Manufacturing Method 4>

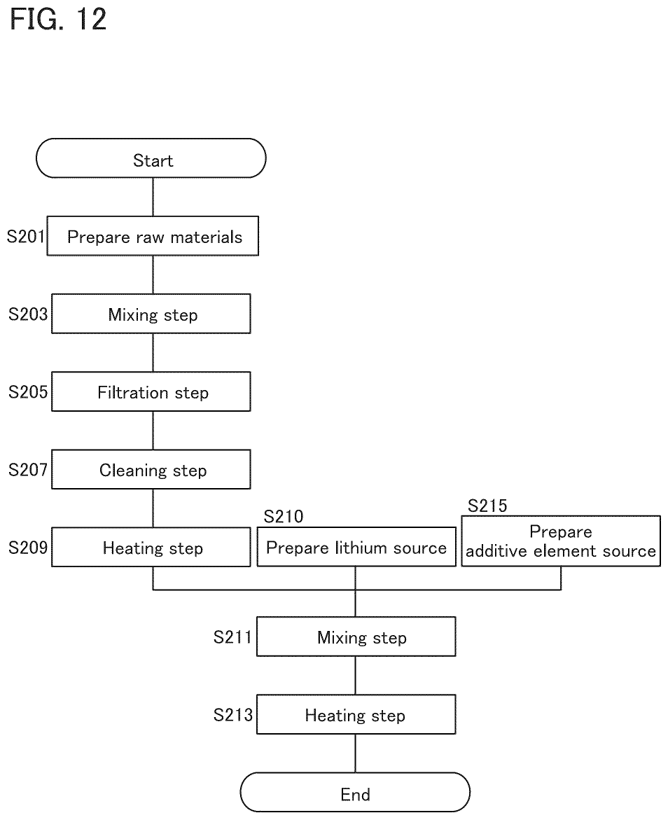

In this manufacturing method 4, the case where the additive element source is added in the same step, i.e., at the same time, as the lithium source prepared in Step S210 is described with reference to FIG. 12. This manufacturing method 4 illustrated in FIG. 12 is similar to the manufacturing method 1 from Step S201 to Step S210, but additionally includes Step S215. In addition, the timing of Step S215 is different from that in the manufacturing method 3 described above.

### <Step S215: Prepare Additive Element Source>

In Step S215 in FIG. 12, an additive element source is prepared. As the additive element source, aluminum sulfate, aluminum chloride, aluminum nitrate, calcium oxide, calcium carbonate, calcium hydroxide, or calcium sulfate can be used. The additive element source is weighed such that the additive element is greater than or equal to 0.1 atm % and less than or equal to 5 atm % of NCM. A plurality of additive elements may be contained. In the case where a plurality of additive elements are contained, the total concentration of the additive elements satisfies greater than or equal to 0.1 atm % and less than or equal to 5 atm % of NCM.

### <Step S211: Mixing Step>

In Step S211 in FIG. 12, the hydroxide, the lithium source, and the additive element source are mixed to manufacture a mixture. This mixing step is similar to Step S211 of the manufacturing method 1.

The subsequent steps, specifically Step S213 and the subsequent steps, are similar to those of the manufacturing method 1; thus, the description thereof is omitted.

In this manner, the positive electrode active material can be manufactured. Note that according to the manufacturing method 4, NCM containing the additive element can be obtained as the positive electrode active material. The additive element is preferably positioned in a surface portion of NCM. According to the manufacturing method 4, NCMA or NCA can also be obtained as the positive electrode active material.

### <Manufacturing Method 5>

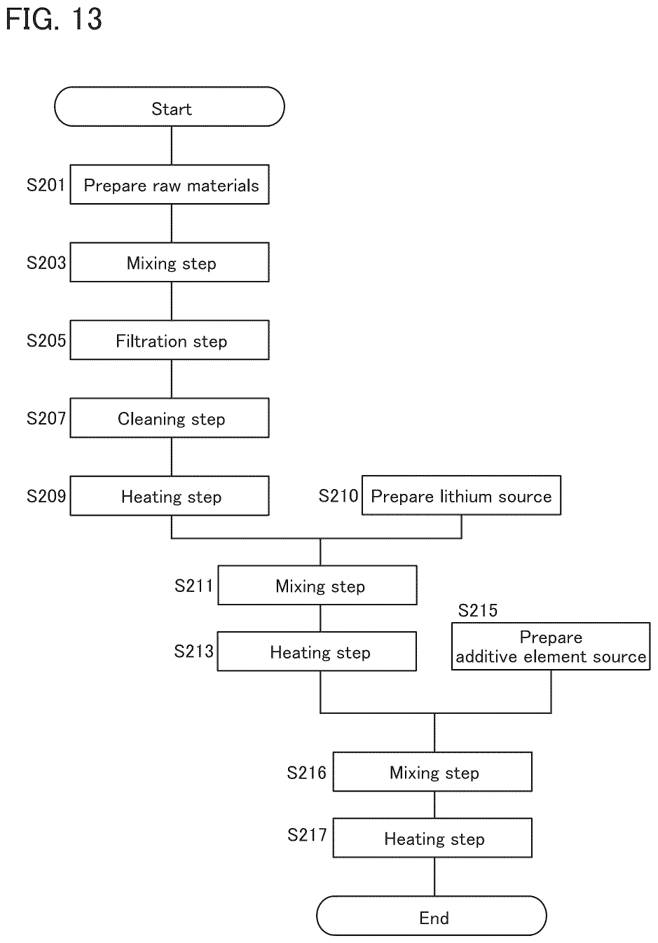

In this manufacturing method 5, the case where the additive element source is added after the heating step in Step S213 is described with reference to FIG. 13. This manufacturing method 5 illustrated in FIG. 13 is similar to the manufacturing method 1 from Step S201 to Step S213, but additionally includes Step S215 to Step S217. In addition, the timing of Step S215 is different from those in the manufacturing methods 3 and 4 described above.

### <Step S215: Prepare Additive Element Source>

In Step S215 in FIG. 13, an additive element source is prepared. As the additive element source, aluminum sulfate, aluminum chloride, aluminum nitrate, calcium oxide, calcium carbonate, calcium hydroxide, or calcium sulfate can be used. The additive element source is weighed such that the additive element is greater than or equal to 0.1 atm % and less than or equal to 5 atm % of NCM. A plurality of additive elements may be contained. In the case where a plurality of additive elements are contained, the total concentration of the additive elements satisfies greater than or equal to 0.1 atm % and less than or equal to 5 atm % of NCM.

### <Step S216: Mixing Step>

In Step S216 in FIG. 13, the composite oxide and the additive element source are mixed to manufacture a mixture. This mixing step is similar to Step S211 of the manufacturing method 1.

### <Step S217: Heating Step>

In Step S217 in FIG. 13, the mixture is heated. This heating step is similar to Step S213 of the manufacturing method 1.

In this manner, the positive electrode active material can be manufactured. Note that according to the manufacturing method 5, NCM containing the additive element can be obtained as the positive electrode active material. The additive element is preferably positioned in a surface portion of NCM. According to the manufacturing method 5, NCMA or NCA can also be obtained as the positive electrode active material.

This embodiment can be freely combined with the other embodiments.

### Embodiment 4

In this embodiment, components of a lithium-ion battery, other than a positive electrode active material and an electrolyte included therein, will be described.

<Positive electrode 1>

A positive electrode includes a positive electrode active material layer and a positive electrode current collector. The positive electrode active material layer includes a positive electrode active material and may further include at least one of a conductive additive and a binder. As the positive electrode active material, any of the positive electrode active materials described in Embodiment 1 can be used.

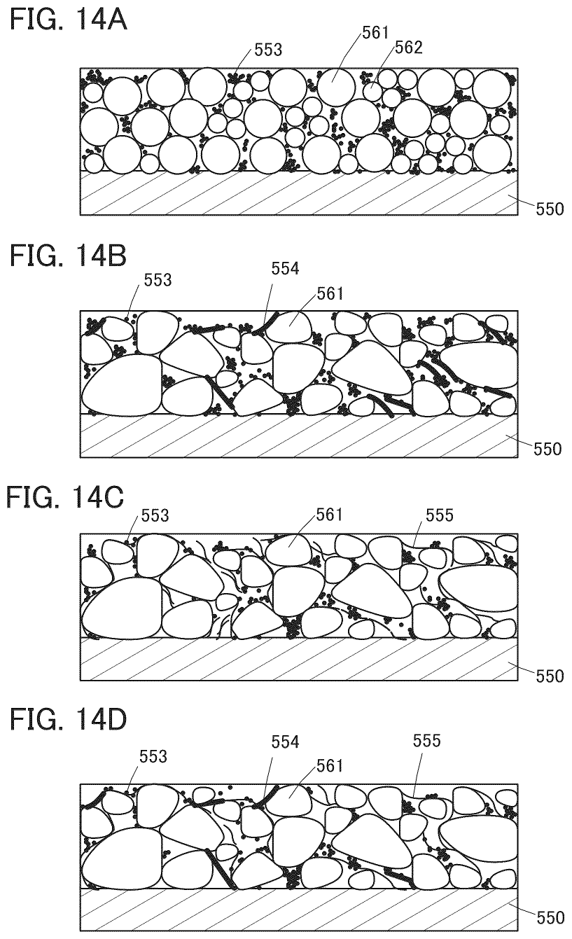

FIG. 14A illustrates an example of a schematic cross-sectional view of the positive electrode.

Metal foil can be used as a current collector 550, for example. The positive electrode can be formed by applying slurry onto the metal foil and drying the slurry. Note that pressing may be performed after drying. The positive electrode is a component obtained by forming an active material layer over the current collector 550.

Slurry refers to a material solution that is used to form an active material layer over the current collector 550 and includes an active material, a binder, and a solvent, preferably also a conductive additive mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

A positive electrode active material 561 has functions of taking in and/or releasing lithium ions in accordance with charging and discharging. For the positive electrode active material 561 used as one embodiment of the present invention, a material with little deterioration due to discharging and charging even at a high charge voltage can be used. In this specification and the like, unless otherwise specified, a charge voltage is shown with reference to the potential of lithium metal. In this specification and the like, high charge voltage is a charge voltage, for example, higher than or equal to 4.6 V, preferably higher than or equal to 4.65 V, further preferably higher than or equal to 4.7 V, still further preferably higher than or equal to 4.75 V, most preferably higher than or equal to 4.8 V.

For the positive electrode active material 561 used as one embodiment of the present invention, any material can be used as long as it shows little deterioration due to discharging and charging even at a high charge voltage, and any of the materials described in Embodiment 1 or Embodiment 2 can be used. Note that for the positive electrode active material 561, two or more kinds of materials having different particle diameters can be used as long as the materials show little deterioration due to discharging and charging even at a high charge voltage.

A conductive additive is also referred to as a conductivity-imparting agent or a conductive material, and a carbon material can be used as the conductive additive. A conductive additive is attached between a plurality of active materials, whereby the plurality of active materials are electrically connected to each other, and the conductivity increases. Note that in this specification and the like, the term “attach” refers not only to a state where an active material and a conductive additive are physically in close contact with each other, and includes, for example, the following concepts: the case where covalent bonding occurs, the case where bonding with the Van der Waals force occurs, the case where a conductive additive covers part of the surface of an active material, the case where a conductive additive is embedded in surface roughness of an active material, and the case where an active material and a conductive additive are electrically connected to each other without being in contact with each other.

Specific examples of carbon materials that can be used as the conductive additive include carbon black (e.g., furnace black, acetylene black, or graphite).

In FIG. 14A, carbon black 553 is illustrated as the conductive additive.

In the positive electrode of the lithium-ion battery, a binder (a resin) may be mixed in order to adhere the current collector 550 such as metal foil and the active material to each other. The binder is also referred to as a binding agent. Since the binder is a high molecular material, a large amount of the binder lowers the proportion of the active material in the positive electrode, thereby reducing the discharge capacity of the lithium-ion battery. Therefore, the amount of the binder mixed is preferably reduced to a minimum. In FIG. 14A, a region not filled with the positive electrode active material 561, a second active material 562, or the carbon black 553 indicates a space or the binder.

Although FIG. 14A illustrates an example in which the positive electrode active material 561 has a spherical shape, there is no particular limitation thereto. The cross-sectional shape of the positive electrode active material 561 may be an ellipse, a rectangle, a trapezoid, a pyramid, a polygon with rounded corners, or an asymmetrical shape, for example. For example, FIG. 14B illustrates an example in which the positive electrode active material 561 has a polygon shape with rounded corners.

In the positive electrode in FIG. 14B, graphene 554 is used as a carbon material used as the conductive additive. In FIG. 14B, a positive electrode active material layer including the positive electrode active material 561, the graphene 554, and the carbon black 553 is formed over the current collector 550.

In the step of mixing the graphene 554 and the carbon black 553 to obtain an electrode slurry, the weight of mixed carbon black is preferably 1.5 times to 20 times, further preferably 2 times to 9.5 times the weight of graphene.

When the graphene 554 and the carbon black 553 are mixed in the above range, the carbon black 553 is excellent in dispersion stability and an aggregated portion is unlikely to be generated at the time of preparing a slurry. Furthermore, when the graphene 554 and the carbon black 553 are mixed in the above range, the electrode density can be higher than that of a positive electrode using only the carbon black 553 as a conductive additive. As the electrode density becomes higher, the capacity per unit weight can become higher. Specifically, the density of the positive electrode active material layer measured by gravimetry can be higher than or equal to 3.5 g/cc.

The electrode density is lower than that of a positive electrode containing only graphene as a conductive additive, but when a first carbon material (graphene) and a second carbon material (acetylene black) are mixed in the above range, fast charging can be achieved. Thus, use of such a mixed conductive additive for lithium-ion batteries for vehicles is particularly effective.

FIG. 14C illustrates an example of a positive electrode in which carbon fiber 555 is used instead of graphene. FIG. 14C illustrates an example different from FIG. 14B. With use of the carbon fiber 555, aggregation of the carbon black 553 can be prevented and the dispersibility can be increased.

In FIG. 14C, the region not filled with the positive electrode active material 561, the carbon fiber 555, or the carbon black 553 indicates a space or the binder.

FIG. 14D illustrates another example of a positive electrode. FIG. 14C illustrates an example in which the carbon fiber 555 is used in addition to the graphene 554. With use of both the graphene 554 and the carbon fiber 555, aggregation of carbon black such as the carbon black 553 can be prevented and the dispersibility can be further increased.

In FIG. 14D, the region not filled with the positive electrode active material 561, the carbon fiber 555, the graphene 554, or the carbon black 553 indicates a space or the binder.

A lithium-ion battery can be fabricated by using any one of the positive electrodes in FIG. 14A to FIG. 14D; setting, in a container (e.g., an exterior body or a metal can) or the like, a stack in which a separator is provided over the positive electrode and a negative electrode is provided over the separator; and filling the container with an electrolyte solution.

### <Positive Electrode 2>

The positive electrode includes a positive electrode active material layer and a positive electrode current collector. The positive electrode active material layer includes a positive electrode active material and sometimes further includes a conductive material. The positive electrode active material layer sometimes further includes a binder. Furthermore, the positive electrode active material layer sometimes includes a conductive material and a binder.

### <Positive Electrode Active Material>

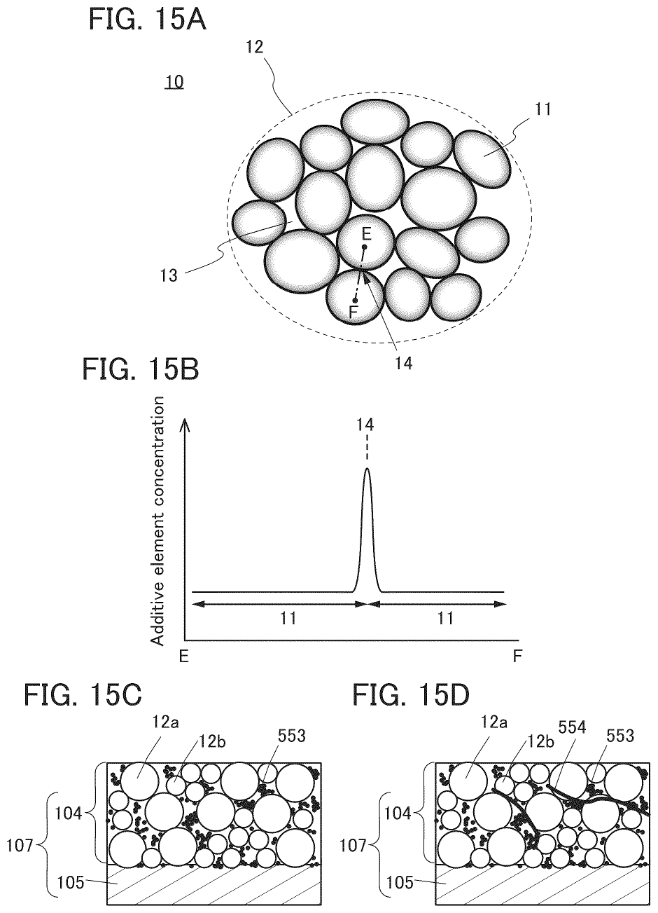

FIG. 15A illustrates an example of the positive electrode active material 10. As the positive electrode active material, any of the materials described above in Embodiment 2 or the like can be used, for example. The positive electrode active material manufactured in accordance with Embodiment 2 or the like includes a secondary particle 12 including primary particles 11, and the like. A space 13 is sometimes observed between the aggregated primary particles 11. In addition, there is an interface 14 between the adjacent primary particles 11.

### [Distribution of Additive Element]

The positive electrode active material fabricated by any of the manufacturing methods 3 to 5 and the like described above in Embodiment 3 can contain the additive element. FIG. 15B illustrates concentration distribution of the additive element in an E-F cross section indicated by the dashed-dotted line in FIG. 15A. Since the E-F cross section passes through the interface 14, FIG. 15B illustrates concentration distribution of the additive element from the interface 14 to the inner portions of the primary particles. In this specification and the like, the concentration distribution is sometimes referred to as a concentration gradient, and the vicinity of the interface refers to a region of a primary particle from the interface to less than 10 nm, preferably a region of a primary particle from the interface 14 to less than 8 nm. A region of a primary particle from the interface to less than 10 m is referred to as a surface portion of the primary particle in some cases.

The horizontal axis in FIG. 15B corresponds to a distance in the E-F cross section, and the vertical axis corresponds to the concentration of the additive element. The concentration peak of the additive element is preferably positioned to overlap with the interface 14. An example of the additive element is calcium. The positive electrode active material containing the additive element having such a concentration peak is preferable because cycle degradation can be inhibited. In the case where the positive electrode active material is manufactured using a plurality of additive elements, the position of the concentration peak may differ among the additive elements.

Note that in the primary particle 11, the concentration of the additive element preferably decreases from the surface toward the inner portion as illustrated in FIG. 15B. That is, in the primary particle, the concentration of the additive element is preferably higher in the surface portion than in the inner portion. For example, calcium, which is an example of the additive element, preferably decreases in concentration from the surface toward the inner portion as illustrated in FIG. 15B. In the case where the positive electrode active material is manufactured using a plurality of additive elements, the concentration distribution may differ in shape among the additive elements.

### [Cross-Sectional View of Positive Electrode]

FIG. 15C illustrates an example of a cross-sectional view of a positive electrode 107. The positive electrode 107 includes a positive electrode current collector 105 and a positive electrode active material layer 104.

### <Positive Electrode Current Collector>

Metal foil can be used as the positive electrode current collector 105, for example. The positive electrode can be formed by applying slurry onto the metal foil and drying the slurry. Note that pressing may be performed after drying. The positive electrode is a component obtained by forming the positive electrode active material layer 104 over the positive electrode current collector 105.

As the metal foil, a material that has high conductivity, such as a metal like stainless steel, gold, platinum, aluminum, or titanium, or an alloy thereof, can be used. It is preferable that a material used for the positive electrode current collector not be eluted at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness greater than or equal to 5 μm and less than or equal to 30 μm.

Slurry refers to a material solution that is used to form the positive electrode active material layer 104 over the positive electrode current collector 105 and includes an active material, a binder, and a solvent, preferably also a conductive material mixed therewith. Slurry may also be referred to as slurry for an electrode or active material slurry; in some cases, slurry for forming a positive electrode active material layer is referred to as slurry for a positive electrode, and slurry for forming a negative electrode active material layer is referred to as slurry for a negative electrode.

The positive electrode active material layer 104 includes a secondary particle 12a and a secondary particle 12b as a positive electrode active material. The secondary particle 12a differs in median diameter (D50) from the secondary particle 12b.

### <Conductive Material>

Next, a conductive material is described. A conductive material is also referred to as a conductivity-imparting agent or a conductive additive, and a carbon material can be used as the conductive material. A conductive material is attached between a plurality of active materials, whereby the plurality of active materials are electrically connected to each other, and the conductivity increases. Note that in this specification and the like, the term “attach” refers not only to a state where an active material and a conductive material are physically in close contact with each other, and includes, for example, the following concepts: the case where covalent bonding occurs, the case where bonding with the Van der Waals force occurs, the case where a conductive material covers part of the surface of an active material, the case where a conductive material is embedded in surface roughness of an active material, and the case where an active material and a conductive material are electrically connected to each other without being in contact with each other.

As a specific example of a carbon material that can be used as the conductive material, carbon black (e.g., furnace black, acetylene black, or graphite), graphene, a graphene compound, or carbon fiber can be used.

### [Graphene and Graphene Compound]

In this specification and the like, graphene contains carbon, has a shape such as a plate-like shape or a sheet-like shape, and has a two-dimensional structure formed of a six-membered ring composed of carbon atoms. In addition to the graphene, multilayer graphene, multi graphene, and the like are included. The graphene may be rounded like carbon nanofiber. Graphene having the two-dimensional structure formed of the six-membered ring composed of carbon atoms may be referred to as a carbon sheet.

A graphene compound in this specification and the like has a shape such as a plate-like shape or a sheet-like shape, and includes graphene oxide, multilayer graphene oxide, multi graphene oxide, reduced graphene oxide, reduced multilayer graphene oxide, reduced multi graphene oxide, graphene quantum dots, and the like. The graphene compound may be rounded like carbon nanofiber. The graphene compound may further include a functional group, and an epoxy group, a carboxy group, or a hydroxy group is preferable as the functional group.

The reduced graphene oxide, reduced multilayer graphene oxide, or reduced multi graphene oxide in this specification and the like preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide, reduced multilayer graphene oxide, or reduced multi graphene oxide can function as a conductive material with high conductivity even with a small amount. In addition, the intensity ratio G/D of a G band to a D band of the Raman spectrum of the reduced graphene oxide, reduced multilayer graphene oxide, or reduced multi graphene oxide is preferably 1 or more. With such an intensity ratio, the reduced graphene oxide, reduced multilayer graphene oxide, or reduced multi graphene oxide can function as a conductive material with high conductivity even with a small amount. Furthermore, reducing graphene oxide, multilayer graphene oxide, or multi graphene oxide can form a vacancy in a graphene compound in some cases.

In FIG. 15C, the carbon black 553 is illustrated as the conductive material. The carbon black 553 is fine particles and is thus aggregated in many cases. The carbon black 553 can be positioned between the secondary particles 12a and the like and can serve as a current path between the adjacent secondary particles 12a. Furthermore, the carbon black 553 can be positioned between the positive electrode current collector 105 and the secondary particle and can serve as a current path between the positive electrode current collector 105 and the secondary particle.

### <Binder>

In the positive electrode of the lithium-ion battery, a binder (a resin) may be mixed in order to adhere the positive electrode current collector 105 and the active material to each other. The binder is also referred to as a binding agent.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, for example, a water-soluble polymer is preferably used. As the water-soluble polymer, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such a water-soluble polymer be used in combination with any of the above rubber materials.

A plurality of the above-described materials may be used in combination for the binder.

For example, a material having a significant viscosity modifying effect and another material may be used in combination. For example, a rubber material or the like has high adhesion and/or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose, starch, or the like can be used.

Since the above-described binder is a high molecular material, a large amount of the binder lowers the proportion of the active material in the positive electrode or the negative electrode, thereby reducing the discharge capacity of the lithium-ion battery. Therefore, the amount of the binder mixed is preferably reduced to a minimum.

Although FIG. 15C illustrates the secondary particle 12a and the secondary particle 12b as having a spherical shape (a circular cross-sectional shape), there is no particular limitation thereto. Roughness which is part of the primary particles is observed in many cases at a surface of a cross-sectional shape of the secondary particle in which the primary particles are aggregated.

As another example, FIG. 15D illustrates a positive electrode using the carbon black 553 and the graphene 554 as carbon materials used as the conductive material. In the step of mixing the graphene 554 and the carbon black 553 to obtain an electrode slurry, the weight of mixed carbon black is preferably 1.5 times to 20 times, further preferably 2 times to 9.5 times the weight of graphene.

When the graphene 554 and the carbon black 553 are mixed in the above range, the carbon black 553 is excellent in dispersion stability at the time of preparing a slurry, which is preferable. Furthermore, when the graphene 554 and the carbon black 553 are mixed in the above range, the electrode density can be higher than that of a positive electrode using only the carbon black 553 as a conductive material. As the electrode density becomes higher, the capacity per unit weight can become higher. Specifically, the density of the positive electrode active material layer measured by gravimetry can be higher than or equal to 3.5 g/cc.

The electrode density is lower than that of a positive electrode containing only graphene as a conductive material, but when the graphene 554 and the carbon black 553 are mixed in the above range, fast charging can be achieved. Thus, mixing the graphene 554 and the carbon black 553 is effective for lithium-ion batteries for vehicles.

Although not illustrated, carbon fiber (carbon nanotube) may be used instead of the graphene. With use of carbon fiber as the conductive material, aggregation of the carbon black 553 can be prevented.

A lithium-ion battery can be fabricated by using any one of the positive electrodes in FIG. 15C and FIG. 15D; setting, in a container (e.g., an exterior body or a metal can) or the like, a stack in which a separator is provided over the positive electrode and a negative electrode is provided over the separator; and filling the container with an electrolyte. That is, in FIG. 15C and FIG. 15D, a region that is a space is impregnated with the electrolyte.

### <Negative Electrode>

The negative electrode includes a negative electrode active material layer and a negative electrode current collector. The negative electrode active material layer includes a negative electrode active material and may further include a conductive material and a binder.

### <Negative Electrode Active Material>

As the negative electrode active material, for example, an alloy-based material and/or a carbon material can be used.

As the negative electrode active material, an element that enables charge and discharge reactions by an alloying reaction and a dealloying reaction with lithium can be used. For example, one or two or more materials selected from silicon, tin, gallium, aluminum, germanium, lead, antimony, bismuth, silver, zinc, cadmium, indium, and the like can be used. Such elements have higher capacity than carbon. In particular, silicon has a high theoretical capacity of 4200 mAh/g. For this reason, silicon is preferably used as the negative electrode active material. Alternatively, a compound containing any of the above elements may be used. Examples of the compound include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn. Here, an element that enables charge and discharge reactions by alloying and dealloying reactions with lithium and a compound containing the element, for example, are referred to as alloy-based materials in some cases.

In this specification and the like, “SiO” refers, for example, to silicon monoxide. SiO can alternatively be expressed as SiOₓ. Here, it is preferable that x be 1 or have an approximate value of 1. For example, x is preferably greater than or equal to 0.2 and less than or equal to 1.5, or preferably greater than or equal to 0.3 and less than or equal to 1.2.

As the carbon material, one or two or more selected from graphite, graphitizing carbon (soft carbon), non-graphitizing carbon (hard carbon), carbon fiber (carbon nanotube), graphene, carbon black, and the like is used.

Examples of graphite include artificial graphite and natural graphite. Examples of artificial graphite include mesocarbon microbeads (MCMB), coke-based artificial graphite, and pitch-based artificial graphite. As artificial graphite, spherical graphite having a spherical shape can be used. For example, MCMB is preferably used because it may have a spherical shape. Moreover, MCMB may preferably be used because it can relatively easily have a small surface area. Examples of natural graphite include flake graphite and spherical natural graphite.

Graphite has a low potential substantially equal to that of lithium metal (higher than or equal to 0.05 V and lower than or equal to 0.3 V vs. Li/Li+) when lithium ions are inserted into graphite (while a lithium-graphite intercalation compound is formed). For this reason, a lithium-ion battery using graphite can have a high operating voltage. In addition, graphite is preferred because of its advantages such as a relatively high capacity per unit volume, relatively small volume expansion, low cost, and a higher level of safety than that of lithium metal.

As the negative electrode active material, one or two or more oxides selected from titanium dioxide (TiO₂), lithium titanium composite oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Alternatively, as the negative electrode active material, Li₃₋ₓMₓN (M=Co, Ni, or Cu) with a Li₃N structure, which is a nitride of lithium and a transition metal, can be used. For example, Li_{2.6}Co_{0.4}N is preferable because of its high discharge capacity (900 mAh/g (per negative electrode active material weight) and 1890 mAh/cm³).

A nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that in the case of using a material containing lithium ions as a positive electrode active material, the nitride of lithium and a transition metal can be used as the negative electrode active material by extracting the lithium ions contained in the positive electrode active material in advance.

A material that causes a conversion reaction can be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorides such as FeF₃ and BiF₃.

For the conductive material and the binder that can be included in the negative electrode active material layer, materials similar to those for the conductive material and the binder that can be included in the positive electrode active material layer can be used.

### <Negative Electrode Current Collector>

For the negative electrode current collector, copper or the like can be used in addition to a material similar to that of the positive electrode current collector. Note that a material that does not alloy with carrier ions of lithium or the like is preferably used for the negative electrode current collector.

### [Electrolyte]

As the electrolyte, any of the electrolytes described in Embodiment 1 and the like can be used.

### [Separator]

When the electrolyte includes an electrolyte solution, a separator is placed between the positive electrode and the negative electrode. As the separator, for example, a fiber containing cellulose such as paper; nonwoven fabric; a glass fiber; ceramics; a synthetic fiber using nylon (polyamide), vinylon (polyvinyl alcohol-based fiber), polypropylene (referred to as PP), polyimide (referred to as PI), polyester, acrylic, polyolefin, or polyurethane; or the like can be used. The separator can have a porosity in thickness higher than or equal to 35% and lower than or equal to 90%, preferably higher than or equal to 60% and lower than or equal to 85%. A separator using polypropylene can have a porosity higher than or equal to 35% and lower than or equal to 45%. A separator using polyimide can have a porosity higher than or equal to 75% and lower than or equal to 85%. The thickness of the separator is preferably greater than or equal to 10 μm and less than or equal to 80 μm, further preferably greater than or equal to 20 μm and less than or equal to 60 μm. The separator using polyimide is preferable because it can have a high porosity and can have a large thickness (typically, a thickness greater than or equal to 50 μm and less than or equal to 60 μm).

The separator is preferably processed into a bag-like shape to wrap one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

With the use of a separator having a multilayer structure, the capacity per volume of the lithium-ion battery can be increased because the safety of the lithium-ion battery can be maintained even when the total thickness of the separator is small.

### [Exterior Body]

For an exterior body included in the lithium-ion battery, a metal material such as aluminum or a resin material can be used, for example. A film-like exterior body can also be used. As the film, for example, it is possible to use a film having a three-layer structure in which a highly flexible metal thin film of aluminum, stainless steel, copper, nickel, or the like is provided over a film formed of a material such as polyethylene, polypropylene, polycarbonate, ionomer, or polyamide, and an insulating synthetic resin film of a polyamide-based resin, a polyester-based resin, or the like is provided over the metal thin film as the outer surface of the exterior body.

### <<Evaluation Conditions>>

Whether or not the electrolyte of one embodiment of the present invention is contained can be evaluated by fabricating a coin cell (e.g., CR2032 type with a diameter of 20 mm and a height of 3.2 mm) using lithium metal as a counter electrode and charging and discharging it under predetermined conditions.

### <<Evaluation Procedure>>

A given lithium-ion battery is disassembled, and a positive electrode immersed in an electrolyte is taken out. Measurement by nuclear magnetic resonance spectroscopy (e.g., ¹H NMR) is performed on the electrolyte to identify at least an organic solvent. The mixing ratio (volume ratio) of the organic solvent can also be identified by nuclear magnetic resonance spectroscopy. In addition, a lithium salt, an additive agent, or the like contained in the electrolyte can also be identified.

After that, the positive electrode is punched out to a size that fits into a coin cell. The positive electrode includes a conductive material and a binder in addition to a positive electrode active material. The electrolyte or the like is removed after the measurement by nuclear magnetic resonance spectroscopy and before the positive electrode is punched out. For example, after the positive electrode is taken out, the positive electrode may be cleaned with an organic solvent or the like.

The coin cell includes lithium metal as the counter electrode. Note that a material other than lithium metal may be used as the counter electrode.

As the electrolyte in the coin cell, an electrolyte identified by nuclear magnetic resonance spectroscopy is prepared. This electrolyte is the electrolyte of one embodiment of the present invention.

The coin cell includes a 25-μm-thick polypropylene porous film as a separator.

The coin cell includes stainless steel (SUS) as a positive electrode can and includes stainless steel (SUS) as a negative electrode can.

In this manner, an evaluation coin cell is prepared.

The evaluation coin cell fabricated under the above conditions is charged to a given voltage (e.g., 4.4 V, 4.5 V, or 4.6 V) and then discharged. For charging conditions, the following examples and the like can be referred to. For discharge conditions, the following examples and the like can be referred to.

The temperature at the time of charging the evaluation coin cell can be set to 25° C. and a temperature below freezing, so that it is possible to observe how much charge and discharge capacities at the temperature below freezing are with respect to charge and discharge capacities at 25° C.

This embodiment can be used in combination with the other embodiments.

### Embodiment 5

In this embodiment, embodiment examples of lithium-ion batteries are described.

### [Laminated Lithium-Ion Battery]

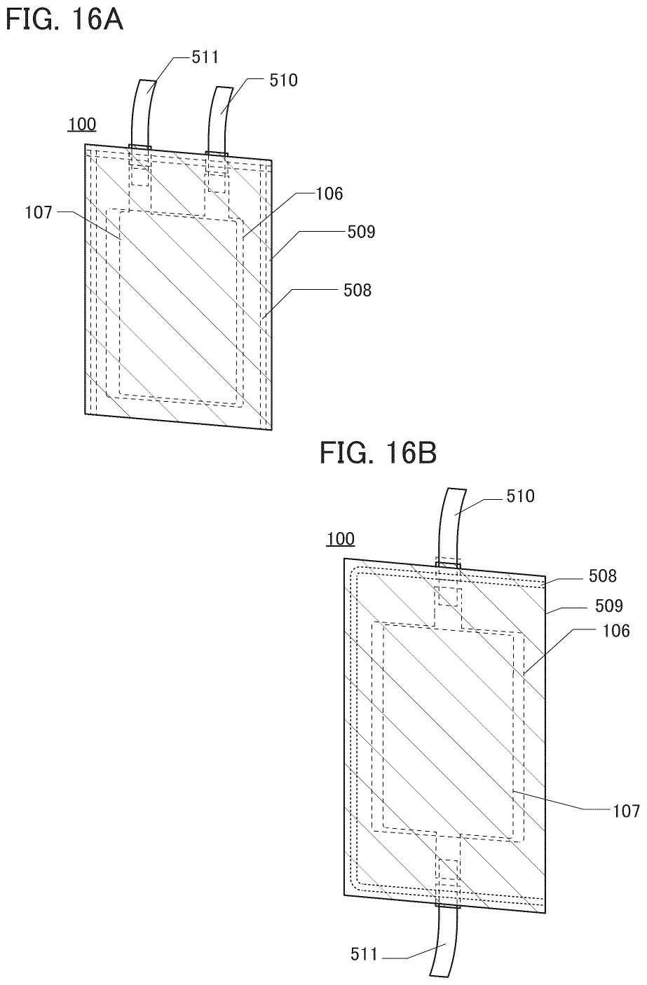

FIG. 16A and FIG. 16B illustrate embodiment examples of a laminated lithium-ion battery 100. FIG. 16A and FIG. 16B are external views, and the lithium-ion battery 100 includes the electrolyte and the separator described in the above embodiments (which are not illustrated in FIG. 16), the negative electrode 106, and the positive electrode 107. In the lithium-ion battery 100, the negative electrode 106 preferably has a larger area than the positive electrode 107. Furthermore, the lithium-ion battery 100 includes a negative electrode lead electrode 510 electrically connected to the negative electrode 106 and a positive electrode lead electrode 511 electrically connected to the positive electrode 107. The electrolyte, the negative electrode 106, and the positive electrode 107 are held in an exterior body 509, and part of the negative electrode lead electrode 510 and part of the positive electrode lead electrode 511 protrude from the exterior body 509. A bonding region 508 is provided in part of the outer periphery of the exterior body 509. FIG. 16A illustrates an embodiment example in which the negative electrode lead electrode 510 and the positive electrode lead electrode 511 protrude from the same side of the exterior body 509, and the bonding region 508 is positioned at least on the side where the lead electrodes protrude and two sides adjacent to that side. FIG. 16B illustrates an embodiment example in which a side where the negative electrode lead electrode 510 protrudes from the exterior body 509 and a side where the positive electrode lead electrode 511 protrudes from the exterior body 509 face each other, and the bonding region 508 is positioned at least on the two sides where the lead electrodes protrude and a side sandwiched between the two sides. A side where the bonding region 508 is not positioned in FIG. 16A or FIG. 16B preferably corresponds to a side where the exterior body 509 is folded.

With use of the organic solvent and the positive electrode active material of the present invention in the laminated lithium-ion battery 100, excellent charge and discharge characteristics can be expected in a wide temperature range from temperatures below freezing to high temperatures.

### [Coin-Type Lithium-Ion Battery]

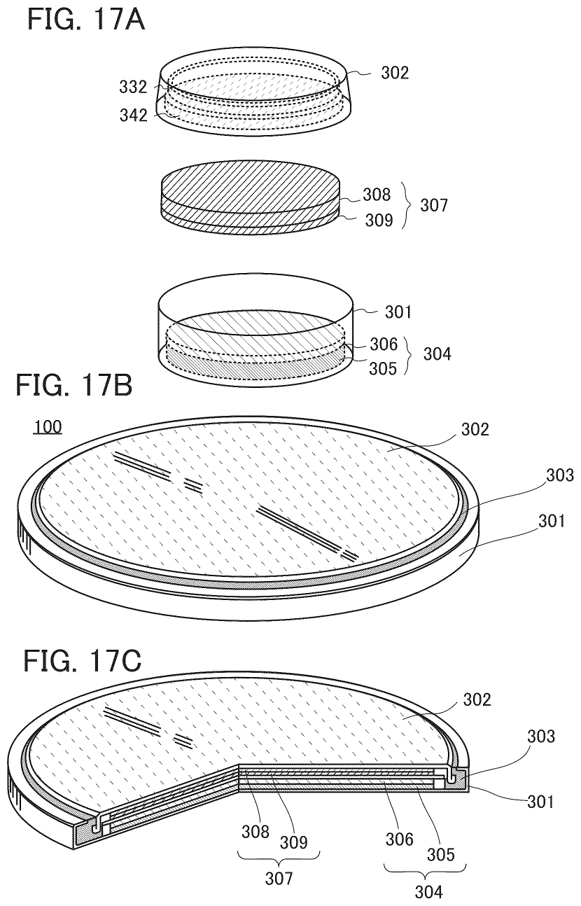

An example of a coin-type lithium-ion battery is described here. FIG. 17A is an exploded perspective view of a coin-type (single-layer flat type) lithium-ion battery, FIG. 17B is an external view thereof, and FIG. 17C is a cross-sectional view thereof. Coin-type lithium-ion batteries are mainly used in small electronic devices. In this specification and the like, coin-type lithium-ion batteries include button-type lithium-ion batteries.

For easy understanding, FIG. 17A is a schematic view illustrating overlap (a vertical relation and a positional relation) between components. Thus, FIG. 17A and FIG. 17B do not completely correspond with each other.

FIG. 17A illustrates a state where a positive electrode 304, a negative electrode 307, a spacer 342, and a washer 332 overlap with each other and are sealed with a negative electrode can 302 and a positive electrode can 301. Note that FIG. 17A does not illustrate the electrolyte and the separator described in the above embodiments. The spacer 342 and the washer 332 are used to protect the inside or fix the position inside the cans at the time when the positive electrode can 301 and the negative electrode can 302 are bonded with pressure. For the spacer 342 or the washer 332, stainless steel or an insulating material is used.

The positive electrode 304 has a stacked-layer structure in which a positive electrode active material layer 306 is formed over a positive electrode current collector 305.

FIG. 17B is a perspective view of a completed coin-type lithium-ion battery 100.

In the coin-type lithium-ion battery 100, the positive electrode can 301 doubling as a positive electrode terminal and the negative electrode can 302 doubling as a negative electrode terminal may be insulated from each other and sealed by a gasket 303 made of polypropylene or the like. The positive electrode 304 includes the positive electrode current collector 305 and the positive electrode active material layer 306 provided in contact with the positive electrode current collector 305. The negative electrode 307 includes a negative electrode current collector 308 and a negative electrode active material layer 309 provided in contact with the negative electrode current collector 308. The positive electrode can 301 and the negative electrode can 302 are electrically connected to the positive electrode 304 and the negative electrode 307, respectively.

Note that only one surface of each of the positive electrode 304 and the negative electrode 307 used for the coin-type lithium-ion battery 100 is provided with an active material layer.

As illustrated in FIG. 17C, the positive electrode 304, the negative electrode 307, and the negative electrode can 302 are stacked in this order with the positive electrode can 301 positioned at the bottom, and then the positive electrode can 301 and the negative electrode can 302 are subjected to pressure bonding with the gasket 303 therebetween; as a result, the coin-type lithium-ion battery 100 is manufactured.

With use of the organic solvent and the positive electrode active material of the present invention in the coin-type lithium-ion battery 100, excellent charge and discharge characteristics can be expected in a wide temperature range from temperatures below freezing to high temperatures.

### [Cylindrical Lithium-Ion Battery]

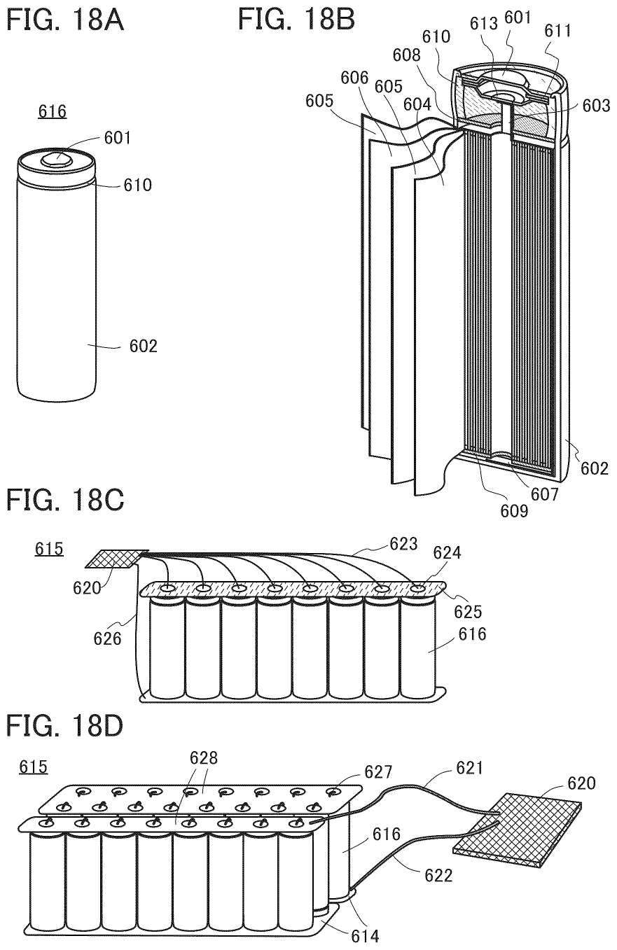

An example of a cylindrical lithium-ion battery is described with reference to FIG. 18A. As illustrated in FIG. 18A, a cylindrical lithium-ion battery 616 includes a positive electrode cap (battery cap) 601 on the top surface and a battery can (outer can) 602 on the side surface and bottom surface. The positive electrode cap 601 and the battery can (outer can) 602 are insulated from each other by a gasket (insulating gasket) 610.

FIG. 18B schematically illustrates a cross section of a cylindrical lithium-ion battery. The cylindrical lithium-ion battery illustrated in FIG. 18B includes the positive electrode cap (battery cap) 601 on the top surface and the battery can (outer can) 602 on the side surface and bottom surface. The positive electrode cap and the battery can (outer can) 602 are insulated from each other by the gasket (insulating gasket) 610.

Inside the battery can 602 having a hollow cylindrical shape, a battery element in which a strip-like positive electrode 604 and a strip-like negative electrode 606 are wound with a separator 605 located therebetween is provided. Although not illustrated, the battery element is wound around a central axis. One end of the battery can 602 is closed and the other end thereof is opened. Inside the battery can 602, the battery element in which the positive electrode, the negative electrode, and the separator are wound is provided between a pair of insulating plates 608 and 609 that face each other. The inside of the battery can 602 provided with the battery element is filled with the electrolyte (not illustrated) of one embodiment of the present invention.

Since a positive electrode and a negative electrode that are used for a cylindrical storage battery are wound, active materials are preferably formed on both surfaces of a current collector. Note that although FIG. 18A to FIG. 18D each illustrate the lithium-ion battery 616 in which the height of the cylinder is larger than the diameter of the cylinder, one embodiment of the present invention is not limited thereto. In a lithium-ion battery, the diameter of the cylinder may be larger than the height of the cylinder. Such a structure can reduce the size of a lithium-ion battery, for example.

A positive electrode terminal (positive electrode current collecting lead) 603 is connected to the positive electrode 604, and a negative electrode terminal (negative electrode current collecting lead) 607 is connected to the negative electrode 606. Both the positive electrode terminal 603 and the negative electrode terminal 607 can be formed using a metal material such as aluminum. The positive electrode terminal 603 and the negative electrode terminal 607 are resistance-welded to a safety valve mechanism 613 and the bottom of the battery can 602, respectively. The safety valve mechanism 613 is electrically connected to the positive electrode cap 601 through a PTC (Positive Temperature Coefficient) element 611. The safety valve mechanism 613 cuts off electrical connection between the positive electrode cap 601 and the positive electrode 604 when the internal pressure of the battery exceeds a predetermined threshold. The PTC element 611, which is a thermally sensitive resistor whose resistance increases as temperature rises, limits the amount of current by increasing the resistance, in order to prevent abnormal heat generation. A barium titanate (BaTiO₃)-based ceramic material or the like can be used for the PTC element.

FIG. 18C illustrates an example of a power storage system 615. The power storage system 615 includes a plurality of lithium-ion batteries 616 and is also referred to as a battery pack in some cases. The positive electrodes of the lithium-ion batteries are in contact with and electrically connected to conductors 624 isolated by an insulator 625. The conductors 624 are electrically connected to a control circuit 620 through wirings 623. The negative electrodes of the lithium-ion batteries are electrically connected to the control circuit 620 through a wiring 626. As the control circuit 620, a protection circuit for preventing overcharging or overdischarging can be used, for example.

FIG. 18D illustrates an example of the power storage system 615. The power storage system 615 includes the plurality of lithium-ion batteries 616, and the plurality of lithium-ion batteries 616 are sandwiched between a conductive plate 628 and a conductive plate 614. The plurality of lithium-ion batteries 616 are electrically connected to the conductive plate 628 and the conductive plate 614 through a wiring 627. The plurality of lithium-ion batteries 616 may be connected in parallel, connected in series, or connected in series after being connected in parallel. With the power storage system 615 including the plurality of lithium-ion batteries 616, large electric power can be extracted.

The plurality of lithium-ion batteries 616 may be connected in series after being connected in parallel.

A temperature control device may be provided between the plurality of lithium-ion batteries 616. The lithium-ion batteries 616 can be cooled with the temperature control device when overheated, whereas the lithium-ion batteries 616 can be heated with the temperature control device when cooled too much. Thus, the performance of the power storage system 615 is less likely to be influenced by the outside temperature.

In FIG. 18D, the power storage system 615 is electrically connected to the control circuit 620 through a wiring 621 and a wiring 622. The wiring 621 is electrically connected to the positive electrodes of the plurality of lithium-ion batteries 616 through the conductive plate 628, and the wiring 622 is electrically connected to the negative electrodes of the plurality of lithium-ion batteries 616 through the conductive plate 614.

With use of the electrolyte and the positive electrode active material of one embodiment of the present invention in the cylindrical lithium-ion battery 100, excellent charge and discharge characteristics can be expected in a wide temperature range from temperatures below freezing to high temperatures.

### Other Structure Examples of Lithium-Ion Battery

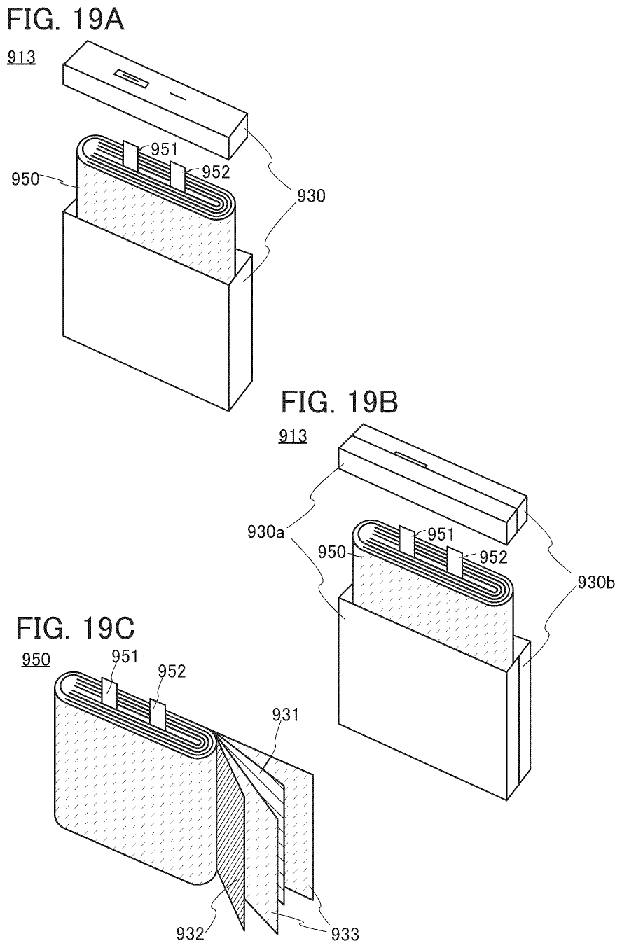

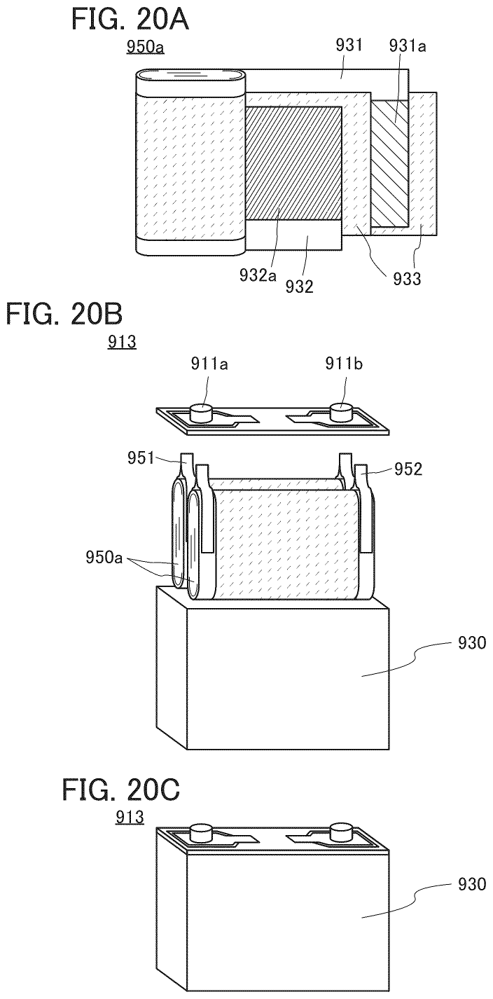

Structure examples of lithium-ion batteries are described with reference to FIG. 19 and FIG. 20.

A lithium-ion battery 913 illustrated in FIG. 19A includes a wound body 950 provided with a terminal 951 and a terminal 952 inside a housing 930. The wound body 950 is immersed in the electrolyte of one embodiment of the present invention inside the housing 930. The terminal 952 is in contact with the housing 930. The terminal 951 is not in contact with the housing 930 with use of an insulator or the like. Note that in FIG. 19A, the housing 930 divided into pieces is illustrated for convenience; however, in the actual structure, the wound body 950 is covered with the housing 930, and the terminal 951 and the terminal 952 extend to the outside of the housing 930. For the housing 930, a metal material (e.g., aluminum) or a resin material can be used.

Note that as illustrated in FIG. 19B, the housing 930 illustrated in FIG. 19A may be formed using a plurality of materials. For example, in the lithium-ion battery 913 illustrated in FIG. 19B, a housing 930a and a housing 930b are attached to each other, and the wound body 950 is provided in a region surrounded by the housing 930a and the housing 930b.

For the housing 930a, an insulating material such as an organic resin can be used. In particular, when a material such as an organic resin is used for the side on which an antenna is formed, blocking of an electric field by the lithium-ion battery 913 can be inhibited. When an electric field is not significantly blocked by the housing 930a, an antenna may be provided inside the housing 930a. For the housing 930b, a metal material can be used, for example.

FIG. 19C illustrates the structure of the wound body 950. The wound body 950 includes a negative electrode 931, a positive electrode 932, and separators 933. The wound body 950 is obtained by winding a sheet of a stack in which the negative electrode 931 and the positive electrode 932 overlap with each other with the separator 933 therebetween. Note that a plurality of stacks each including the negative electrode 931, the positive electrode 932, and the separators 933 may be further stacked.

As illustrated in FIG. 20A to FIG. 20C, the lithium-ion battery 913 may include a wound body 950a. The wound body 950a illustrated in FIG. 20A includes the negative electrode 931, the positive electrode 932, and the separators 933. The negative electrode 931 includes a negative electrode active material layer 931a. The positive electrode 932 includes a positive electrode active material layer 932a.

The separator 933 has a larger width than the negative electrode active material layer 931a and the positive electrode active material layer 932a, and is wound to overlap with the negative electrode active material layer 931a and the positive electrode active material layer 932a. In terms of safety, the width of the negative electrode active material layer 931a is preferably larger than that of the positive electrode active material layer 932a. The wound body 950a having such a shape is preferable because of its high level of safety and high productivity.

As illustrated in FIG. 20B, the negative electrode 931 is electrically connected to the terminal 951. The terminal 951 is electrically connected to a terminal 911a. The positive electrode 932 is electrically connected to the terminal 952. The terminal 952 is electrically connected to a terminal 911b.

As illustrated in FIG. 20C, the wound body 950a is covered with the housing 930, whereby the lithium-ion battery 913 is completed. The housing 930 is preferably provided with a safety valve, an overcurrent protection element, and the like. In order to prevent the battery from exploding, the safety valve is a valve to be released when the internal pressure of the housing 930 reaches a predetermined pressure.

As illustrated in FIG. 20B, the lithium-ion battery 913 may include a plurality of wound bodies 950a. The use of the plurality of wound bodies 950a enables the lithium-ion battery 913 to have higher charge and discharge capacities. The description of the lithium-ion battery 913 illustrated in FIG. 19A to FIG. 19C can be referred to for the other components of the lithium-ion battery 913 illustrated in FIG. 20A and FIG. 20B.

With use of the electrolyte and the positive electrode active material of one embodiment of the present invention in the lithium-ion battery 913 including the wound body, excellent charge and discharge characteristics can be expected in a wide temperature range from temperatures below freezing to high temperatures.

The contents of this embodiment can be combined with the contents of the other embodiments as appropriate.

### Embodiment 6

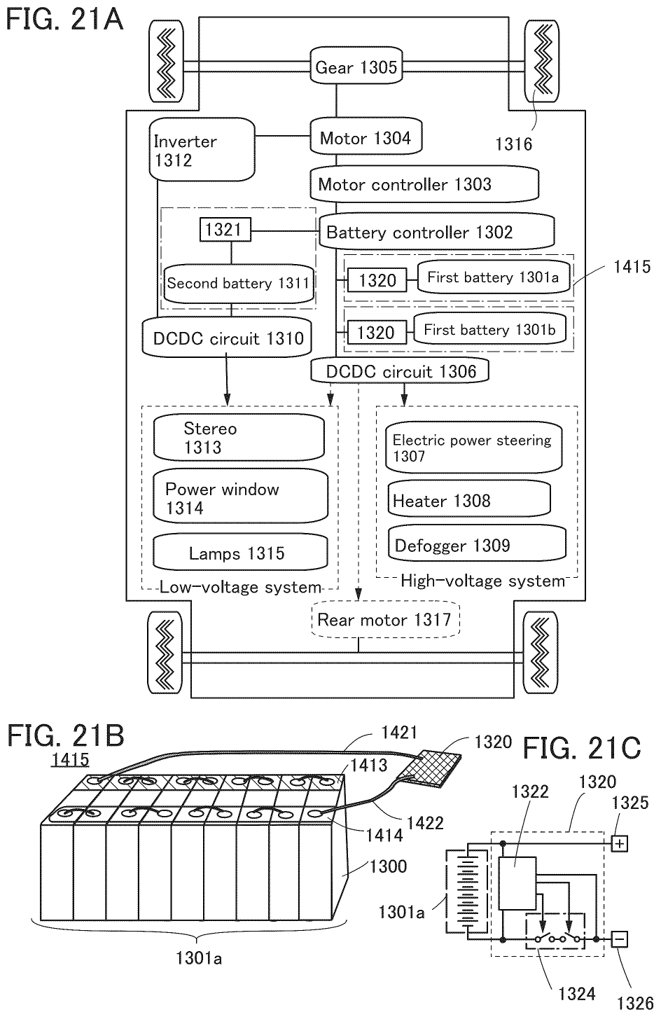

In this embodiment, an example of application to an electric vehicle (EV) will be described with reference to FIG. 21.

As illustrated in FIG. 21A, the electric vehicle is provided with first batteries 1301a and 1301b as main lithium-ion batteries for driving and a second battery 1311 that supplies electric power to an inverter 1312 for starting a motor 1304. With use of the electrolyte and the positive electrode active material of one embodiment of the present invention in the first batteries 1301a and 1301b, excellent charge and discharge characteristics can be expected in a wide temperature range from temperatures below freezing to high temperatures.

The second battery 1311 is also referred to as a cranking battery (also referred to as a starter battery). The second battery 1311 only needs high output and high capacity is not so much needed; the capacity of the second battery 1311 is lower than that of the first batteries 1301a and 1301b.

The internal structure of the first battery 1301a may be a wound structure or a stacked-layer structure. Alternatively, the first battery 1301a may be the all-solid-state battery in Embodiment 5. The use of the all-solid-state battery in Embodiment 5 as the first battery 1301a can achieve high capacity, improvement in safety, and reduction in size and weight.

Although this embodiment describes an example in which the two first batteries 1301a and 1301b are connected in parallel, three or more batteries may be connected in parallel. In the case where the first battery 1301a can store sufficient electric power, the first battery 1301b may be omitted. By constituting a battery pack including a plurality of lithium-ion batteries, large electric power can be extracted. The plurality of lithium-ion batteries may be connected in parallel, connected in series, or connected in series after being connected in parallel. The plurality of lithium-ion batteries are also referred to as an assembled battery.

In order to cut off electric power from the plurality of lithium-ion batteries, the lithium-ion batteries in the vehicle include a service plug or a circuit breaker that can cut off a high voltage without the use of equipment. The first battery 1301a is provided with such a service plug or a circuit breaker.

Electric power from the first batteries 1301a and 1301b is mainly used to rotate the motor 1304 and is supplied to in-vehicle parts for 42 V (such as an electric power steering 1307, a heater 1308, and a defogger 1309) through a DCDC circuit 1306. Even in the case where there is a rear motor 1317 for rear wheels, the first battery 1301a is used to rotate the rear motor 1317.

The second battery 1311 supplies electric power to in-vehicle parts for 14 V (such as a stereo 1313, a power window 1314, and lamps 1315) through a DCDC circuit 1310.

The first battery 1301a will be described with reference to FIG. 21B.

FIG. 21B illustrates an example in which nine rectangular lithium-ion batteries 1300 form one battery pack 1415. The nine rectangular lithium-ion batteries 1300 are connected in series; one electrode of each battery is fixed by a fixing portion 1413 made of an insulator, and the other electrode thereof is fixed by a fixing portion 1414 made of an insulator. Although this embodiment describes an example in which the lithium-ion batteries are fixed by the fixing portions 1413 and 1414, they may be stored in a battery container box (also referred to as a housing). Since a vibration or a jolt is assumed to be given to the vehicle from the outside (e.g., a road surface), the plurality of lithium-ion batteries are preferably fixed by the fixing portions 1413 and 1414 and a battery container box, for example. Furthermore, the one electrode is electrically connected to a control circuit portion 1320 through a wiring 1421. The other electrode is electrically connected to the control circuit portion 1320 through a wiring 1422.

The control circuit portion 1320 may include a memory circuit including a transistor using an oxide semiconductor. A charging control circuit or a battery control system that includes a memory circuit including a transistor using an oxide semiconductor is referred to as a BTOS (Battery operating system or Battery oxide semiconductor) in some cases.

A metal oxide functioning as an oxide semiconductor is preferably used. For example, as the oxide, a metal oxide such as an In-M-Zn oxide (an element M is one or more kinds selected from aluminum, gallium, yttrium, copper, vanadium, beryllium, boron, titanium, iron, nickel, germanium, zirconium, molybdenum, lanthanum, cerium, neodymium, hafnium, tantalum, tungsten, and magnesium) or the like is preferably used. In particular, the In-M-Zn oxide that can be used as the oxide is preferably a CAAC-OS (C-Axis Aligned Crystal Oxide Semiconductor) or a CAC-OS (Cloud-Aligned Composite Oxide Semiconductor). Alternatively, an In-Ga oxide or an In-Zn oxide may be used as the oxide. The CAAC-OS is an oxide semiconductor that has a plurality of crystal regions each of which has c-axis alignment in a particular direction. Note that the particular direction refers to the thickness direction of a CAAC-OS film, the normal direction of the surface where the CAAC-OS film is formed, or the normal direction of the surface of the CAAC-OS film. The crystal region refers to a region having a periodic atomic arrangement. Note that when an atomic arrangement is regarded as a lattice arrangement, the crystal region also refers to a region with a uniform lattice arrangement. The CAAC-OS has a region where a plurality of crystal regions are connected in the a-b plane direction, and the region has distortion in some cases. Note that distortion refers to a portion where the direction of a lattice arrangement changes between a region with a uniform lattice arrangement and another region with a uniform lattice arrangement in a region where a plurality of crystal regions are connected. That is, the CAAC-OS is an oxide semiconductor having c-axis alignment and having no clear alignment in the a-b plane direction. The CAC-OS refers to one composition of a material in which elements constituting a metal oxide are unevenly distributed with a size greater than or equal to 0.5 Nm and less than or equal to 10 nm, preferably greater than or equal to 1 nm and less than or equal to 3 nm, or a similar size, for example. Note that a state in which one or more metal elements are unevenly distributed and regions including the metal element(s) are mixed with a size greater than or equal to 0.5 Nm and less than or equal to 10 nm, preferably greater than or equal to 1 nm and less than or equal to 3 nm, or a similar size in a metal oxide is hereinafter referred to as a mosaic pattern or a patch-like pattern.

The control circuit portion 1320 preferably includes a transistor using an oxide semiconductor because it can be used in a low-temperature environment. For the process simplicity, the control circuit portion 1320 may be formed using transistors of the same conductivity type. A transistor using an oxide semiconductor in its semiconductor layer has an operating ambient temperature range of −40° C. to 150° C., which is wider than that of a single crystal Si transistor, and thus shows a smaller change in characteristics than the single crystal Si transistor when the lithium-ion battery is heated. The off-state current of the transistor using an oxide semiconductor is lower than or equal to the lower measurement limit even at 150° C. independently of the temperature; meanwhile, the off-state current characteristics of the single crystal Si transistor largely depend on the temperature. For example, at 150° C., the off-state current of the single crystal Si transistor increases, and a sufficiently high current on/off ratio cannot be obtained. The control circuit portion 1320 can improve the safety.

The control circuit portion 1320 that includes a memory circuit including a transistor using an oxide semiconductor can also function as an automatic control device for the lithium-ion battery to resolve ten items of causes of instability, such as a micro-short circuit. Examples of functions of resolving the ten items of causes of instability include prevention of overcharging, prevention of overcurrent, control of overheating during charging, cell balance of an assembled battery, prevention of overdischarging, a battery indicator, automatic control of charge voltage and current amount according to temperature, control of the amount of charge current according to the degree of deterioration, abnormal behavior detection for a micro-short circuit, and anomaly prediction regarding a micro-short circuit; the control circuit portion 1320 has at least one of these functions. Furthermore, the automatic control device for the lithium-ion battery can be extremely small in size.

A micro-short circuit refers to a minute short circuit caused in a lithium-ion battery. One of the causes of a micro-short circuit is as follows: charging and discharging performed a plurality of times cause an uneven distribution of positive electrode active materials, which leads to local concentration of current in part of the positive electrode and part of the negative electrode or generation of a by-product by a side reaction, which is thought to generate a micro short-circuit.

It can be said that the control circuit portion 1320 not only detects a micro-short circuit but also senses a terminal voltage of the lithium-ion battery and controls the charge and discharge state of the lithium-ion battery. For example, to prevent overcharging, an output transistor of a charge circuit and an interruption switch can be turned off substantially at the same time.

FIG. 21C illustrates an example of a block diagram of the battery pack 1415 illustrated in FIG. 21B.

The control circuit portion 1320 includes a switch portion 1324 that includes at least a switch for preventing overcharging and a switch for preventing overdischarging, a control circuit 1322 for controlling the switch portion 1324, and a portion for measuring the voltage of the first battery 1301a. The control circuit portion 1320 is set to have the upper limit voltage and the lower limit voltage of the lithium-ion battery to be used, and imposes the upper limit of current from the outside, the upper limit of output current to the outside, and the like. The range from the lower limit voltage to the upper limit voltage of the lithium-ion battery falls within the recommended voltage range; when a voltage falls outside the range, the switch portion 1324 operates and functions as a protection circuit. The control circuit portion 1320 can also be referred to as a protection circuit because it controls the switch portion 1324 to prevent overdischarging and overcharging. For example, when the control circuit 1322 detects a voltage that is likely to cause overcharging, current is interrupted by turning off the switch in the switch portion 1324. Furthermore, a function of interrupting current in accordance with a temperature rise may be set by providing a PTC element in the charge and discharge path. The control circuit 35 portion 1320 includes an external terminal 1325 (+IN) and an external terminal 1326 (−IN).

The switch portion 1324 can be formed by a combination of an n-channel transistor and a p-channel transistor. The switch portion 1324 is not limited to a switch including a Si transistor using single crystal silicon; the switch portion 1324 may be formed using, for example, a power transistor containing Ge (germanium), SiGe (silicon germanium), GaAs (gallium arsenide), GaAlAs (gallium aluminum arsenide), InP (indium phosphide), SiC (silicon carbide), ZnSe (zinc selenide), GaN (gallium nitride), GaO, (gallium oxide, where x is a real number greater than 0), or the like. A memory element using an OS transistor can be freely placed by being stacked over a circuit using a Si transistor, for example; hence, integration can be easy. The control circuit portion 1320 using an OS transistor can be stacked over the switch portion 1324 so that they can be integrated into one chip and can be reduced in size.

The first batteries 1301a and 1301b mainly supply electric power to in-vehicle parts for 42 V (for a high-voltage system), and the second battery 1311 supplies electric power to in-vehicle parts for 14 V (for a low-voltage system). Lead storage batteries are usually used for the second battery 1311 due to cost advantage. There is an advantage that the second battery 1311 can be maintenance-free when a lithium-ion battery is used; however, in the case of long-term use, for example three years or more, anomaly that cannot be determined at the time of manufacturing might occur. In particular, when the second battery 1311 that starts the inverter becomes inoperative, the motor cannot be started even when the first batteries 1301a and 1301b have remaining capacity; thus, in order to prevent this, in the case where the second battery 1311 is a lead storage battery, the second battery is supplied with electric power from the first battery to constantly maintain a fully-charged state.

Although this embodiment describes an example in which lithium-ion batteries are used as both the first battery 1301a and the second battery 1311, a lead storage battery, an all-solid-state battery, or an electric double layer capacitor may be used as the second battery 1311. With use of the electrolyte and the positive electrode active material of one embodiment of the present invention in the above-described lithium-ion batteries, excellent charge and discharge characteristics can be expected in a wide temperature range from temperatures below freezing to high temperatures.

Regenerative energy generated by rolling of tires 1316 is transmitted to the motor 1304 through a gear 1305, and is stored in the second battery 1311 from a motor controller 1303 and a battery controller 1302 through a control circuit portion 1321. Alternatively, the regenerative energy is stored in the first battery 1301a from the battery controller 1302 through the control circuit portion 1320. Alternatively, the regenerative energy is stored in the first battery 1301b from the battery controller 1302 through the control circuit portion 1320. For efficient charging with regenerative energy, the first batteries 1301a and 1301b are desirably capable of fast charging.

The battery controller 1302 can set the charge voltage, charge current, and the like of the first batteries 1301a and 1301b. The battery controller 1302 can set charge conditions in accordance with charge performance of a lithium-ion battery used, so that fast charging can be performed.

Although not illustrated, in the case of connection to an external charger, a plug of the charger or a connection cable of the charger is electrically connected to the battery controller 1302. Electric power supplied from the external charger is stored in the first batteries 1301a and 1301b through the battery controller 1302. Some chargers are provided with a control circuit, in which case the function of the battery controller 1302 is not used; to prevent overcharging, the first batteries 1301a and 1301b are preferably charged through the control circuit portion 1320. In addition, a connection cable or the connection cable of the charger is sometimes provided with a control circuit. The control circuit portion 1320 is also referred to as an ECU (Electronic Control Unit). The ECU is connected to a CAN (Controller Area Network) provided in the electric vehicle. The CAN is a type of a serial communication standard used as an in-vehicle LAN. The ECU includes a microcomputer. Moreover, the ECU uses a CPU or a GPU.

External chargers installed at charging stations and the like have a 100 V outlet, a 200 V outlet, and a three-phase 200 V outlet with 50 kW, for example. Furthermore, charging can be performed with electric power supplied from external charging equipment by a contactless power feeding method or the like.

Next, examples in which the lithium-ion battery of one embodiment of the present invention is mounted on a vehicle, typically a transport vehicle, will be described.

Mounting the lithium-ion battery on vehicles can achieve next-generation clean energy vehicles such as hybrid vehicles (HVs), electric vehicles (EVs), and plug-in hybrid vehicles (PHVs). The lithium-ion battery can also be mounted on transport vehicles such as agricultural machines, motorized bicycles including motor-assisted bicycles, motorcycles, electric wheelchairs, electric carts, boats and ships, submarines, aircraft such as fixed-wing aircraft and rotary-wing aircraft, rockets, artificial satellites, space probes, planetary probes, and spacecraft.

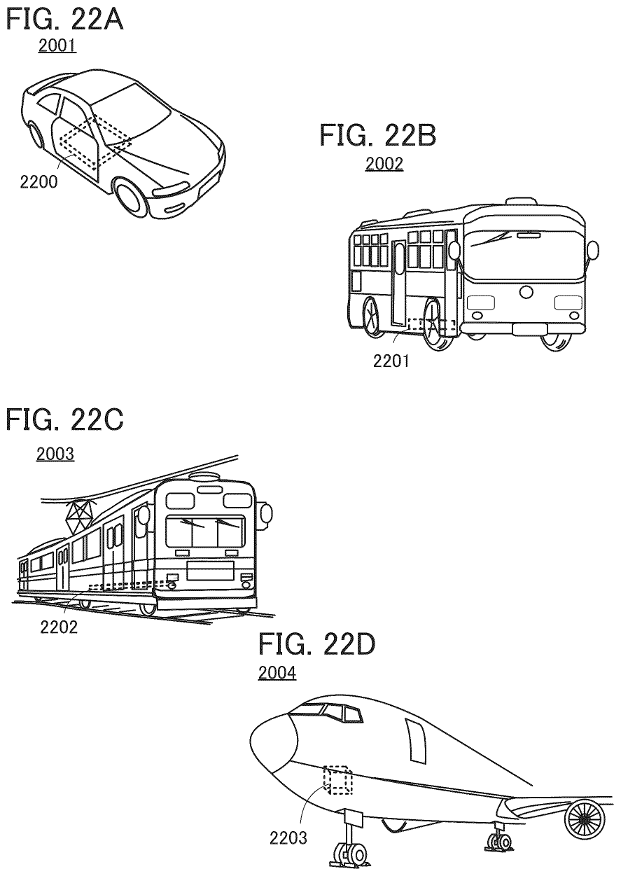

FIG. 22A to FIG. 22D illustrate examples of transport vehicles using one embodiment of the present invention. An automobile 2001 illustrated in FIG. 22A is an electric vehicle that runs using an electric motor as a driving power source. Alternatively, the automobile 2001 is a hybrid vehicle that enables appropriate selection of an electric motor or an engine as a driving power source. In the case where the lithium-ion battery is mounted on the vehicle, an example of the lithium-ion battery described in the above embodiment is provided at one position or several positions. With use of the electrolyte and the positive electrode active material of one embodiment of the present invention in the lithium-ion battery mounted on the vehicle, excellent charge and discharge characteristics can be expected in a wide temperature range from temperatures below freezing to high temperatures.

The automobile 2001 illustrated in FIG. 22A includes a battery pack 2200, and the battery pack includes a battery module in which a plurality of lithium-ion batteries are connected to each other. The battery pack 2200 preferably further includes a charge control device that is electrically connected to the battery module.

The automobile 2001 can be charged when the lithium-ion battery included in the automobile 2001 is supplied with electric power from external charge equipment by a plug-in system, a contactless charge system, or the like. In charging, a given method such as CHAdeMO (registered trademark) or Combined Charging System may be employed as a charge method, the standard of a connector, and the like as appropriate. The lithium-ion battery may be a charge station provided in a commerce facility or a household power supply. For example, with the use of the plug-in system, the power storage device mounted on the automobile 2001 can be charged by being supplied with electric power from the outside. Charging can be performed by converting AC power into DC power through a converter such as an ACDC converter.

Although not illustrated, the vehicle may be provided with a power receiving device so that it can be charged by being supplied with electric power from an above-ground power transmitting device in a contactless manner. In the case of the contactless power feeding system, by fitting a power transmitting device in a road or an exterior wall, charging can be performed not only when the vehicle is stopped but also when moving. In addition, the contactless power feeding system may be utilized to perform transmission and reception of electric power between two vehicles. Furthermore, a solar cell may be provided in the exterior of the vehicle to charge the lithium-ion battery while the vehicle is stopped or while the vehicle is moving. To supply power in such a contactless manner, an electromagnetic induction method or a magnetic resonance method can be used.

FIG. 22B illustrates a large transporter 2002 having a motor controlled by electricity, as an example of a transport vehicle. A battery module of the transporter 2002 has a cell unit of four lithium-ion batteries with a nominal voltage of 3.0 V or higher and 5.0 V or lower, and 48 cells are connected in series to have 170 V as the maximum voltage, for example. A battery pack 2201 has the same function as that in FIG. 21B except, for example, the number of lithium-ion batteries; thus, the description is omitted. With use of the electrolyte and the positive electrode active material of one embodiment of the present invention in the lithium-ion batteries in the battery pack 2201, excellent charge and discharge characteristics can be expected in a wide temperature range from temperatures below freezing to high temperatures.

FIG. 22C illustrates a large transport vehicle 2003 having a motor controlled by electricity as an example. A battery module of the transport vehicle 2003 has 100 or more lithium-ion batteries with a nominal voltage of 3.0 V or higher and 5.0 V or lower connected in series to have a maximum voltage of 600 V. A battery pack 2202 has the same function as that in FIG. 22B except, for example, the number of lithium-ion batteries configuring the battery module; thus, the description is omitted. With use of the electrolyte and the positive electrode active material of one embodiment of the present invention in the lithium-ion batteries included in the module, excellent charge and discharge characteristics can be expected in a wide temperature range from temperatures below freezing to high temperatures.

FIG. 22D illustrates an aircraft 2004 having a combustion engine as an example. The aircraft 2004 illustrated in FIG. 22D can also be regarded as a kind of transport vehicle because it has wheels for takeoff and landing, and includes a battery pack 2203 that includes a charge control device and a battery module configured by connecting a plurality of lithium-ion batteries.

The battery module of the aircraft 2004 has eight 4 V lithium-ion batteries connected in series, which has a maximum voltage of 32 V, for example. The battery pack 2203 has the same function as that in FIG. 21B except, for example, the number of lithium-ion batteries configuring the battery module; thus, the description is omitted.

The contents of this embodiment can be combined with the contents of the other embodiments as appropriate.

### Embodiment 7

In this embodiment, examples in which a vehicle such as a motorcycle or a bicycle is provided with the lithium-ion battery of one embodiment of the present invention will be described.

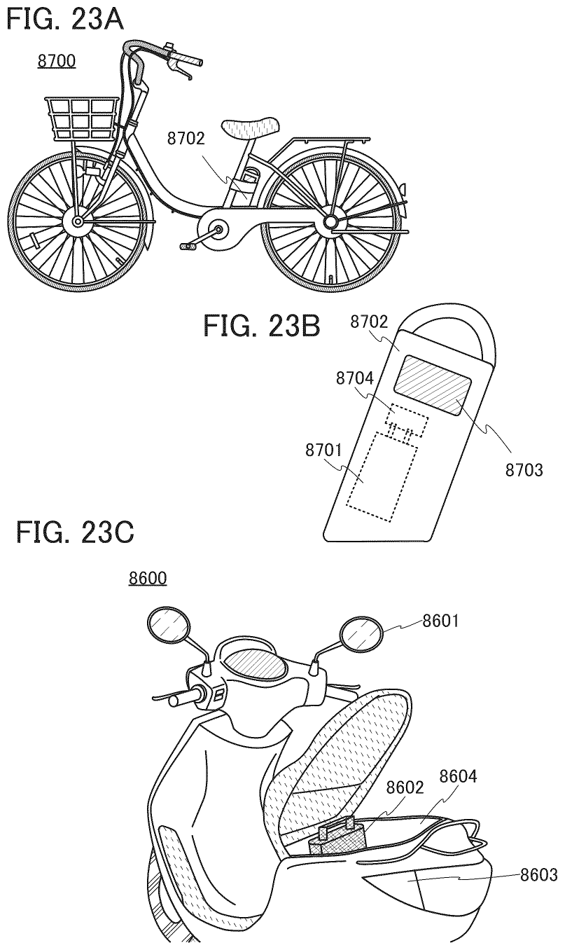

FIG. 23A illustrates an example of an electric bicycle using the lithium-ion battery of one embodiment of the present invention. The lithium-ion battery of one embodiment of the present invention can be used for an electric bicycle 8700 illustrated in FIG. 23A. The lithium-ion battery of one embodiment of the present invention may include a protection circuit.

The electric bicycle 8700 includes a power storage device 8702. The power storage device 8702 can supply electricity to a motor that assists a rider. The power storage device 8702 is portable, and FIG. 23B illustrates the state where the power storage device 8702 is detached from the bicycle. A plurality of lithium-ion batteries 8701 of one embodiment of the present invention are incorporated in the power storage device 8702, and the remaining battery capacity and the like can be displayed on a display portion 8703. With use of the electrolyte and the positive electrode active material of one embodiment of the present invention in the lithium-ion batteries 8701, excellent charge and discharge characteristics can be expected in a wide temperature range from temperatures below freezing to high temperatures.

The power storage device 8702 includes a control circuit 8704 capable of charge control or anomaly detection for the lithium-ion battery, which is exemplified in Embodiment 7. The control circuit 8704 is electrically connected to a positive electrode and a negative electrode of the lithium-ion battery 8701. The control circuit 8704 can contribute greatly to elimination of accidents due to lithium-ion batteries, such as fires.

FIG. 23C illustrates an example of a motorcycle including the lithium-ion battery of one embodiment of the present invention. A motor scooter 8600 illustrated in FIG. 23C includes a power storage device 8602, side mirrors 8601, and indicator lights 8603. The power storage device 8602 can supply electricity to the indicator lights 8603. With use of the electrolyte and the positive electrode active material of one embodiment of the present invention in the lithium-ion battery, excellent charge and discharge characteristics can be expected in a wide temperature range from temperatures below freezing to high temperatures.

In the motor scooter 8600 illustrated in FIG. 23C, the power storage device 8602 can be stored in an under-seat storage unit 8604. The power storage device 8602 can be stored in the under-seat storage unit 8604 even when the under-seat storage unit 8604 is small.

The contents of this embodiment can be combined with the contents in the other embodiments as appropriate.

### Embodiment 8

In this embodiment, examples of electronic devices each including the lithium-ion battery of one embodiment of the present invention will be described. Examples of electronic devices including the lithium-ion battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

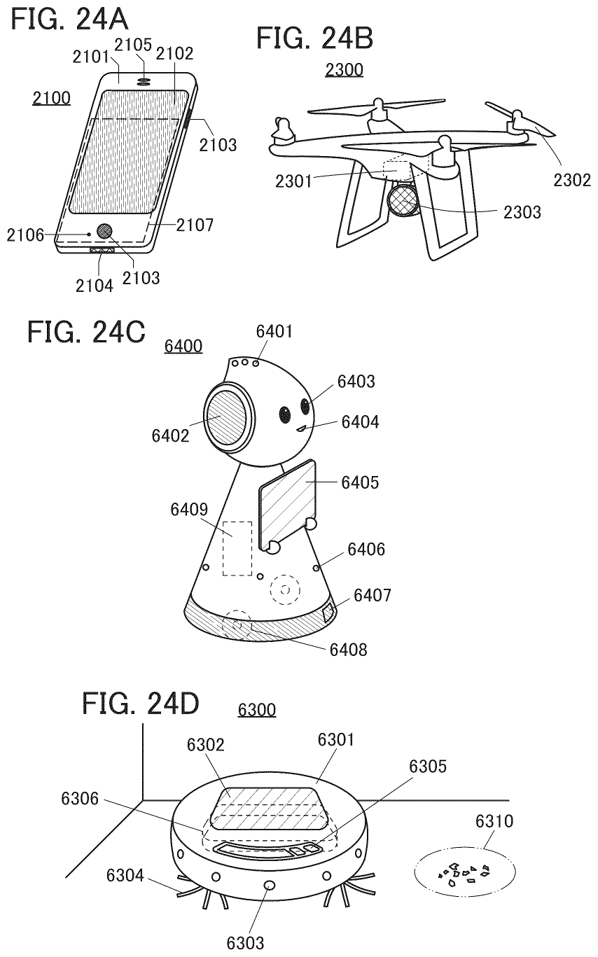

FIG. 24A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a lithium-ion battery 2107. With use of the electrolyte and the positive electrode active material of one embodiment of the present invention in the lithium-ion battery, excellent charge and discharge characteristics can be expected in a wide temperature range from temperatures below freezing to high temperatures.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication between the mobile phone 2100 and a headset capable of wireless communication enables hands-free calling.

The mobile phone 2100 includes the external connection port 2104, and can perform direct data transmission and reception with another information terminal via a connector. In addition, charging can be performed via the external connection port 2104. Note that the charging operation may be performed by wireless power feeding without using the external connection port 2104.

The mobile phone 2100 preferably includes a sensor. As the sensor, a human body sensor such as a fingerprint sensor, a pulse sensor, or a temperature sensor, a touch sensor, a pressure sensitive sensor, or an acceleration sensor is preferably mounted, for example.

FIG. 24B illustrates an unmanned aircraft 2300 including a plurality of rotors 2302. The unmanned aircraft 2300 is sometimes also referred to as a drone. The unmanned aircraft 2300 includes a lithium-ion battery 2301 of one embodiment of the present invention, a camera 2303, and an antenna (not illustrated). The unmanned aircraft 2300 can be remotely controlled through the antenna. With use of the electrolyte and the positive electrode active material of one embodiment of the present invention in the lithium-ion battery, excellent charge and discharge characteristics can be expected in a wide temperature range from temperatures below freezing to high temperatures.

FIG. 24C illustrates an example of a robot. A robot 6400 illustrated in FIG. 24C includes a lithium-ion battery 6409, an illuminance sensor 6401, a microphone 6402, an upper camera 6403, a speaker 6404, a display portion 6405, a lower camera 6406, an obstacle sensor 6407, a moving mechanism 6408, an arithmetic device, and the like.

The microphone 6402 has a function of detecting a speaking voice of a user, an environmental sound, and the like. The speaker 6404 has a function of outputting sound. The robot 6400 can communicate with the user using the microphone 6402 and the speaker 6404.

The display portion 6405 has a function of displaying various kinds of information. The robot 6400 can display information desired by the user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect the presence of an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 further includes, in its inner region, the lithium-ion battery 6409 of one embodiment of the present invention and a semiconductor device or an electronic component. With use of the electrolyte and the positive electrode active material of one embodiment of the present invention in the lithium-ion battery, excellent charge and discharge characteristics can be expected in a wide temperature range from temperatures below freezing to high temperatures.

FIG. 24D illustrates an example of a cleaning robot. A cleaning robot 6300 includes a display portion 6302 placed on atop surface of a housing 6301, a plurality of cameras 6303 placed on a side surface of the housing 6301, a brush 6304, operation buttons 6305, a lithium-ion battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on a bottom surface.

For example, the cleaning robot 6300 can determine whether there is an obstacle such as a wall, furniture, or a step by analyzing images taken by the cameras 6303. In the case where the cleaning robot 6300 detects an object, such as a wire, that is likely to be caught in the brush 6304 by image analysis, the rotation of the brush 6304 can be stopped. The cleaning robot 6300 includes, in its inner region, the lithium-ion battery 6306 according to one embodiment of the present invention and a semiconductor device or an electronic component. With use of the electrolyte and the positive electrode active material of one embodiment of the present invention in the lithium-ion battery, excellent charge and discharge characteristics can be expected in a wide temperature range from temperatures below freezing to high temperatures.

This embodiment can be implemented in appropriate combination with the other embodiments.

### Embodiment 9

In this embodiment, examples of devices for space each including the lithium-ion battery of one embodiment of the present invention will be described.

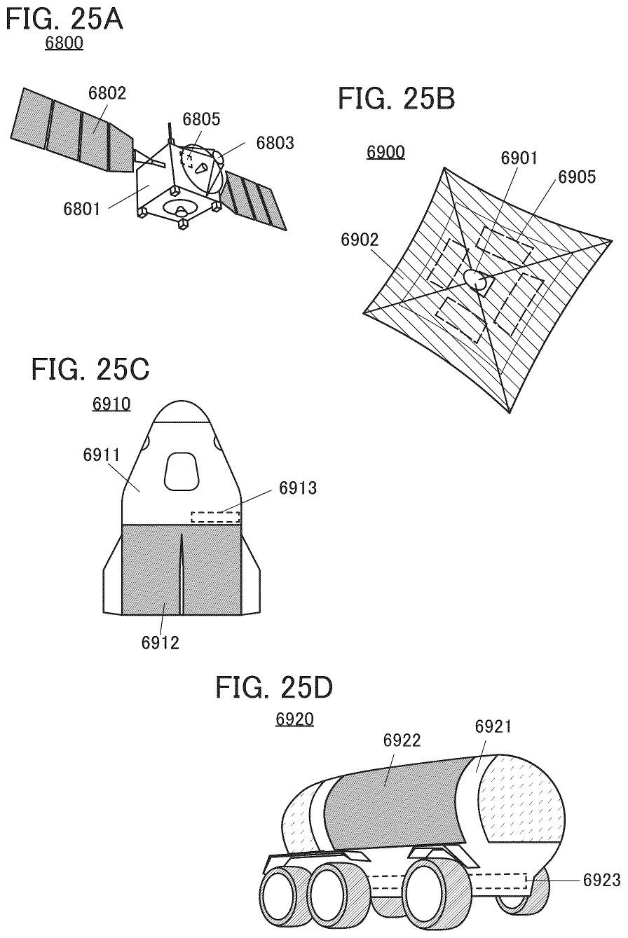

FIG. 25A illustrates an artificial satellite 6800 as an example of a device for space. The artificial satellite 6800 includes a body 6801, a solar panel 6802, an antenna 6803, and a lithium-ion battery 6805. A solar panel is referred to as a solar cell module in some cases.

When the solar panel 6802 is irradiated with sunlight, electric power required for the operation of the artificial satellite 6800 is generated. However, for example, in the situation where the solar panel is not irradiated with sunlight or the amount of sunlight with which the solar panel is irradiated is small, the amount of generated electric power is small. Accordingly, a sufficient amount of electric power required for the operation of the artificial satellite 6800 might not be generated. In order to operate the artificial satellite 6800 even with a small amount of generated electric power, the artificial satellite 6800 is preferably provided with the lithium-ion battery 6805. With use of the electrolyte and the positive electrode active material of one embodiment of the present invention in the lithium-ion battery, excellent charge and discharge characteristics can be expected in a wide temperature range from temperatures below freezing to high temperatures.

The artificial satellite 6800 can generate a signal. The signal is transmitted through the antenna 6803, and the signal can be received by a ground-based receiver or another artificial satellite, for example. When the signal transmitted by the artificial satellite 6800 is received, the position of a receiver that receives the signal can be measured, for example. Thus, the artificial satellite 6800 can construct a satellite positioning system, for example.

Alternatively, the artificial satellite 6800 can include a sensor. For example, with a structure including a visible light sensor, the artificial satellite 6800 can have a function of sensing sunlight reflected by a ground-based object. Alternatively, with a structure including a thermal infrared sensor, the artificial satellite 6800 can have a function of sensing thermal infrared rays emitted from the surface of the earth. Thus, the artificial satellite 6800 can function as an earth observing satellite, for example.

FIG. 25B illustrates a probe 6900 including a solar sail as an example of a device for space. The probe 6900 includes a body 6901, a solar sail 6902, and a lithium-ion battery 6905. With use of the electrolyte and the positive electrode active material of one embodiment of the present invention in the lithium-ion battery, excellent charge and discharge characteristics can be expected in a wide temperature range from temperatures below freezing to high temperatures. When photons from the sun are incident on the surface of the solar sail 6902, the momentum is transmitted to the solar sail 6902. Hence, the surface of the solar sail 6902 preferably has a thin film with high reflectance and further preferably faces in the direction of the sun.

The solar sail 6902 may be designed to fold compact before reaching the outer atmosphere and to be unfurled to have a large sheet-like shape as illustrated in FIG. 25B in the expanse beyond the earth's atmosphere (outer space).

FIG. 25C illustrates a spacecraft 6910 as an example of a device for space. The spacecraft 6910 includes a body 6911, a solar panel 6912, and a lithium-ion battery 6913. With use of the electrolyte and the positive electrode active material of one embodiment of the present invention in the lithium-ion battery, excellent charge and discharge characteristics can be expected in a wide temperature range from temperatures below freezing to high temperatures. The body 6911 can include a pressurized cabin and an unpressurized cabin, for example. The pressurized cabin may be designed so that the crew can get into the cabin. Electric power that is generated by irradiation of the solar panel 6912 with sunlight can be stored in the lithium-ion battery 6913.

FIG. 25D illustrates a rover 6920 as an example of a device for space. The rover 6920 includes a body 6921 and a lithium-ion battery 6923. With use of the electrolyte and the positive electrode active material of one embodiment of the present invention in the lithium-ion battery, excellent charge and discharge characteristics can be expected in a wide temperature range from temperatures below freezing to high temperatures. The rover 6920 may include a solar panel 6922.

The rover 6920 may be designed so that the crew can get into the rover. Electric power that is generated by irradiation of the solar panel 6912 with sunlight may be stored in the lithium-ion battery 6923, or electric power generated by another power source such as a fuel cell or a radioisotope thermoelectric generator, for example, may be stored in the lithium-ion battery 6923.

The contents of this embodiment can be combined with the contents in the other embodiments as appropriate.

### Example 1

### <NMR Measurement>

In this example, measurement by nuclear magnetic resonance spectroscopy (¹H NMR) was performed on FEC, MTFP, and a mixed solution A obtained by adding 1 mol/L of LiPF₆ as a lithium salt to a mixture of FEC:MTFP=2:8 (volume ratio) of one embodiment of the present invention. Results thereof are sequentially described.

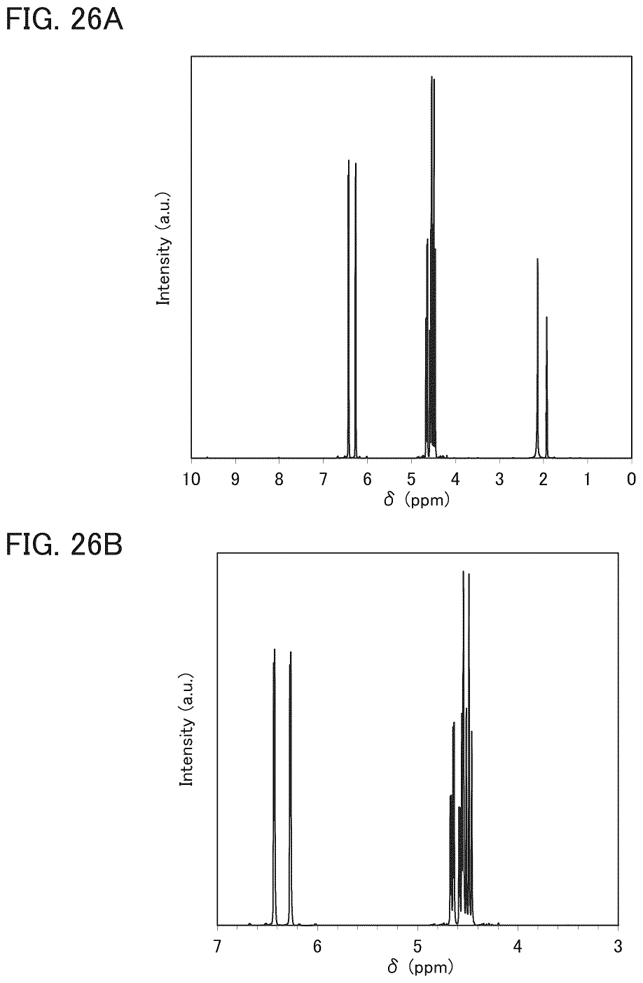

FEC was mixed into a deuterated acetonitrile solution, which was measured by nuclear magnetic resonance spectroscopy (¹H-NMR). FIG. 26A and FIG. 26B show charts of measurement results. Note that the range of δ=0-10 ppm is shown in FIG. 26A, and an enlarged view of the range of δ=3-7 ppm is shown in FIG. 26B. The peak position of FEC can be read from FIG. 26A and FIG. 26B. For example, FEC can be read to have a peak also at higher than or equal to 3 ppm and lower than or equal to 7 ppm when analyzed by ¹H-NMR.

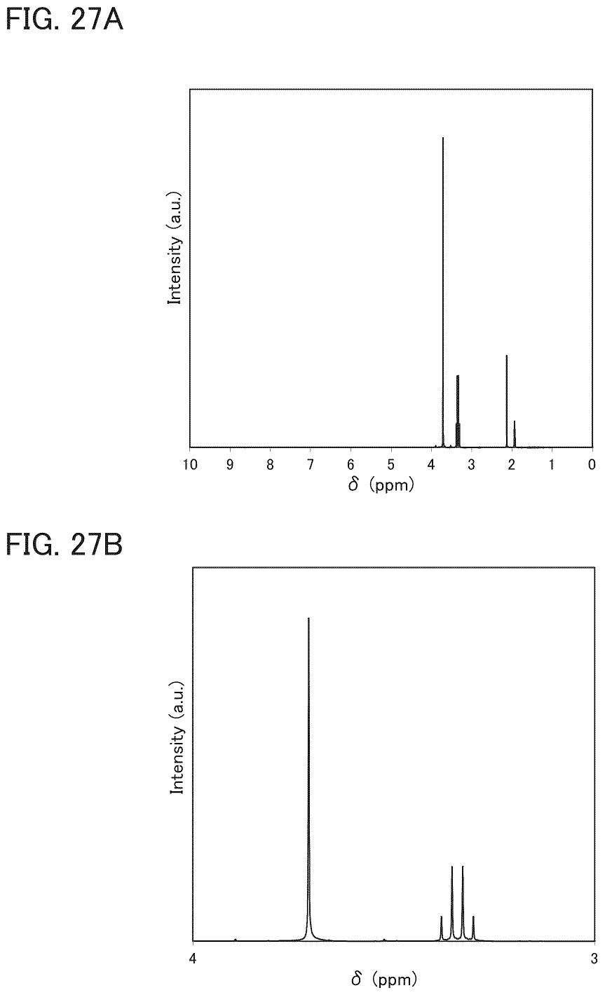

Next, MTFP was mixed into a deuterated acetonitrile solution, which was measured by ¹H-NMR. FIG. 27A and FIG. 27B show charts of measurement results. Note that the range of δ=0-10 ppm is shown in FIG. 27A, and an enlarged view of the range of δ=3-4 ppm is shown in FIG. 27B. The peak position of MTFP can be read from FIG. 27A and FIG. 27B. For example, MTFP can be read to have a peak at higher than or equal to 3 ppm and lower than or equal to 4 ppm when analyzed by ¹H-NMR.

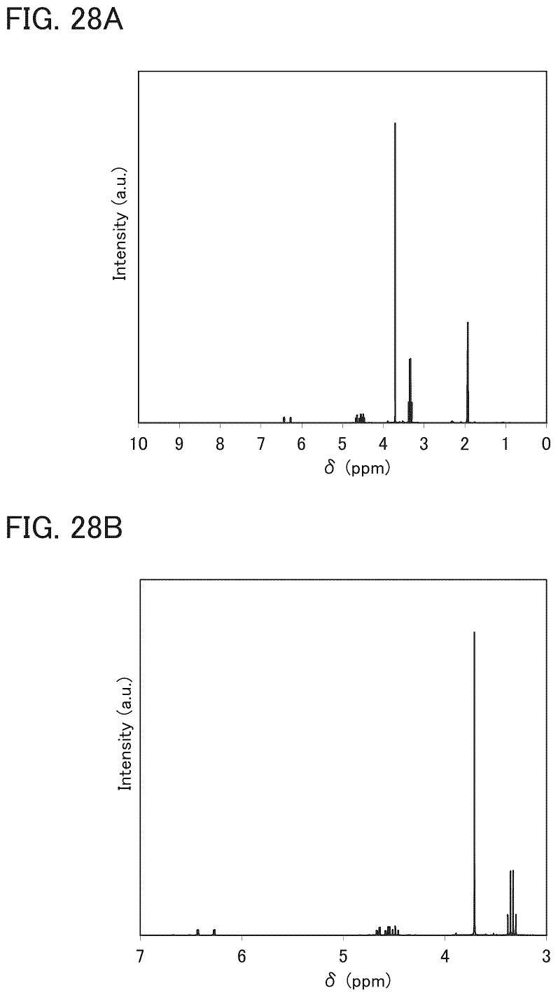

Next, the mixed solution A obtained by adding LiPF₆ as the lithium salt at a concentration of 1 mol/L to the mixture of FEC:MTFP=2:8 (volume ratio) of one embodiment of the present invention was mixed into a deuterated acetonitrile solution, which was measured by ¹H-NMR. FIG. 28A and FIG. 28B show charts of measurement results. Note that the range of δ=0-10 ppm is shown in FIG. 28A, and an enlarged view of the range of δ=3-7 ppm is shown in FIG. 28B. The peak position of the mixed solution can be read from FIG. 28A and FIG. 28B. For example, the mixed solution A can be read to have a peak at higher than or equal to 3 ppm and lower than or equal to 4 ppm and a peak at higher than or equal to 4 ppm and lower than or equal to 7 ppm when analyzed by ¹H-NMR.

In FIG. 28B, which is the enlarged view, both the peak corresponding to FEC observed in FIG. 26B and the peak corresponding to MTFP observed in FIG. 27B can be observed. This probably suggests that FEC and MTFP are not bonded and FEC, which solvates the lithium salt, and MTFP coexist in the mixed solution. MTFP may be regarded as being mixed to maintain an appropriate viscosity. In addition, MTFP may solvate the lithium salt.

According to this example, NMR of FEC, MTFP, and the mixed solution A obtained by adding LiPF₆ as a lithium salt at the concentration of 1 mol/L to the mixture of FEC:MTFP=2:8 (volume ratio) of one embodiment of the present invention can be observed.

### Example 2

### <HOMO Level and Solvation Energy>

In this example, a HOMO level and a solvation energy were obtained by calculation. Note that the solvation energy refers to an energy for an organic solvent used in an electrolyte to bond with lithium ions by the Coulomb force or the like. Such bonding is also called coordination. In this example, the HOMO levels and solvation energies of FEC and MTFP, which include a substituent with an electron-withdrawing property, and EC and MP as organic compounds that do not include a substituent with an electron-withdrawing property were calculated to make a comparison. Note that the solvation energies here were each calculated as an energy at which the organic solvent used in the electrolyte is stabilized with four molecules thereof coordinated to one Li ion.

The HOMO levels and the solvation energies were calculated using density functional theory (DFT). In the DFT, the total energy is represented as the sum of potential energy, electrostatic energy between electrons, electronic kinetic energy, and exchange-correlation energy including all the complicated interactions between electrons. Also in the DFT, an exchange-correlation interaction is approximated by a functional (a function of another function) of one electron potential represented in terms of electron density to enable high-speed and high-accuracy calculations. Here, B3LYP, which is a hybrid functional, is used to specify the weight of each parameter related to exchange-correlation energy. In addition, as a basis function, 6-311G (a basis function of a triple-split valence basis set using three contraction functions for each valence orbital) is applied to all the atoms. By the above basis function, for example, is to 3s orbitals are considered in the case of hydrogen atoms, while is to 4s and 2p to 4p orbitals are considered in the case of carbon atoms. Furthermore, to improve calculation accuracy, the p function and the d function as polarization basis sets are added to hydrogen atoms and atoms other than hydrogen atoms, respectively. The table below summarizes the calculation conditions.

TABLE 1

| | |
|---|---|
| Calculation software | Gaussian16 |
| Functional | B3LYP |
| Basis function | 6-311G(d, p) |

The calculation results of the HOMO levels and the solvation energies are shown in a table below, and actual measured melting points are also shown in the table below. In the table below, the solvation energies of MTFP and MP, which are chain-shaped organic compounds, are expressed as ranges because their solvation energies change by the influence of rotating coordinates.

TABLE 2

| Name of organic compound | | | | |
|---|---|---|---|---|
| (abbreviation) | FEC | MTFP | EC | MP |
| Structual formula | 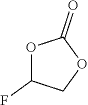 | 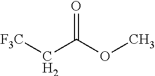 | 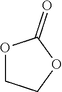 | 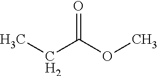 |
| HOMO level [eV] | −8.71 | −8.15 | −8.23 | −7.56 |
| Solvation energy [eV] | 5.39 | 4.33 to 5.38 | 5.79 | 4.45 to 5.22 |
| Actual measured melting | 17 | Unknown | 38 | −87.5 |
| point [° C.] | | | | |

A difference in HOMO level is observed between the organic compounds that include a substituent with an electron-withdrawing property and the organic compounds that do not include such a substituent. Specifically, the HOMO level of FEC including the substituent is deeper than that of EC not including the substituent. In addition, the HOMO level of MTFP including the substituent is deeper than that of MP not including the substituent. An organic compound with a deep HOMO can be considered to be less likely to be oxidized, and an organic solvent using such an organic compound can be considered to have improved oxidation resistance. Thus, a lithium-ion battery using the above organic solvent in an electrolyte can be expected to have improved cycle performance.

A difference in solvation energy is also observed between the organic compounds that include a substituent with an electron-withdrawing property and the organic compounds that do not include such a substituent. Specifically, the solvation energy of FEC including the substituent is lower than that of EC not including the substituent. It is also suggested that the solvation energy of MTFP including the substituent tends to be lower than that of MP not including the substituent. A low solvation energy leads to a low resistance between an electrolyte including the organic solvent and a positive electrode or between the electrolyte and a negative electrode. Thus, a lithium-ion battery using the above organic solvent in an electrolyte can be expected to have improved battery characteristics even when placed in a wide temperature range, especially at temperatures below freezing.

Although the melting point of MTFP is unknown, MTFP can be considered to maintain an appropriate viscosity even when exposed to a temperature below freezing, considering that the melting point of MP is −87.5° C. Thus, it can be considered that an electrolyte that maintains an appropriate viscosity even at a temperature below freezing can be provided by using the mixed solution of MTFP and FEC as an organic solvent. Note that the proportions of FEC and MTFP (specifically, the volume ratio) are described above in Embodiment 1.

When an organic compound that includes a substituent with an electron-withdrawing property is used as an organic solvent, a lithium-ion battery can be used in a wide temperature range, and furthermore, the lithium-ion battery can be expected to have improved battery characteristics when placed at a temperature below freezing.

### Example 3

In this example, Sample 1, Sample 2, and Reference Example 1 were prepared to measure AC impedance and evaluate charge and discharge characteristics. The fabrication conditions of the samples and the like are described here.

<Fabrication conditions of Sample 1>

As an electrolyte of Sample 1, an organic solvent mixed to satisfy FEC:MTFP=2:8 (volume ratio) was prepared, and lithium hexafluorophosphate (LiPF₆) was added as a lithium salt at 1 mol/L to the organic solvent. A solvent containing two or more organic solvents is referred to as a mixed solvent in some cases. Note that no additive agent was used for Sample 1.

As a positive electrode active material of Sample 1, LCO formed by the solid phase method described above in Embodiment 2 was used. A method for fabricating the LCO is described here. First, Step S11 to Step S13 in FIG. 2A were omitted, and as LiMO₂ in Step S14, lithium cobalt oxide (produced by Nippon Chemical Industrial Co., Ltd., product name; C-10N, hereinafter referred to as C-10N”) was prepared. The median diameter (D50) of C-10N is approximately 12.0 μm. In Step S15, the lithium cobalt oxide was heated at 850° C. for 2 hours in a furnace to which oxygen had been introduced. During the heating, oxygen was not supplied to the furnace. Next, as the A1 source in Step S20_1, LiF and MgF₂ were weighed so as to satisfy LiF:MgF₂=1:3 (molar ratio) and so as to be 1 atomic % with respect to lithium cobalt oxide as in Step S21_1 in FIG. 2B, and LiF and MgF₂ were mixed while being ground in dehydrated acetone as in Step S22_1 to give a mixture A1, i.e., the A1 source. After that, as in Step S31 in FIG. 2A, lithium cobalt oxide subjected to the heat treatment in Step S15 and the mixture A1 were mixed to give the mixture 903 as in Step S32, and the mixture 903 was heated at 900° C. for 20 hours in a furnace to which oxygen had been introduced as in Step S33. During the heating, oxygen was not supplied to the furnace. Next, the A2 source in Step S20_2 was prepared. Ni(OH)₂ and Al(OH)₃ shown in Step S21_2 in FIG. 2C were each weighed so as to be 0.5 mol % with respect to lithium cobalt oxide, and were mixed while being ground in dehydrated acetone as in Step S22_2 to give a mixture A2, i.e., the A2 source. Then, the mixture 903 and the mixture A2 were mixed as in Step S34 in FIG. 2A to give the mixture 904 as in Step S35. Next, as in Step S36, the mixture 904 was heated at 850° C. for 10 hours in a furnace to which oxygen had been introduced. During the heating, oxygen was not supplied to the furnace. In this manner, the positive electrode active material of Sample 1 was obtained.

The positive electrode active material of Sample 1 is LCO containing Mg, F, Ni, and Al, and the positive electrode active material has a smaller change than conventional LCO in the crystal structure between a discharged state with x in LiₓCoO₂ described above being 1 and a state with x=0.2 or a state with x=0.15, which corresponds to a state with x being less than or equal to 0.24.

For a positive electrode of Sample 1, the above-described positive electrode active material, acetylene black (AB) as a conductive additive, and polyvinylidene fluoride (PVDF) as a binder were prepared. PVDF was prepared in a state of being dissolved in N-methyl-2-pyrrolidone (NMP), a solvent, at a weight ratio of 5%. Next, a slurry compounded at the positive electrode active material:AB:PVDF=95:3:2 (weight ratio) was fabricated, and the slurry was applied to a positive electrode current collector of aluminum. After that, pressing was performed under a linear pressure of 210 kN/m at 120° C.

As a separator of Sample 1, PP or PI was used. Sample 1 is referred to as “Sample 1_P” and “Sample 1_I” to make a distinction depending on the separator material.

A coin cell (CR2032 type with a diameter of 20 mm and a height of 3.2 mm) was assembled using Sample 1 as a positive electrode. Lithium metal was used as a counter electrode of the coin cell. Stainless steel (SUS) was used as each of a positive electrode can and a negative electrode can of the coin cell. Such a coin cell is referred to as a half cell or a test battery in some cases.

### Fabrication Conditions of Reference Example 1

As an electrolyte of Reference Example 1, an organic solvent mixed to satisfy EC:DEC=3:7 (volume ratio) was prepared, and LiPF₆ was mixed as a lithium salt at a concentration of 1 mol/L with the organic solvent to give a mixed solution. A mixture of an additive agent VC at 2 wt % with the mixed solution was used. Reference Example 1 is similar to Sample 1 except for the above-described electrolyte.

### <Fabrication Conditions of Sample 2>

As an electrolyte of Sample 2, an organic solvent mixed to satisfy FEC:MTFP=2:8 (volume ratio) was used, and a mixture of LiPF₆ at a concentration of 1 mol/L with the organic solvent was used as in Sample 1. Note that as in the case of Sample 1, no additive agent was used for Sample 2.

Sample 2 is different from Sample 1 in the positive electrode active material. Although LCO obtained by the solid phase method described above in Embodiment 2 was used as a positive electrode active material of Sample 2, Sample 2 is different from Sample 1 in that lithium cobalt oxide (produced by Nippon Chemical Industrial Co., Ltd., product name: C-5H, hereinafter referred to as “C-5H”) was prepared as LiMO₂ in Step S14 for Sample 2. C-5H has a median diameter (D50) of approximately 7.0 μm. For Sample 2, Step S15 and the subsequent steps were performed as in the case of Sample 1. As different heating conditions in Step S33 from those for Sample 1, the mixture 903 was heated at 850° C. for 10 hours in a furnace to which oxygen had been introduced. The heating time of Sample 2 was shorter than that of Sample 1 because of the smaller median diameter (D50) of Sample 2. In addition, the heating time of Sample 2 in Step S36 was also shorter than that of Sample 1. Except for the above, Step S20_2 and the subsequent steps were performed for Sample 2 as in the case of Sample 1. In this manner, the positive electrode active material of Sample 2 was obtained.

The positive electrode active material of Sample 2 is LCO containing Mg, F, Ni, and Al, and the positive electrode active material has a smaller change than conventional LCO in the crystal structure between a discharged state with x in LiₓCoO₂ described above being 1 and a state with x=0.2 or a state with x=0.15, which corresponds to a state with x being less than or equal to 0.24.

For a positive electrode of Sample 2, the above-described positive electrode active material, acetylene black (AB) as a conductive additive, and polyvinylidene fluoride (PVDF) as a binder were prepared. PVDF was prepared in a state of being dissolved in N-methyl-2-pyrrolidone (NMP), a solvent, at a weight ratio of 5%. Next, a slurry compounded at the positive electrode active material:AB:PVDF=95:3:2 (weight ratio) was fabricated, and the slurry was applied to a positive electrode current collector of aluminum.

As in the case of Sample 1, PP or PI was prepared as a separator of Sample 2. Sample 2 is referred to as “Sample 2_P” and “Sample 2_I” to make a distinction depending on the separator material.

Then, as in the case of Sample 1, a coin cell (CR2032 type with a diameter of 2θ mm and a height of 3.2 mm) was assembled using Sample 2 as a positive electrode and lithium metal as a counter electrode. Stainless steel (SUS) was used as each of a positive electrode can and a negative electrode can of the coin cell. Such a coin cell is referred to as a half cell or a test battery in some cases.

The table below shows the main conditions of Sample 1_P, Sample 1I, Reference Example 1, Sample 2_P, and Sample 2_I. The description of measurement of each sample is also shown.

TABLE 3

| | Organic solvent | Positive electrode | Median diameter | | |
|---|---|---|---|---|---|
| | (volume ratio) | active material | (D50) | Separator | Description of measurement |
| Sample 1_P | FEC:MTFP = 2:8 | LCO containing | Approx. 12 μm | PP | AC impedance measurement |
| | | Mg, F, Ni, and Al | | | Charge and discharge measurement |
| Sample 1_I | | | | PI | Charge and discharge measurement |
| Reference Example 1 | EC:DEC = 3:7 | | | PP | AC impedance measurement |
| Sample 2_P | FEC:MTFP = 2:8 | LCO containing | Approx. 7 μm | PP | Charge and discharge measurement |
| Sample 2_I | | Mg, F, Ni, and Al | | PI | Charge and discharge measurement |

### <AC Impedance Measurement>

The interface resistance between the positive electrode and the electrolyte of Sample 1_P and Reference Example 1 was evaluated by an AC impedance method.

First, conditions for the fabrication of an evaluation cell for AC impedance measurement will be described using Sample 1_P as an example. The half cell including Sample 1_P was subjected to aging treatment. Two cycles of aging treatment was performed by repeating charging under the following conditions and discharging under the following conditions. As the charging conditions, the ambient temperature at which Sample 1_P was placed was 25° C., constant current charging (hereinafter referred to as CC charging) was performed at a 0.1 C rate until a termination voltage of 4.6 V, and then constant voltage charging (hereinafter referred to as CV charging) was performed at 4.6 V until a current of 0.01 C. As the discharging conditions, the ambient temperature at which Sample 1_P was placed was 25° C., and constant current discharging (hereinafter referred to as CC discharging) was performed at a 0.1 C rate until a termination voltage of 2.5 V. After that, charging in the third cycle of aging treatment was performed. As the charging conditions, the ambient temperature was 25° C., CC charging was performed at a 0.1 C rate until a termination voltage of 4.5 V, and then CV charging was performed until a current of 0.01 C. The ambient temperature is the temperature of a thermostatic chamber (produced by ESPEC Corp.) where samples are placed, and the term “ambient temperature” is hereinafter simply used. In this example, 1 C was set equal to 200 mA/g (a current per positive electrode active material weight of 200 mA/g).

In the state where the charging in the third cycle was completed, the half cell including Sample 1 was left in the thermostatic chamber for 6 hours. Then, the positive electrode of Sample 1_P was taken out from the half cell in an argon atmosphere. The positive electrode taken out was in a state of being immersed in the electrolyte.

The evaluation cell used for AC impedance measurement is a symmetric cell. Thus, two positive electrodes taken out were prepared, and a symmetric cell was assembled with PP positioned as a separator between the two positive electrodes. At that time, the amount of the electrolyte in the symmetric cell was insufficient; thus, the organic solvent containing 1 mol/L of LiPF₆ (FEC:MTFP=2:8 (volume ratio)) was newly added such that the amount was sufficient for AC impedance evaluation. Note that like Sample 1_P, Reference Example 1 was also used to assemble a symmetric cell. Through such steps, the evaluation cell of Sample 1 and the evaluation cell of Reference Example 1 were prepared.

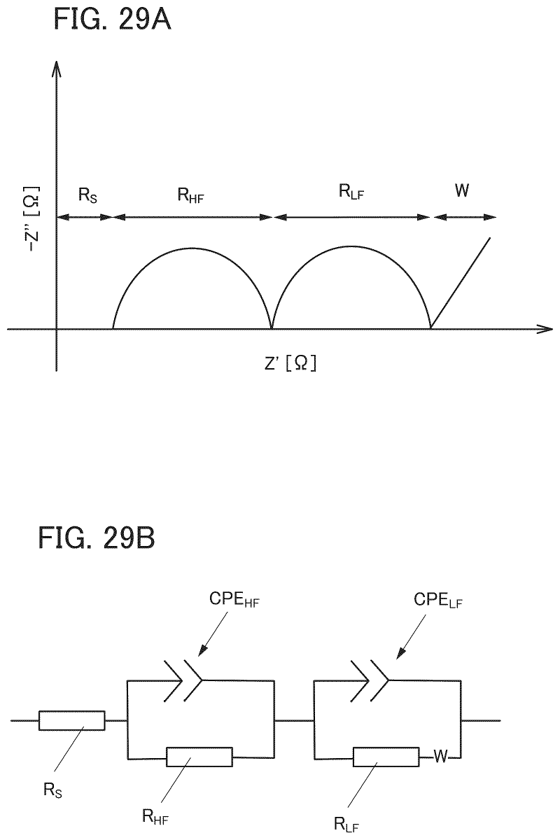

Next, conditions for AC impedance measurement will be described. First, FIG. 29A and FIG. 29B illustrate a Nyquist diagram and an equivalent circuit diagram that is used for fitting, respectively. In the Nyquist diagram in FIG. 29A, Z on the horizontal axis represents the resistance [Ω], and −Z″ on the vertical axis represents the reactance [Ω]. In the equivalent circuit diagram in FIG. 29B, CPE_{HF} and CPE_{LF} correspond to double layer capacitances. It is known that in FIG. 29A and FIG. 29B, a resistance denoted by R_{S} corresponds to the resistance of an electrolyte, a resistance denoted by R_{HF} corresponds to a resistance related to electron conduction in an electrode or adsorption and desorption of lithium ions at the surface of an electrode, and a resistance denoted by R_{LF} corresponds to the resistance of charge transfer corresponding to solvation and desolvation of lithium ions and insertion and extraction of lithium ions, and the resistance of a surface coating film. The surface coating film can be formed in such a manner that an electrolyte solution is decomposed and deposited on an active material. Note that W in FIG. 29A and FIG. 29B is a diffusion coefficient corresponding to diffusion of lithium ions in a solid.

The AC impedance measurement was performed using a measurement device that was a combination of a potentio/galvanostat (hereinafter referred to as “P/G”) and a frequency response analyzer (hereinafter referred to as “FRA”) while the ambient temperature at which the symmetric cells were placed was controlled to be 25° C., 0° C., −20° C., −40° C., and 25° C. in this order. With the FRA, the AC amplitude was set to 10 mV, and the frequency applied to the symmetric cells was varied within the range of 0.3 mHz to 100 kHz. Specifically, the frequency at the ambient temperatures of 25° C. and 0° C. was changed from 1 mHz to 100 kHz, the frequency at −20° C. was changed from 0.5 mHz to 100 kHz, and the frequency at −40° C. was changed from 0.3 mHz to 100 kHz.

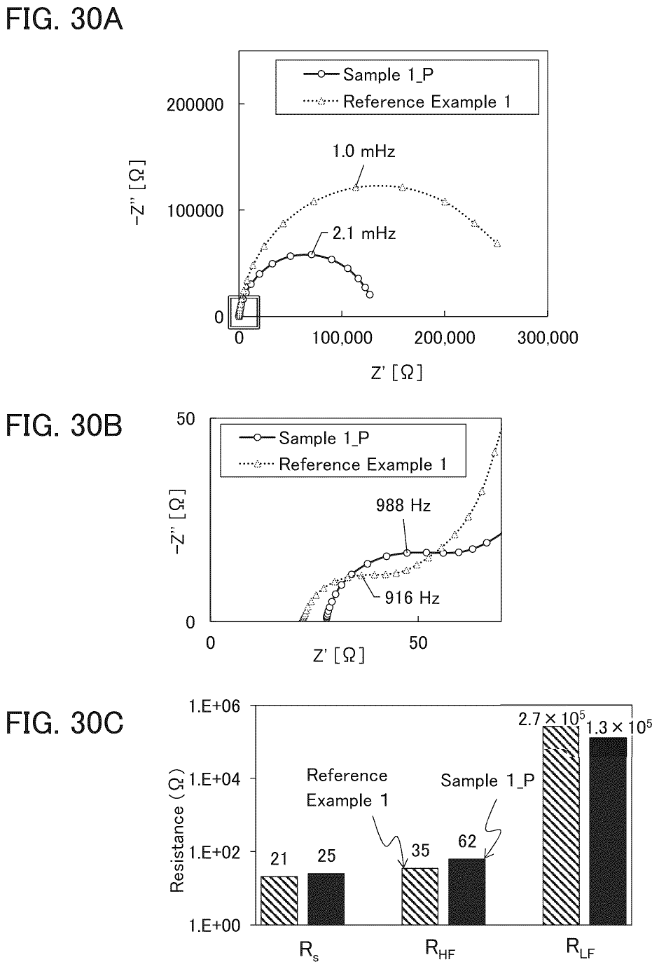

FIG. 30A shows the AC impedance measurement results of Sample 1_P and Reference Example 1 at the ambient temperature of −40° C., which is the lowest temperature among the AC impedance conditions. As to Sample 1_P, the frequency at the vertex of the arc corresponding to R_{LF} is 2.1 mHz, and the resistance is 1.3×10⁵(Ω). As to Reference Example 1, the frequency at the vertex of the arc corresponding to R_{LF} is 1.0 mHz, and the resistance is 2.7×10⁵(Ω). FIG. 30B shows an enlarged view of a region indicated by a square in FIG. 30A, where the resistance Z′ is around 50(Ω). As to Sample 1_P, the frequency at the vertex of the arc corresponding to R_{HF} is 988 Hz, and the resistance is 62(Ω). As to Reference Example 1, the frequency at the vertex of the arc corresponding to R_{H}F is 916 Hz, and the resistance is 35(Ω). FIG. 30C shows R_{S}, R_{HF}, and R_{LF} of Sample 1_P and Reference Example 1 all together.

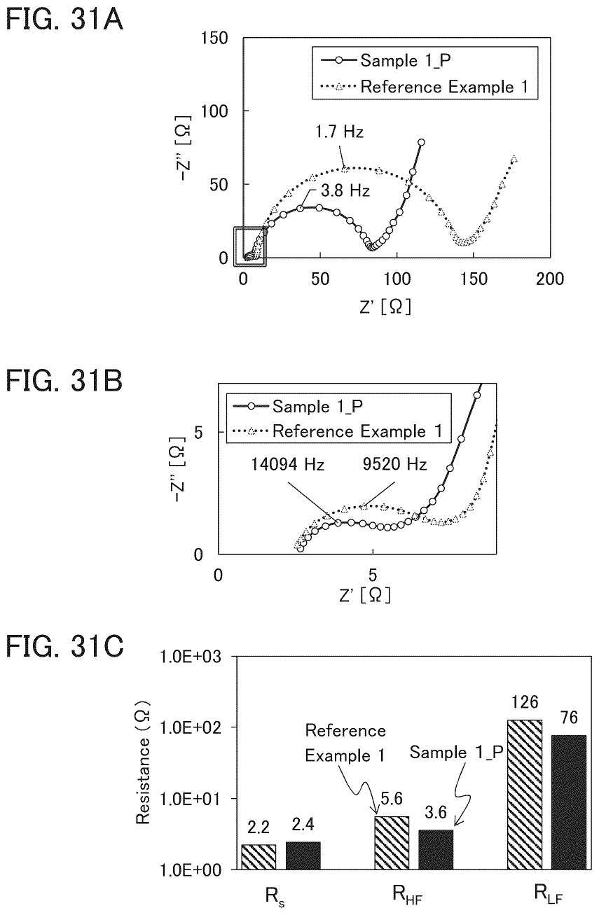

FIG. 31A shows the AC impedance measurement results of Sample 1_P and Reference Example 1 at the ambient temperature of 25° C. As to Sample 1_P, the frequency at the vertex of the arc corresponding to R_{LF} is 3.8 Hz, and the resistance is 76(Ω). As to Reference Example 1, the frequency at the vertex of the arc corresponding to R_{LF} is 1.7 Hz, and the resistance is 126 (Ω). FIG. 31B shows an enlarged view of a region indicated by a square in FIG. 31A, where Z is around 50(Ω). As to Sample 1_P, the frequency at the vertex of the arc corresponding to R_{HF} is 14094 Hz, and the resistance is 3.6(Ω). As to Reference Example 1, the frequency at the vertex of the arc corresponding to R_{HF} is 9520 Hz, and the resistance is 5.6(Ω). FIG. 31C shows R_{S}, R_{HF}, and R_{LF} of Sample 1_P and Reference Example 1 all together.

It can be found from FIG. 30C and FIG. 31C that Sample 1_P shows smaller R_{LF} values than Reference Example 1 at both of the ambient temperatures of −40° C. and 25° C. In other words, since the same separator material is used for both Sample 1_P and Reference Example 1, Sample 1 shows smaller R_{LF} values than Reference Example 1 at both of the ambient temperatures of −40° C. and 25° C. As described above, R_{LF} is the resistance of charge transfer corresponding to solvation and desolvation of lithium ions and insertion and extraction of lithium ions and the resistance component of a surface coating film. At −40° C., as compared with the case of 25° C., R_{LF} is higher than R_{S} and R_{HF} (by a factor of approximately 1000 or more), from which it can be found that R_{LF} is the resistance that should be considered most at a temperature below freezing. Sample 1 shows low R_{LF} at −40° C. and thus probably enables excellent charge and discharge characteristics of a lithium-ion battery at a temperature below freezing. In addition, Sample 1 shows low R_{LF} also at 25° C.; thus, a lithium-ion battery including the electrolyte of Sample 1 or the like can probably achieve excellent charge and discharge characteristics in a wide temperature range from temperatures below freezing to high temperatures.

### <Charge and Discharge Characteristics>

The charge capacities, discharge capacities, and cycle performances of Sample 1, Sample 2, and the like described above were measured using a charge-discharge test system (TOSCAT-3100) produced by TOYO SYSTEM Co., Ltd. as a charge-discharge measuring instrument.

Since a rate is used as a condition at the time of measuring a charge capacity, a discharge capacity, and a cycle performance, the rate is described here. An example of the rate is a discharge rate, and the discharge rate represents the relative ratio of a current value at the time of discharging to the battery capacity and is expressed in a unit C. For example, a current corresponding to 1 C in a battery with a rated capacity X (Ah) is X (A). In measurement of a charge capacity, a discharge capacity, and a cycle performance, the case where discharging is performed with a current of 2X (A) is rephrased as follows: discharge is performed at a discharge rate of 2 C. The case where discharging is performed with a current of X/2 (A) is rephrased as follows: discharging is performed at a discharge rate of 0.5 C. Note that another example of the rate is a charge rate, and the charge rate can be understood by replacing the above-described discharge rate and discharging with the charge rate and charging, respectively. In this example of this specification, 1 C was set equal to 200 mA/g (a current per positive electrode active material weight of 200 mA/g).

### <Charge Characteristics>

In this example, while the ambient temperature at which Sample 1_P, Sample 1_I, Sample 2_P, and Sample 2_I (collectively referred to as each sample) were placed was decreased to 25° C., 0° C., −20° C., −40° C., −45° C., and −50° C. in this order, charge capacities were measured at each ambient temperature in order to observe charge capacities at temperatures below freezing. Note that discharging was performed every time charging was performed at each ambient temperature, and the ambient temperature at the time of the discharging was set to 25° C. The above-described charging was performed by CC charging at a charge rate of 0.1 C until a termination voltage of 4.6 V, and the above-described discharging was performed by CC discharging at a discharge rate of 0.1 C until a termination voltage of 2.5 V. In this example, 1 C was set equal to 200 mA/g (a current per positive electrode active material weight of 200 mA/g). The table below shows test conditions.

TABLE 4

| | | Termination | | |
|---|---|---|---|---|
| | Ambient temperature | voltage | Rate | Other |
| Charge | 25° C., 0° C., −20° | 4.6 V | 0.1 C | CC charging |
| conditions | C., −40° C., −45° | | | |
| | C., −50° C. | | | |
| Discharge | 25° C. | 2.5 V | 0.1 C | CC discharging |
| conditions | | | | |

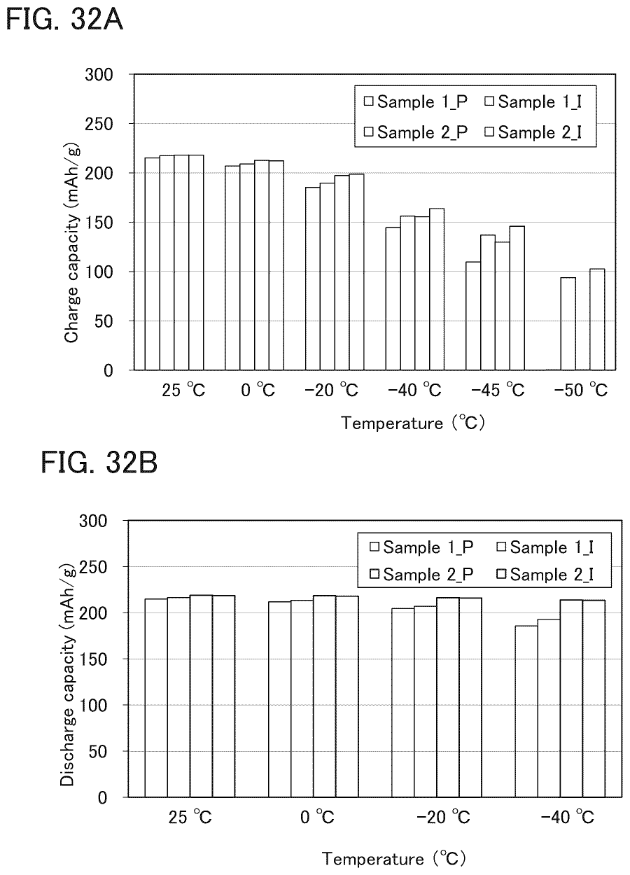

FIG. 32A shows the result of a charge capacity per positive electrode active material weight (mAh/g) of each sample. The temperature shown on the horizontal axis in FIG. 32A is the ambient temperature under the charge conditions in the above table. The table below shows values obtained by normalizing the charge capacity at each ambient temperature by the charge capacity at 25° C. The normalized values may be expressed in percentage, and a normalized value of 0.5 is equal to 50%.

TABLE 5

| Ambient | | Value normalized by charge capacity at 25° C. | | | |
|---|---|---|---|---|---|
| temperature | | Sample | Sample | Sample | Sample |
| [° C.] | | 1_P | 1_I | 2_P | 2_I |
| 25° | C. | 1 | 1 | 1 | 1 |
| 0° | C. | 0.96 | 0.96 | 0.98 | 0.97 |
| −20° | C. | 0.86 | 0.87 | 0.91 | 0.91 |
| −40° | C. | 0.67 | 0.72 | 0.71 | 0.75 |
| −45° | C. | 0.51 | 0.63 | 0.59 | 0.67 |
| −50° | C. | — | 0.43 | — | 0.50 |

It can be found that each sample can achieve a charge capacity in a wide temperature range including temperatures below freezing and the charge capacities at −20° C., −40° C., and −45° C. satisfy higher than or equal to 50% of the charge capacity at 25° C. Furthermore, Sample 1_I and Sample 2_I using PI as the separator can be charged and discharged even at −50° C. It can also be found that Sample 2 has a higher charge capacity at each ambient temperature than Sample 1 regardless of the separator material. Thus, it can be found that a lithium-ion battery using the organic solvent of the electrolyte and the positive electrode active material of one embodiment of the present invention exhibits excellent charge characteristics in a wide temperature range including temperatures below freezing.

### <Discharge Characteristics>

In this example, while the ambient temperature at which Sample 1_P, Sample 1_I, Sample 2_P, and Sample 2_I (collectively referred to as each sample) were placed was decreased to 25° C., 0° C., −20° C., −40° C., −45° C., and −50° C. in this order, discharge capacities were measured at each ambient temperature in order to observe discharge capacities at temperatures below freezing. Note that charging was performed every time discharging was performed at each ambient temperature, and the ambient temperature at the time of the charging was set to 25° C. The above-described charging was performed by CC charging at a charge rate of 0.1 C until a termination voltage of 4.6 V, and then by CV charging at 4.6 V until a current of 0.05 C. The above-described discharging was performed by CC discharging at a discharge rate of 0.1 C until a termination voltage of 2.5 V. In this example, 1 C was set equal to 200 mA/g (a current per positive electrode active material weight of 200 mA/g). The table below shows test conditions.

TABLE 6

| | | Termination | | |
|---|---|---|---|---|
| | Ambient temperature | voltage | Rate | Other |
| Charge | 25° C. | 4.6 V | 0.1 C | CC charging − |
| conditions | | | | CV charging |
| Discharge | 25° C., 0° C., −20° | 2.5 V | 0.1 C | CC discharging |
| conditions | C., −40° C. −45° | | | |
| | C., −50° C. | | | |

FIG. 32B shows the result of a discharge capacity per positive electrode active material weight (mAh/g) of each sample. The temperature shown on the horizontal axis in FIG. 32B is the ambient temperature under the discharge conditions in the above table. The table below shows values obtained by normalizing the discharge capacity at each ambient temperature by the discharge capacity at 25° C. The normalized values may be expressed in percentage, and a normalized value of 0.5 is equal to 50%.

TABLE 7

| Ambient | | | | | |
|---|---|---|---|---|---|
| temperature | | Value normalized by discharge capacity at 25° C. | | | |
| [° C.] | | Sample 1_P | Sample 1_I | Sample 2_P | Sample 2_I |
| 25° | C. | 1 | 1 | 1 | 1 |
| 0° | C. | 0.99 | 0.99 | 0.99 | 0.99 |
| −20° | C. | 0.97 | 0.97 | 0.98 | 0.98 |
| −40° | C. | 0.85 | 0.88 | 0.94 | 0.95 |

It can be found that each sample can achieve a discharge capacity in a wide temperature range including temperatures below freezing and the discharge capacities at −20° C. and −40° C. satisfy higher than or equal to 80%, preferably higher than or equal to 85%, of the charge capacity at 25° C. It can also be found that Sample 2 has a higher discharge capacity at each ambient temperature than Sample 1. Thus, it can be found that the lithium-ion battery using the organic solvent of the electrolyte and the positive electrode active material of one embodiment of the present invention exhibits excellent charge and discharge characteristics in a wide temperature range including temperatures below freezing.

### <Fabrication of Full Cell>

Next, a full cell (Sample 1F_P) was assembled using Sample 1_P as a positive electrode and graphite as a negative electrode. Similarly, a full cell (Sample 2F_P) was assembled using Sample 2_P as a positive electrode and graphite as a negative electrode.

### <Fabrication of Positive Electrode>

The positive electrodes were fabricated in a manner similar to that of Sample 1_P and Sample 2_P. Note that a positive electrode active material layer was applied to one surface of a current collector.

### <Fabrication of Negative Electrode>

Artificial graphite (MCMB-High rate dischage-G10 produced by Linyi Gelon) was used as a negative electrode active material, VGCF (registered trademark) (VGCF-H produced by Showa Denko) was used as a conductive additive, SBR (TRD2001 produced by JSR) was used as a binder, and CMC (produced by Kishida Chemical) was used as a thickener to fabricate a negative electrode active material layer containing these. For the negative electrode active material layer, the mixing ratio (weight ratio) of artificial graphite to VGCF to CMC to SBR was set to 96:1:1:2. For a slurry corresponding to the negative electrode active material layer, water was used as a solvent. The slurry was applied to one surface of copper foil using a coater with a drier, and the solvent was dried, whereby a negative electrode was fabricated. Pressing was not performed.

### <Electrolyte Solution>

An organic electrolyte solution was prepared by using LiPF₆ as a lithium salt, using fluoroethylene carbonate (FEC) and methyl 3,3,3-trifluoropropionate (MTFP) as organic solvents, and dissolving LiPF₆ at 1 mol/L in a mixed solvent containing FEC:MTFP=2:8 (volume ratio). No additive agent was used.

### <Separator>

As a separator, polypropylene was used.

### <Other Structure>

A single-layer structure including one negative electrode, one positive electrode, and one separator was held in an exterior body. The area of the negative electrode was 45 mm×53 mm (23.841 cm²), and the area of the positive electrode was 41 mm×50 mm (20.493 cm²). The loading amount of the positive electrode active material was approximately 10.6 mg/cm², the loading amount of the negative electrode was approximately 7.6 mg/cm², and the capacity ratio was approximately 80%. The capacity ratio is the ratio of the negative electrode capacity to the positive electrode capacity. The positive electrode capacity is the product of the loading amount of the positive electrode, the positive electrode capacity of 200 mAh/g, and the area of the positive electrode active material layer, and the negative electrode capacity is the product of the loading amount of the negative electrode, the negative electrode capacity of 300 mAh/g, and the area of the negative electrode active material layer.

The table below shows the main conditions of Sample 1F_P and Sample 2F_P. The description of measurement of each sample is also shown.

TABLE 8

| | Organic solvent | Positive electrode | Median | | Description of |
|---|---|---|---|---|---|
| | (volume ratio) | active material | diameter (D50) | Separator | measurement |
| Sample 1F_P | FEC:MTFP = 2:8 | LCO containing | Approx. 12 μm | PP | Charge and discharge measurement |
| | | Mg, F, Ni, and Al | | | |
| Sample 2F_P | FEC:MTFP = 2:8 | LCO containing | Approx. 7 μm | PP | Charge and discharge measurement |
| | | Mg, F, Ni, and Al | | | |

### <Charge Characteristics>

In this example, while the ambient temperature at which Sample 1F_P and Sample 2F_P (collectively referred to as each sample) were placed was decreased to 25° C., 0° C., −20° C., and −40° C. in this order, charge capacities were measured at each ambient temperature in order to observe charge capacities at temperatures below freezing. Note that discharging was performed every time charging was performed at each ambient temperature, and the ambient temperature at the time of the discharging was set to 25° C. The above-described charging was performed by CC charging at a charge rate of 0.1 C until a termination voltage of 4.5 V (a potential with reference to graphite serving as the negative electrode), and the above-described discharging was performed by CC discharging at a discharge rate of 0.1 C until a termination voltage of 2.5 V. In this example, 1 C was set equal to 200 mA/g (a current per positive electrode active material weight of 200 mA/g). The table below shows test conditions.

TABLE 9

| | | Termination | | |
|---|---|---|---|---|
| | Ambient temperature | voltage | Rate | Other |
| Charge | 25° C., 0° C., −20° | 4.5 V | 0.1 C | CC charging |
| conditions | C., −40° C. | | | |
| Discharge | 25° C. | 2.5 V | 0.1 C | CC discharging |
| conditions | | | | |

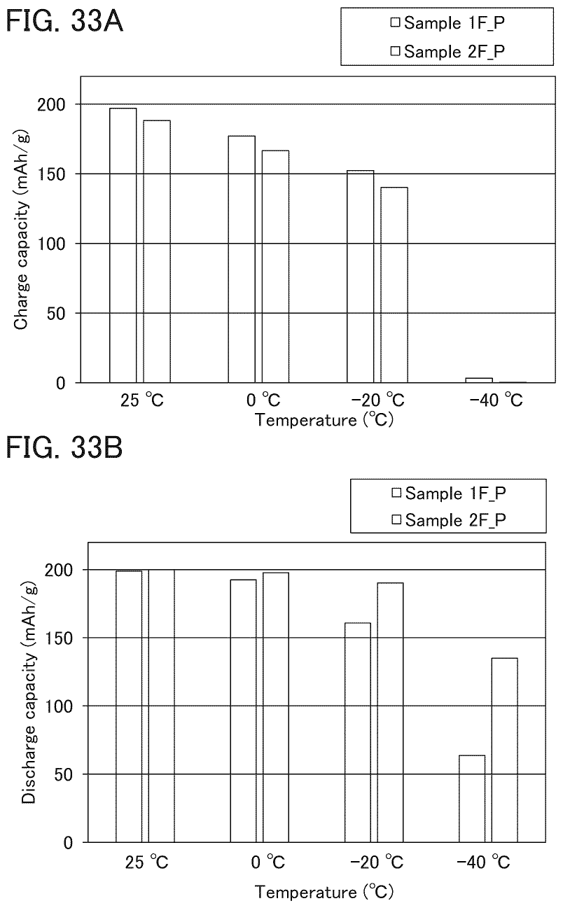

FIG. 33A shows the result of a charge capacity per positive electrode active material weight (mAh/g) of each sample. The temperature shown on the horizontal axis in FIG. 33A is the ambient temperature under the charge conditions in the above table. The table below shows values obtained by normalizing the charge capacity at each ambient temperature by the charge capacity at 25° C. The normalized values may be expressed in percentage, and a normalized value of 0.5 is equal to 50%.

TABLE 10

| Ambient | | Value normalized by charge capacity at 25° C. | |
|---|---|---|---|
| temperature [° C.] | | Sample 1F_P | Sample 2F_P |
| 25° | C. | 1 | 1 |
| 0° | C. | 0.89 | 0.90 |
| −20° | C. | 0.73 | 0.76 |
| −40° | C. | — | — |

It can be found that each sample can achieve a charge capacity in a wide temperature range including temperatures below freezing and the charge capacity at −20° C. satisfies higher than or equal to 50% of the charge capacity at 25° C. Thus, it can be found that the lithium-ion battery using the organic solvent of the electrolyte and the positive electrode active material of one embodiment of the present invention exhibits excellent charge characteristics in a wide temperature range including temperatures below freezing.

### <Discharge Characteristics>

In this example, while the ambient temperature at which Sample 1F_P and Sample 2F_P (collectively referred to as each sample) were placed was decreased to 25° C., 0° C., −20° C., and −40° C. in this order, discharge capacities were measured at each ambient temperature in order to observe discharge capacities at temperatures below freezing. Note that charging was performed every time discharging was performed at each ambient temperature, and the ambient temperature at the time of the charging was set to 25° C. The above-described charging was performed by CC charging at a charge rate of 0.1 C until a termination voltage of 4.5 V, and then by CV charging at 4.5 V (a potential with reference to graphite serving as the negative electrode) until a current of 0.05 C. The above-described discharging was performed by CC discharging at a discharge rate of 0.1 C until a termination voltage of 2.5 V. In this example, 1 C was set equal to 200 mA/g (a current per positive electrode active material weight of 200 mA/g). The table below shows test conditions.

TABLE 11

| | | Termination | | |
|---|---|---|---|---|
| | Ambient temperature | voltage | Rate | Other |
| Charge | 25° C. | 4.5 V | 0.1 C | CC charging − |
| conditions | | | | CV charging |
| Discharge | 25° C., 0° | 2.5 V | 0.1 C | CC discharging |
| conditions | C., −20° C., −40° C. | | | |

FIG. 33B shows the result of a charge capacity per positive electrode active material weight (mAh/g) of each sample. The temperature shown on the horizontal axis in FIG. 33B is the ambient temperature under the charge conditions in the above table. The table below shows values obtained by normalizing the charge capacity at each ambient temperature by the charge capacity at 25° C. The normalized values may be expressed in percentage, and a normalized value of 0.5 is equal to 50%.

TABLE 12

| | Value normalized by |
|---|---|
| Ambient | discharge capacity at 25° C. |

| | | |
|---|---|---|
| temperature [° C.] | Sample 1F_P | Sample 2F_P |

| | | | |
|---|---|---|---|
| 25° | C. | 1 | 1 |
| 0° | C. | 0.97 | 0.99 |
| −20° | C. | 0.81 | 0.95 |
| −40° | C. | 0.32 | 0.68 |

It can be found that each sample can achieve a discharge capacity in a wide temperature range including temperatures below freezing and the discharge capacity at −20° C. satisfies higher than or equal to 50% of the discharge capacity at 25° C. It can also be found that the discharge capacity of Sample 2F_P at −40° C. satisfies higher than or equal to 50% of the discharge capacity at 25° C. Thus, it can be found that the lithium-ion battery using the organic solvent of the electrolyte and the positive electrode active material of one embodiment of the present invention exhibits excellent discharge characteristics in a wide temperature range including temperatures below freezing.

### <Charge and Discharge Characteristics and Cycle Performance at 25° C.>

A new sample 25F_P corresponding to Sample 1F_P described above was fabricated and subjected to a cycle test at 25° C. to evaluate the charge and discharge characteristics and cycle performance thereof.

### <Aging Conditions>

After Sample 25F_P was held at room temperature for 24 hours, Sample 25F_P was charged by 15 mAh/g at a 0.01 C rate and further charged by 120 mAh/g at a 0.1 C rate. Here, a calculation was made assuming that the positive electrode capacity was 200 mAh/g. After Sample 25F_P in a charged state to 135 mAh/g was held in a thermostatic chamber set at 40° C. for 24 hours, evacuation to a vacuum was performed until a differential pressure gauge reached −60 kPa, and the exterior body was sealed.

A cycle of CCCV charging at an upper limit voltage of 4.5 V and a 0.1 C rate with a 0.01 C cut and then CV discharging at 0.2 C until a lower limit voltage of 2.5 V was performed once. Then, a cycle of CCCV charging at the upper limit voltage of 4.5 V and a 0.2 C rate with a 0.02 C cut and then CV discharging at 0.2 C until the lower limit voltage of 2.5 V was repeated three times. Furthermore, a cycle of CCCV charging at the upper limit voltage of 4.5 V and the 0.2 C rate with the 0.02 C cut and then CV discharging at 0.2 C until a lower limit voltage of 3.0 V was repeated three times.

### <Charge and Discharge Conditions>

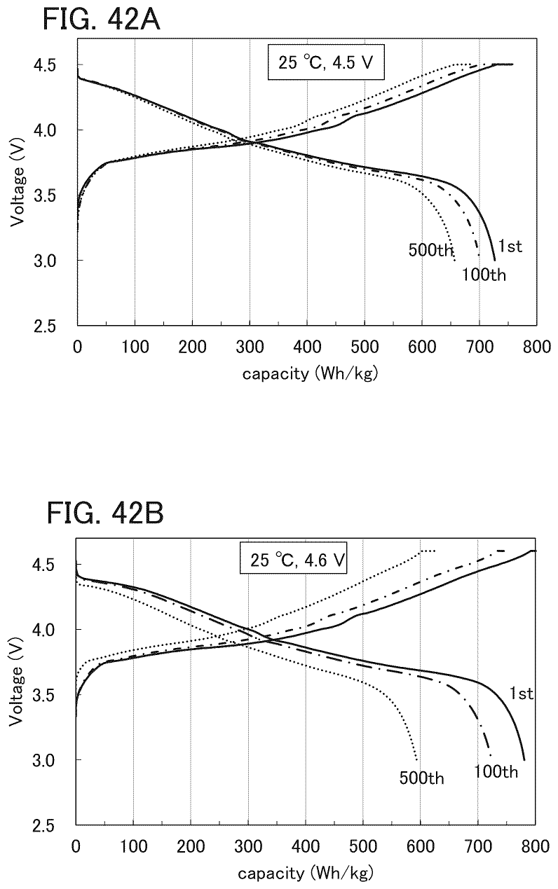

FIG. 42A shows charge and discharge curves of the case where a cycle of CCCV charging at an upper limit voltage of 4.5 V and a 0.2 C rate with a 0.1 C cut and then CV discharging until a lower limit voltage of 3.0 V was repeated 500 times. In FIG. 42A showing the charge and discharge curves, the vertical axis represents the voltage (V), and the horizontal axis represents the capacity per active material importance (Wh/kg). Note that the capacity of the charge curve indicates the charge capacity and the capacity of the discharge curve indicates the discharge capacity. FIG. 42B shows charge and discharge curves of the case where a cycle of CCCV charging at an upper limit voltage of 4.6 V and a 0.2 C rate with a 0.02 C cut and then CV discharging until a lower limit voltage of 3.0 V was repeated 500 times. In FIG. 42B showing the charge and discharge curves, the vertical axis represents the voltage (V), and the horizontal axis represents the capacity per active material importance (Wh/kg). Note that the capacity of the charge curve indicates the charge capacity and the capacity of the discharge curve indicates the discharge capacity. The charge and discharge curves are superimposed plots of the charge voltage (V) as a function of the charge capacity (Wh/kg, per positive electrode active material weight) and the discharge voltage (V) as a function of the discharge capacity (Wh/kg, per positive electrode active material weight).

The initial discharge capacity at the upper limit voltage of 4.5 V is 187.2 mAh/g. As can be read from FIG. 42A, the initial energy density at the upper limit voltage of 4.5 V is 727.7 Wh/kg. The initial discharge capacity at the upper limit voltage of 4.6 V is 200.1 mAh/g. As can be read from FIG. 42B, the initial energy density at the upper limit voltage of 4.6 V is 782.8 Wh/kg. As shown in FIG. 42A and FIG. 42B, Sample 25F_P shows only a small decrease in discharge voltage even when the number of cycles increases. This is probably because of no occurrence of a change in property and a decrease in crystallinity of the LCO surface that inhibit Li diffusion.

### <Cycle Evaluation>

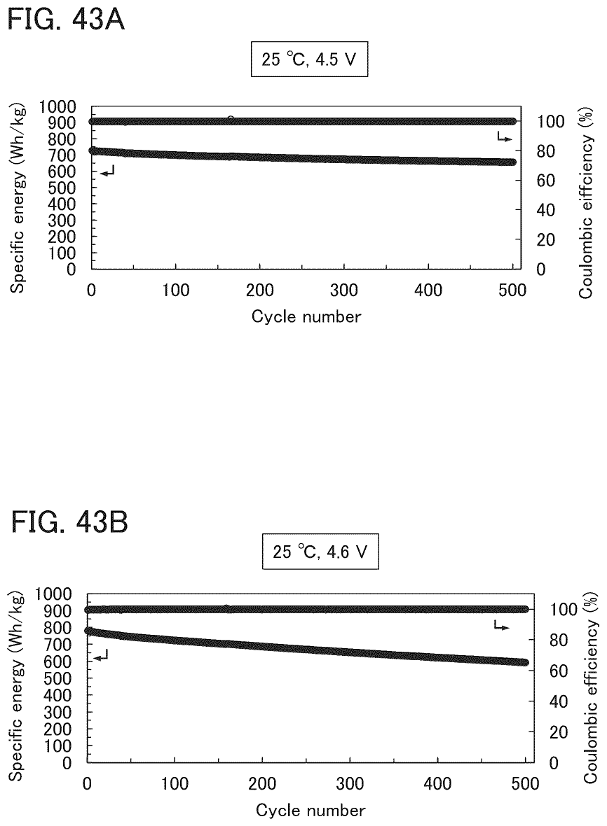

Next, FIG. 43A shows the results of a cycle test in which a cycle of CCCV charging at an upper limit voltage of 4.5 V and a 0.2 C rate with a 0.1 C cut and then CV discharging at a 0.2 C rate until a lower limit voltage of 3.0 V was repeated 500 times. As the cycle test results, FIG. 43A shows the discharge energy density and charge and discharge efficiency as a function of the number of cycles (Cycle number) on the horizontal axis. Thus, in FIG. 43A, the left vertical axis represents the discharge energy density (Specific energy) (Wh/kg), and the right vertical axis represents the charge and discharge efficiency (Coulombic efficiency) (%). FIG. 43B shows the results of a cycle test in which a cycle of CCCV charging at an upper limit voltage of 4.6 V and a 0.2 C rate with a 0.02 C cut and then CV discharging until a lower limit voltage of 3.0 V was repeated 500 times. As the cycle test results, FIG. 43B shows the discharge energy density and charge and discharge efficiency as a function of the number of cycles on the horizontal axis. Thus, in FIG. 43A, the left vertical axis represents the discharge energy density (Wh/kg), and the right vertical axis represents the charge and discharge efficiency (%).

In each cycle test, Sample 25F_P showed an initial discharge capacity of approximately 40 mAh at the upper limit voltage of 4.5 V and 44 mAh at the upper limit voltage of 4.6 V. At the upper limit voltage of 4.5 V, the energy density retention rate after the 500 cycles was 89% (650 Wh/kg). At the upper limit voltage of 4.6 V, the energy density retention rate after the 500 cycles was 75.8% (593.7 Wh/kg). Thus, it can be found that the lithium-ion battery using the organic solvent of the electrolyte and the positive electrode active material of one embodiment of the present invention exhibits excellent cycle performance even at room temperature (typically 25° C.).

### Example 4

In this example, the charge and discharge characteristics and cycle performance of each of Sample 11 and Sample 12 using the electrolyte of one embodiment of the present invention were evaluated.

### <Fabrication Conditions of Sample 11>

As an electrolyte of Sample 11, an organic solvent mixed to satisfy FEC:MTFP=2:8 (volume ratio) was prepared, and LiPF₆ was added as a lithium salt at 1 mol/L to the organic solvent. Note that no additive agent was used for Sample 11.

As a positive electrode active material of Sample 11, a lithium composite oxide (Li_{1.01}Ni_{0.8}Co_{0.1}Mn_{0.1}O₂) with nickel, cobalt, and manganese mixed at a ratio of Ni:Co:Mn=8:1:1 (NCM 811) which was obtained by the coprecipitation method described above in Embodiment 3 was used. A method for fabricating the lithium composite oxide is described here. First, as a raw material of Step S201 in FIG. 9, an aqueous solution A in which nickel sulfate, cobalt sulfate, manganese sulfate, and glycine were dissolved in pure water was prepared. Note that the aqueous solution A was prepared such that the concentration of Ni ions was 2 mol/L, the concentration of Co ions was 2 mol/L, the concentration of Mn ions was 2 mol/L, and the concentration of glycine was 0.1 mol/L. At this time, the ratio of nickel to cobalt to manganese was set to satisfy Ni:Co:Mn=8:1:1 or the neighborhood thereof.

In Step S201, sodium hydroxide was also prepared and dissolved in pure water to prepare an aqueous solution B. The aqueous solution B was prepared such that the concentration of sodium hydroxide was 5 mol/L.

In Step S201, glycine was also prepared and dissolved in pure water to prepare an aqueous solution C. The aqueous solution C was prepared such that the concentration of glycine was 0.1 mol/L.

In the coprecipitation synthesis apparatus, 300 mL of the aqueous solution C was put in the reaction vessel 171, 250 mL of the aqueous solution A was put in the first tank 180, and 200 mL of the aqueous solution B was put in the second tank 186. Nitrogen was supplied to the reaction vessel 171 at a flow rate of 1 L/min.

Mixing was started after the temperature of the reaction vessel 171 of the coprecipitation synthesis apparatus was adjusted to 50° C. and the pH value of the aqueous solution C was adjusted to 11.0. The aqueous solution A was supplied from the first tank 180 to the reaction vessel 171 at a liquid delivery rate of 0.1 m/min, and stirring was continued at 1000 rpm using three swept blades. A baffle plate was placed at the time of the stirring. Note that the aqueous solution B in the second tank 186 was supplied to the reaction vessel 171 as appropriate so that the pH value of the aqueous solution C in the reaction vessel 171 of the coprecipitation synthesis apparatus was kept constant.

After the coprecipitation reaction was advanced over an adequate time, the deposited coprecipitated substance was filtered. After that, suction filtration was performed using a suction filtration apparatus while the coprecipitated substance in a suction funnel was cleaned with pure water. After that, suction filtration was performed using the suction filtration apparatus while the coprecipitated substance in the suction funnel was cleaned with acetone.

The coprecipitated substance that had been subjected to the above suction filtration step was transferred to a petri dish, the petri dish was put in a bell jar type vacuum apparatus, the pressure was reduced until a differential pressure gauge reached −0.1 MPa, and heating was performed at 80° C. for one hour. This heating step can be referred to as a drying step. Through this step, a hydroxide corresponding to the precursor of the positive electrode active material of Sample 11 was obtained.

As the lithium source, lithium hydroxide that was ground and classified at 10000 rpm for one hour was prepared. Lithium hydroxide was weighed such that the ratio of lithium hydroxide was 0.95 with respect to the hydroxide corresponding to the precursor of the positive electrode active material of Sample 11. Lithium hydroxide and the hydroxide corresponding to the precursor of the positive electrode active material of Sample 11 were mixed at 1500 rpm for 1.5 minutes to fabricate a mixture.

The mixture was put in an alumina crucible, which was then put in a muffle furnace without a lid and subjected to heating at 700° C. for 10 hours. Oxygen was supplied to the muffle furnace at a flow rate of 5 L/min.

After the heating at 700° C., the mixture was transferred to a mortar, crushed, and sieved. The sieved mixture was put in the alumina crucible again, which was put in the muffle furnace without a lid and subjected to heating at 800° C. for 10 hours. Oxygen was supplied to the muffle furnace at a flow rate of 5 L/min.

After the heating at 800° C., the mixture was transferred to a mortar, crushed, and sieved to give NCM corresponding to the positive electrode active material of Sample 11. The median diameter (D50) of NCM corresponding to the positive electrode active material of Sample 11 was 9.2 μm. The particle size distribution was measured using a laser diffraction particle size distribution measurement apparatus SALD-2200 (produced by Shimadzu Corporation).

As a separator of Sample 11, PP or PI was used. Sample 11 is referred to as “Sample 11_P” and “Sample 11_I” to make a distinction depending on the separator material.

For a positive electrode of Sample 11, the above-described positive electrode active material, acetylene black (AB) as a conductive additive, and polyvinylidene fluoride (PVDF) as a binder were prepared. PVDF was prepared in a state of being dissolved in N-methyl-2-pyrrolidone (NMP), a solvent, at a weight ratio of 5%. Next, a slurry compounded at the positive electrode active material:AB:PVDF=95:3:2 (weight ratio) was fabricated, and the slurry was applied to a positive electrode current collector of aluminum.

A coin cell (CR2032 type with a diameter of 20 mm and a height of 3.2 mm) was assembled using Sample 11 as a positive electrode and lithium metal as a counter electrode. Stainless steel (SUS) was used as each of a positive electrode can and a negative electrode can of the coin cell.

### <Fabrication Conditions of Sample 12>

A hydroxide was obtained by supplying the aqueous solution A to the reaction vessel 171 at a liquid delivery rate of 0.04 mL/min, and was then weighed such that the ratio of lithium hydroxide was 1.01 with respect to the hydroxide corresponding to the precursor of the positive electrode active material of Sample 12. Then, lithium hydroxide and the hydroxide corresponding to the precursor of the positive electrode active material of Sample 12 were mixed at 2000 rpm for 1.5 minutes to fabricate a mixture. After a drying step at 80° C. for one hour, a petri dish was put in a vacuum drying furnace, the pressure was reduced until a differential pressure gauge reached −0.1 MPa, and heating was performed at 200° C. for 12 hours. Through this heating step, a hydroxide from which impurities were sufficiently removed was obtained. In view of the heating temperature, hydrogen and oxygen may be removed as water from the mixture, and this heating step can be referred to as a dehydration step. After that, heating at 700° C. and heating at 800° C. were performed as in the case of Sample 11 to give NCM corresponding to the positive electrode active material of Sample 12. As in the case of Sample 11, NCM was a lithium composite oxide represented by Li_{1.01}Ni_{0.5}Co_{0.1}Mn_{0.1}O₂. The median diameter (D50) of NCM corresponding to the positive electrode active material of Sample 12 was 4.7 μm. The particle size distribution was measured using a laser diffraction particle size distribution measurement apparatus SALD-2200 (produced by Shimadzu Corporation).

For a positive electrode of Sample 12, the above-described positive electrode active material, acetylene black (AB) as a conductive additive, and polyvinylidene fluoride (PVDF) as a binder were prepared. PVDF was prepared in a state of being dissolved in N-methyl-2-pyrrolidone (NMP), a solvent, at a weight ratio of 5%. Next, a slurry compounded at the positive electrode active material:AB:PVDF=95:3:2 (weight ratio) was fabricated, and the slurry was applied to a positive electrode current collector of aluminum.

As a separator of Sample 12, PP was used. This is referred to as “Sample 12_P”.

A coin cell (CR2032 type with a diameter of 20 mm and a height of 3.2 mm) was assembled using Sample 12 as a positive electrode and lithium metal as a counter electrode. Stainless steel (SUS) was used as each of a positive electrode can and a negative electrode can of the coin cell.

The table below shows the main conditions of Sample 11_P, Sample 11_I, and Sample 12_P.

TABLE 13

| | | Positive | | |
|---|---|---|---|---|
| | | electrode | Median | |
| | Organic solvent | active | diameter | |
| | (volume ratio) | material | (D50) | Separator |
| Sample 11_P | FEC:MTFP = 2:8 | NCM(811) | 9.2 μm | PP |
| Sample 11_I | | | | PI |
| Sample 12_P | | | 4.7 μm | PP |

### <Charge Characteristics>

In this example, while the ambient temperature at which Sample 11_P, Sample 11_I, and Sample 12_P (collectively referred to as each sample) were placed was decreased to 25° C., 0° C., −20° C., −40° C., −45° C., and −50° C. in this order, charge capacities were measured at each ambient temperature in order to observe charge capacities at temperatures below freezing. Note that discharging was performed every time charging was performed at each ambient temperature, and the ambient temperature at the time of the discharging was set to 25° C. The above-described charging was performed by CC charging at a charge rate of 0.1 C until a termination voltage of 4.5 V, and the above-described discharging was performed by CC discharging at a discharge rate of 0.1 C until a termination voltage of 2.5 V. In this example, 1 C was set equal to 200 mA/g (a current per positive electrode active material weight of 200 mA/g). The table below shows test conditions.

TABLE 14

| | | Termination | | |
|---|---|---|---|---|
| | Ambient temperature | voltage | Rate | Other |
| Charge | 25° C., 0° C., −20° | 4.5 V | 0.1 C | CC |
| conditions | C., −40° C., −45° | | | charging |
| | C., −50° C. | | | |
| Discharge | 25° C. | 2.5 V | 0.1 C | CC |
| conditions | | | | discharging |

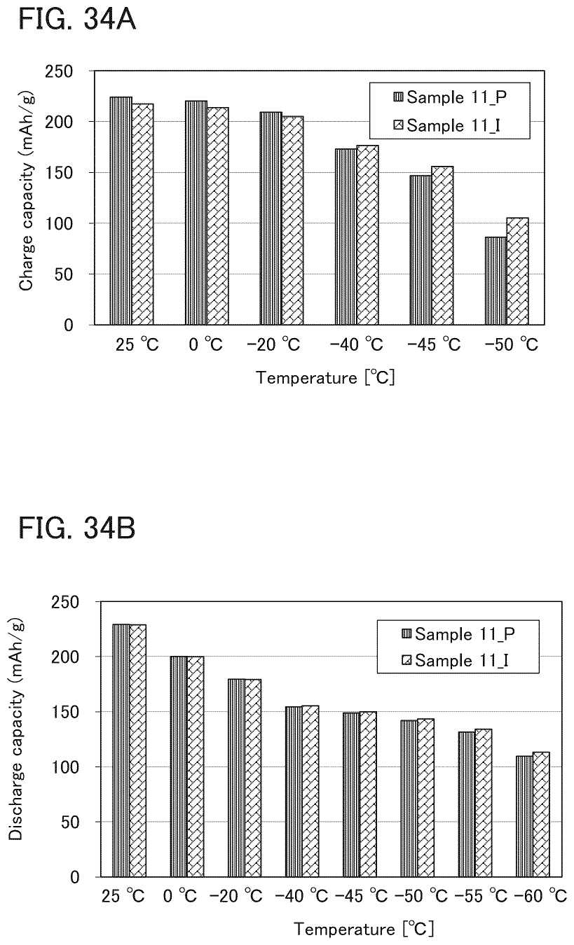

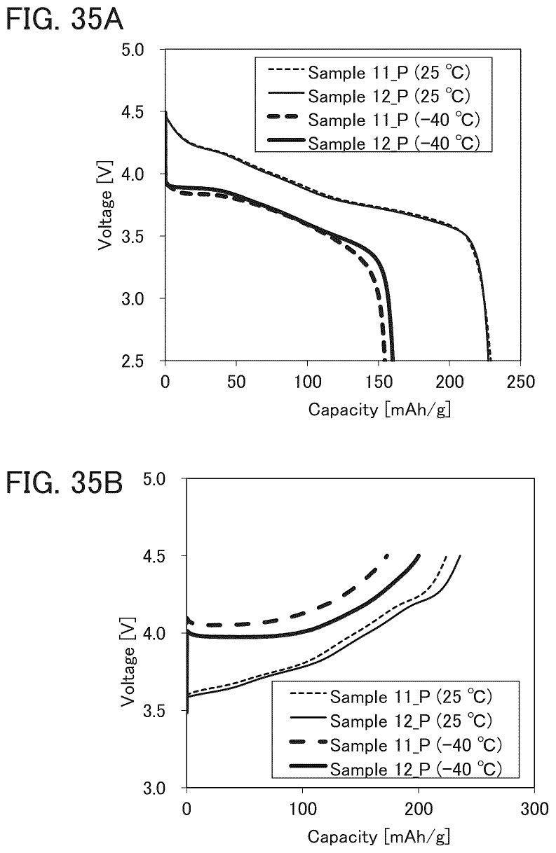

FIG. 34A shows the results of charge capacities per positive electrode active material weight (mAh/g) of Sample 11_P and Sample 11_I. The temperature shown on the horizontal axis in FIG. 34A is the ambient temperature under the charge conditions in the above table. FIG. 35A shows the charge curves of Sample 11_P and Sample 12_P at 25° C. and −40° C. The table below shows values obtained by normalizing the charge capacity at each ambient temperature by the charge capacity at 25° C. The normalized values may be expressed in percentage, and a normalized value of 0.5 is equal to 50%.

TABLE 15

| Ambient | | Value normalized by charge capacity at 25° C. | | |
|---|---|---|---|---|
| temperature [° C.] | | Sample 11_P | Sample 11_I | Sample 12_P |
| 25° | C. | 1 | 1 | 1 |
| 0° | C. | 0.98 | 0.98 | 0.99 |
| −20° | C. | 0.93 | 0.94 | 0.96 |
| −40° | C. | 0.77 | 0.81 | 0.85 |
| −45° | C. | 0.65 | 0.72 | 0.78 |
| −50° | C. | 0.38 | 0.48 | 0.69 |

It can be found from Table 5 above, FIG. 34A, FIG. 35A, and the like that each sample can achieve a charge capacity in a wide temperature range including temperatures below freezing and the charge capacities at −20° C., −40° C., and −45° C. satisfy higher than or equal to 50% of the charge capacity at 25° C. Furthermore, each sample can be charged even at −50° C., and the charge capacity of Sample 12_P at −50° C. also satisfies higher than or equal to 50% of the charge capacity at 25° C. It can also be found that Sample 11_I has a higher charge capacity at each ambient temperature than Sample 11_P. It can also be found that Sample 12_P has a higher charge capacity at each temperature than Sample 11_P. Thus, it can be found that a lithium-ion battery using the organic solvent of the electrolyte and the positive electrode active material of one embodiment of the present invention exhibits excellent charge characteristics in a wide temperature range including temperatures below freezing.

### <Discharge Characteristics>

In this example, while the ambient temperature at which Sample 11_P, Sample 11_I, and Sample 12_P (collectively referred to as each sample) were placed was decreased to 25° C., 0° C., −20° C., −40° C., −45° C., −50° C., −55° C., and −60° C. in this order, discharge capacities were measured at each ambient temperature in order to observe discharge capacities at temperatures below freezing. Note that charging was performed every time discharging was performed at each ambient temperature, and the ambient temperature at the time of the charging was set to 25° C. The above-described charging was performed by CC charging at a charge rate of 0.1 C until a termination voltage of 4.5 V, and then by CV charging at 4.5 V until a current value of 0.05 C. The above-described discharging was performed by CC discharging at a discharge rate of 0.1 C until a termination voltage of 2.5 V. In this example, 1 C was set equal to 200 mA/g (a current per positive electrode active material weight of 200 mA/g). The table below shows test conditions.

TABLE 16

| | | Termination | | |
|---|---|---|---|---|
| | Ambient temperature | voltage | Rate | Other |
| Charge | 25° C. | 4.5 V | 0.1 C | CC charging − |
| conditions | | | | CV charging |
| Discharge | 25° C., 0° C., −20° | 2.5 V | 0.1 C | CC discharging |
| conditions | C., −40° C., −45° | | | |
| | C., −50° C., −55° | | | |
| | C., −60° C. | | | |

FIG. 34B shows the results of discharge capacities per positive electrode active material weight (mAh/g) of Sample 11_P and Sample 11_I. The temperature shown on the horizontal axis in FIG. 34B is the ambient temperature under the discharge conditions in the above table. FIG. 35B shows the discharge curves of Sample 11_P and Sample 12_P at 25° C. and −40° C. The table below shows values obtained by normalizing the discharge capacity at each ambient temperature by the discharge capacity at 25° C. The normalized values may be expressed in percentage, and a normalized value of 0.5 is equal to 50%.

TABLE 17

| Ambient | | Value normalized by discharge capacity at 25° C. | | |
|---|---|---|---|---|
| temperature [° C.] | | Sample 11_P | Sample 11_I | Sample 12_P |
| 25° | C. | 1 | 1 | 1 |
| 0° | C. | 0.87 | 0.87 | 0.89 |
| −20° | C. | 0.78 | 0.78 | 0.80 |
| −40° | C. | 0.67 | 0.68 | 0.70 |
| −45° | C. | 0.65 | 0.65 | 0.68 |
| −50° | C. | 0.62 | 0.63 | 0.65 |
| −55° | C. | 0.57 | 0.59 | 0.62 |
| −60° | C. | 0.48 | 0.49 | — |

It can be found from Table 17 above, FIG. 34B, FIG. 35B, and the like that each sample can achieve a charge capacity in a wide temperature range including temperatures below freezing and the discharge capacities at −20° C. to −55° C. satisfy higher than or equal to 50% of the charge capacity at 25° C. Furthermore, each sample can be discharged even at −55° C. or −60° C. It can also be found that Sample 11_I has a higher discharge capacity at each ambient temperature than Sample 11_P. It can also be found that Sample 12_P has a higher charge capacity at each ambient temperature than Sample 11_P. Thus, it can be found that the lithium-ion battery using the organic solvent of the electrolyte and the positive electrode active material of one embodiment of the present invention exhibits excellent charge and discharge characteristics in a wide temperature range including temperatures below freezing.

### Example 5

In this example, Sample 11_P and Sample 12_P using the electrolyte of one embodiment of the present invention were subjected to high-temperature cycle performance measurement.

### <Cycle Performance>

In this example, the cycle performances of Sample 11_P and Sample 12_P were evaluated at high temperatures. The temperature of a thermostatic chamber in which Sample 11_P and Sample 12_P were placed (the ambient temperature) was controlled to any one of 25° C., 45° C., and 65° C., and their cycle performances were measured at each temperature. In this cycle test, 45° C. and 65° C. are included in high temperatures.

Charging in the cycle test was performed by CC charging at a charge rate of 0.5 C until a termination voltage of 4.5 V, and then by CV charging until a current of 0.05 C. After the CV charging, a break period was held for 10 minutes, and discharging was started. The discharging was performed by CC discharging at a discharge rate of 0.5 C until a termination voltage of 2.5 V. In this example, 1 C was set equal to 200 mA/g (a current per positive electrode active material weight of 200 mA/g).

A cycle of the above-described charging and discharging was repeated 50 times, and the value calculated by (the discharge capacity in the 50th cycle/the maximum value of the discharge capacity in the 50 cycles)×100 was referred to as discharge capacity retention rate (%) in the 50th cycle. In other words, in the case where a test of 50 repetitions of a cycle of charging and discharging was conducted and the discharge capacity in each cycle was measured, the proportion of the value of the discharge capacity measured in the 50th cycle with respect to the maximum value of the discharge capacity in all the 50 cycles (referred to as the maximum discharge capacity) was calculated as the discharge capacity retention rate (%). A higher discharge capacity retention rate is desirable as a battery characteristic because a reduction in battery capacity after repeated charging and discharging is inhibited.

In the cycle test, a current is actually measured, and the current is preferably measured by a four-terminal method. At the time of charging, electrons flow from a positive electrode terminal to a negative electrode terminal through a charge-discharge measuring instrument and thus, a charge current flows from the negative electrode terminal to the positive electrode terminal through the charge-discharge measuring instrument. At the time of discharging, electrons flow from the negative electrode terminal to the positive electrode terminal through the charge-discharge measuring instrument and thus, a discharge current flows from the positive electrode terminal to the negative electrode terminal through the charge-discharge measuring instrument. The charge current and discharge current are measured with an ammeter of the charge-discharge measuring instrument, the total amount of the current flowing during one charging step and the total amount of the current flowing during one discharging step respectively correspond to charge capacity and discharge capacity. For example, the total amount of the discharge current flowing during the discharging in the first cycle can be regarded as the discharge capacity in the first cycle, and the total amount of the discharge current flowing during the discharging in the 50th cycle can be regarded as the discharge capacity in the 50th cycle.

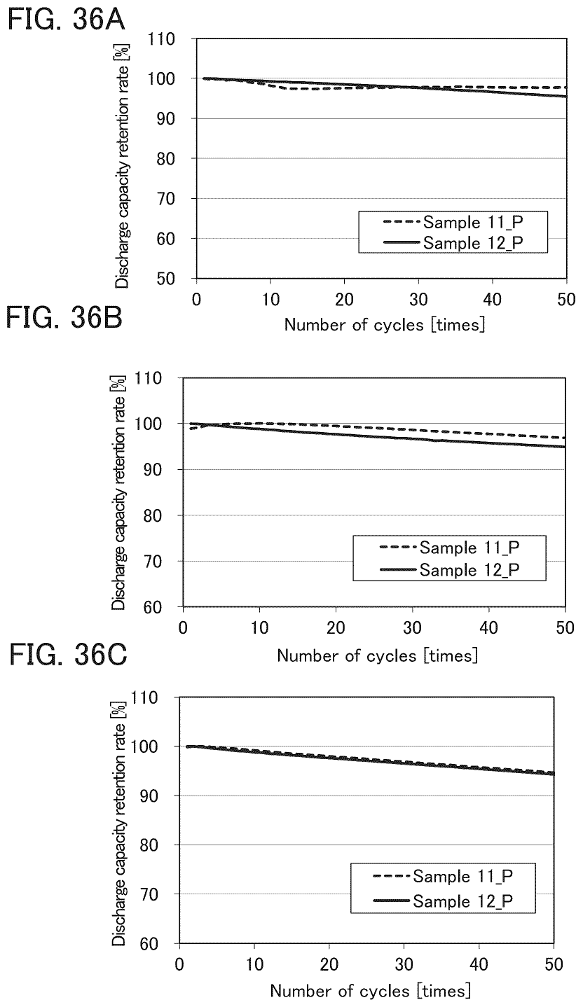

FIG. 36A, FIG. 36B, and FIG. 36C respectively show the discharge capacity retention rate at the ambient temperature of 25° C., the discharge capacity retention rate at the ambient temperature of 45° C., and the discharge capacity retention rate at the ambient temperature of 65° C. of Sample 11_P and Sample 12_P. In each graph, the horizontal axis represents the number of cycles (times) and the vertical axis represents the discharge capacity retention rate (%). It can be found that Sample 11_P and Sample 12_P have discharge capacity retention rates higher than or equal to 85%, preferably higher than or equal to 90% at each temperature, particularly at high temperatures, and exhibit favorable cycle performances. It can be found that lithium-ion batteries using Sample 11_P and Sample 12_P described above exhibit excellent battery characteristics in a wide temperature range from temperatures below freezing to high temperatures.

### Example 6

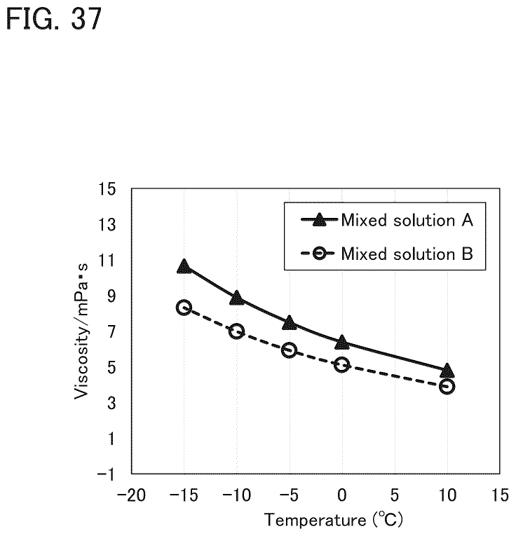

In this example, the viscosities of the mixed solution A used for Sample 1 and the like (the mixture of LiPF₆ at 1 mol/L with the mixed solvent of FEC:MTFP=2:8 (volume ratio)) and a mixed solution B with a different mixing ratio (a mixture of LiPF₆ at 1 mol/L with a mixed solvent of FEC:MTFP=1:9 (volume ratio)) were measured at −15° C., −10° C., −5° C., 0° C., 5° C., and 10° C. FIG. 37 shows the viscosity measurement results.

It can be found that the viscosity of the mixed solution B is lower than that of the mixed solution A at all the temperatures. A low viscosity leads to a high carrier ion conductivity, i.e., a high lithium ion conductivity; thus, like the mixed solution A, the mixed solution B probably exhibits excellent charge and discharge characteristics at a temperature below freezing and can be found to be suitable as the organic solvent of the electrolyte of one embodiment of the present invention. A lithium-ion battery using the mixed solution B and the positive electrode active material of one embodiment of the present invention probably exhibits excellent charge and discharge characteristics in a wide temperature range including temperatures below freezing.

### Example 7

Next, Sample 31 was prepared to examine the charge and discharge characteristics at low temperatures.

### <Electrolyte Solution of Sample 31>

As an electrolyte solution, the mixed solution A (the mixture of LiPF₆ at 1 mol/L with the mixed solvent of FEC:MTFP=2:8 (volume ratio)) and the mixed solution B (the mixture of LiPF₆ at 1 mol/L with the mixed solvent of FEC:MTFP=1:9 (volume ratio)) used in Example 6 described above were prepared. In addition, a mixed solution C (a mixture of LiPF₆ at 1 mol/L with a mixed solvent of FEC:MTFP=3:7 (volume ratio)) was prepared as an electrolyte solution. Sample 31 is referred to as Sample 31A, Sample 31B, and Sample 31C depending on the mixed solution.

<Positive electrode active material of Sample 31>

As a positive electrode active material, the same positive electrode active material as that of Sample 1 described above was prepared again.

### <Separator of Sample 31>

As a separator, PP was prepared.

The table below summarizes the conditions of the samples in this example.

TABLE 18

| | | | Positive | | |
|---|---|---|---|---|---|
| | | | electrode | Median | |
| | Organic solvent | | active | diameter | |
| | (volume ratio) | | material | (D50) | Separator |
| Sample | Mixed | FEC:MTFP = | LCO | Approx. | PP |
| 31A | solution A | 2:8 + LiPF₆ | containing | 12 μm | |
| Sample | Mixed | FEC:MTFP = | Mg, F, Ni, | | |
| 31B | solution B | 1:9 + LiPF₆ | and Al | | |
| Sample | Mixed | FEC:MTFP = | | | |
| 31C | solution C | 3:7 + LiPF₆ | | | |

### <Charge Characteristics>

In this example, while the ambient temperature at which Sample 31A, Sample 31B, and Sample 31C (collectively referred to as each sample) were placed was decreased to 25° C., 0° C., −20° C., −40° C., and −45° C. in this order, charge capacities were measured at each ambient temperature in order to observe charge capacities at temperatures below freezing. Note that discharging was performed every time charging was performed at each ambient temperature, and the ambient temperature at the time of the discharging was set to 25° C. The above-described charging was performed by CC charging at a charge rate of 0.1 C until a termination voltage of 4.5 V, and the above-described discharging was performed by CC discharging at a discharge rate of 0.1 C until a termination voltage of 2.5 V. In this example, 1 C was set equal to 200 mA/g (a current per positive electrode active material weight of 200 mA/g). The table below shows test conditions.

TABLE 19

| | | Termination | | |
|---|---|---|---|---|
| | Ambient temperature | voltage | Rate | Other |
| Charge | 25° C., 0° C., −20° | 4.6 V | 0.1 C | CC charging |
| conditions | C., −40° C., −45° C. | | | |
| Discharge | 25° C. | 2.5 V | 0.1 C | CC discharging |
| conditions | | | | |

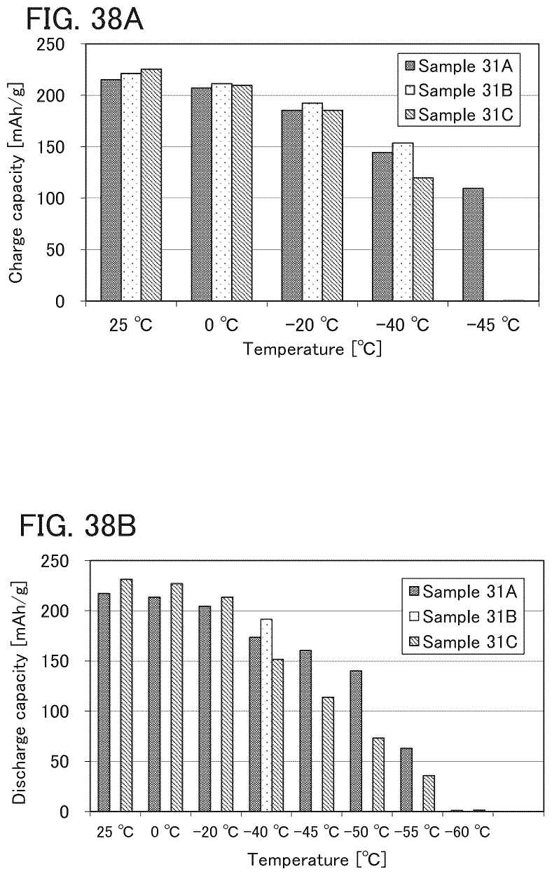

FIG. 38A shows the results of charge capacities per positive electrode active material weight (mAh/g) of Sample 31A, Sample 31B, and Sample 31C. The temperature shown on the horizontal axis in FIG. 38A is the ambient temperature under the charge conditions in the above table.

It can be found that each sample can achieve a charge capacity in a wide temperature range including temperatures below freezing and has a high charge capacity at each ambient temperature. Thus, it can be found that the lithium-ion battery using the organic solvent of the electrolyte and the positive electrode active material of one embodiment of the present invention exhibits excellent charge and discharge characteristics in a wide temperature range including temperatures below freezing regardless of the volume ratio of the organic solvent.

### <Discharge Characteristics>

In this example, while the ambient temperature at which Sample 31A, Sample 31B, and Sample 31C (collectively referred to as each sample) were placed was decreased to 25° C., 0° C., −20° C., −40° C., −45° C., −50° C., −55° C., and −60° C. in this order, discharge capacities were measured at each ambient temperature in order to observe discharge capacities at temperatures below freezing. Note that charging was performed every time discharging was performed at each ambient temperature, and the ambient temperature at the time of the charging was set to 25° C. The above-described charging was performed by CC charging at a charge rate of 0.1 C until a termination voltage of 4.6 V, and then by CV charging at 4.6 V until a current of 0.05 C. The above-described discharging was performed by CC discharging at a discharge rate of 0.1 C until a termination voltage of 2.5 V. In this example, 1 C was set equal to 200 mA/g (a current per positive electrode active material weight of 200 mA/g). The table below shows test conditions.

TABLE 20

| | | Termination | | |
|---|---|---|---|---|
| | Ambient temperature | voltage | Rate | Other |
| Charge conditions | 25° C. | 4.6 V | 0.1 C | CC charging − CV charging |
| Discharge conditions | 25° C., 0° C., −20° C., −40° C. −45° | 2.5 V | 0.1 C | CC discharging |
| | C., −50° C., −55° C., −60° C. | | | |

FIG. 38B shows the results of discharge capacities per positive electrode active material weight (mAh/g) of Sample 31A, Sample 31B, and Sample 31C. The temperature shown on the horizontal axis in FIG. 38B is the ambient temperature under the discharge conditions in the above table.

It can be found that each sample can achieve a discharge capacity in a wide temperature range including temperatures below freezing and has a high discharge capacity at each ambient temperature. Thus, it can be found that the lithium-ion battery using the organic solvent of the electrolyte and the positive electrode active material of one embodiment of the present invention exhibits excellent charge and discharge characteristics in a wide temperature range including temperatures below freezing regardless of the compounding ratio of the organic solvent.

### Example 8

### <Differential Scanning Calorimetry>

In this example, the mixed solution A used in Example 6 and the like described above (the mixture of LiPF₆ at 1 mol/L with the mixed solvent of FEC:MTFP=2:8 (volume ratio)) was subjected to measurement of the amount of heat with a differential scanning calorimeter (Thermo plus EVO2 DSC8231, a high-sensitivity differential scanning calorimeter produced by Rigaku Corporation). The amount of heat is derived from an exothermic peak and an endothermic peak. As a sample, 2.55 g of the mixed solution A was prepared, and the measurement conditions were set in the temperature range from room temperature to 500° C. Furthermore, a mixed solution D (a mixture of LiPF₆ at 1 mol/L with a mixed solvent of EC:DEC=3:7 (volume ratio)) was also subjected to measurement of the amount of heat.

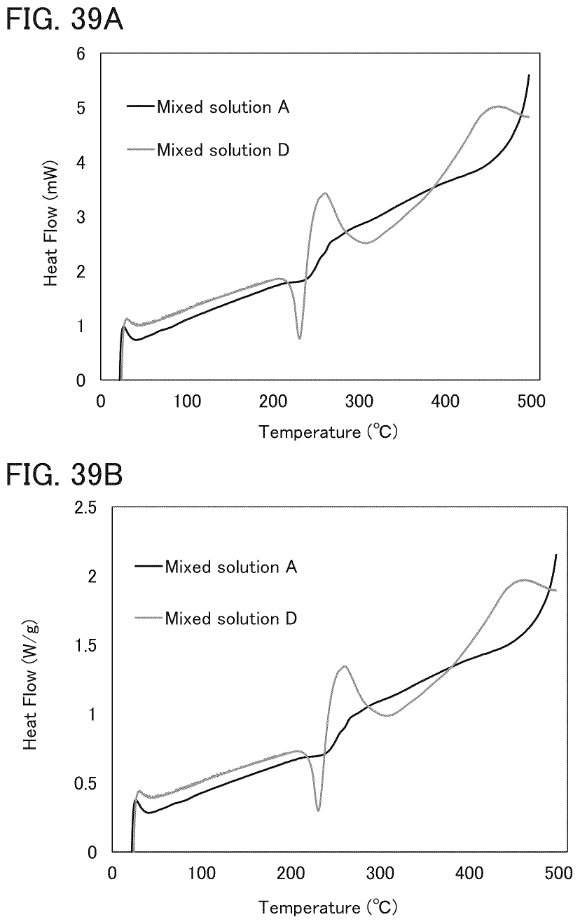

The table below shows the amounts of heat of the samples. FIG. 39A shows the amount of heat (Heat Flow, mW) as a function of the temperature, and FIG. 39B shows the amount of heat (Heat Flow, W/g) as a function of the temperature.

TABLE 21

| | | Amount of heat [J/g] | |
|---|---|---|---|
| | | Exothermic | Endothermic |
| Sample | | peak | peak |
| Mixed | FEC:MTFP = 2:8 + LiPF₆ | 34.103 | −17.269 |
| solution A | | | |
| Mixed | EC:DEC = 3:7 + LiPF₆ | 148.629 | −87.625 |
| solution D | | | |

It can be found from the differential scanning calorimetry that the amount of heat of the mixed solution A is smaller than that of the mixed solution D.

### Example 9

### <Nail Penetration Test>

In a nail penetration test, a nail having a predetermined diameter in the range of 2 mm to 10 mm penetrates a full cell in a fully charged state at a predetermined speed. In this example, a full cell was assembled using Sample 1-P as a positive electrode and spherical natural graphite as a negative electrode and was subjected to a nail penetration test. The table below shows the conditions of the full cell.

TABLE 22

| Positive | Active material | LCO (with added Mg, F, | |
|---|---|---|---|
| electrode | | Al, and Ni) | |
| | Loading amount | 9.9 | mg/cm² |
| | (per side) | | |
| | Current collector | Al/20 | μm |
| | material/thickness | | |
| Negative | Active material | Spherical natural graphite | |
| electrode | Loading amount | 6.9 | mg/cm² |
| | (per side) | | |
| | Current collector | Cu/18 | μm |
| | material/thickness | | |
| Separator | Material/thickness | PP/25 | μm |
| Electrolyte | Organic solvent | FEC:MTFP = 2:8 | |
| solution | Lithium salt | 1M LiPF₆ | |
| Cell | Number of stacked | 15 (double-side coating) | |
| structure | positive electrodes | | |
| | Number of stacked | 14 (double-side coating) + 2 | |
| | negative electrodes | outside (single-side coating) | |
| | Design capacity | 1200 | mAh |
| | Exterior body | Aluminum laminate | |
| | Injection amount of | 9 | mL |
| | electrolyte solution | | |
| Nail | Charge voltage | 4.5 | V |
| penetration | (in aging) | | |
| test | Charge voltage | 4.5 | V |
| | (in nail penetration) | | |

| | |
|---|---|
| Determination | No ignition |

The nail penetration test was performed using Advanced Safety Tester produced by ESPEC Corp. in an environment at room temperature, specifically 25° C. In the nail penetration test, a nail with a diameter of 3 mm was used, the nail penetration speed was 5 mm/s, and the nail penetration depth was 10 mm. The other conditions in the nail penetration test were compliant with SAE J2464, “Electric and Hybrid Electric Vehicle Rechargeable Energy Storage System (RESS) Safety and Abuse Testing”.

The loading amount of each active material can be calculated from the electrode as the weight of the active material layer obtained by subtracting the weights of the components other than the active material, e.g., the current collector, the conductive additive, the binder, and the thickener, from the weight of the electrode. The weight of the active material is obtained by identifying the compounding ratio between the active material, the conductive additive, the binder, the thickener, and the like included in the active material layer. As an example of a specific procedure, portions having the same area are taken out from a first region of the current collector alone not coated with the active material layer and a second region of a stack of the active material layer and the current collector coated with the active material layer, and then the weights of these portions are measured. The difference between the weights indicates the weight of the active material layer. Then, the compounding ratio between the active material, the conductive additive, the binder, and the thickener is identified, whereby the weight of the active material can be found. The weight of the active material is divided by the area of the taken portion, whereby the loading amount of the active material can be obtained.

In this specification and the like, ignition in a nail penetration test refers to a state where fire is observed outside an exterior body within one minute of nail penetration or a state where thermal runaway of a secondary battery has occurred within one minute of nail penetration. As a result of the nail penetration test, the full cell using Sample 1-P as the positive electrode was determined to have no ignition. It has been found from the above-described results of the differential thermal analysis that the amount of heat of the mixed solution A (the mixture of LiPF₆ at 1 mol/L with the mixed solvent of FEC:MTFP=2:8) is small. It can be considered that the full cell using Sample 1-P as the positive electrode includes such a mixed solvent with a small amount of heat generation and thus has no ignition in the nail penetration test.

### Example 10

It has been found from the above-described results of the AC impedance measurement in Example 3 that Sample 1 shows smaller R_{LF} values than Reference Example 1 at both of the ambient temperatures of −40° C. and 25° C. In this example, the likelihood of diffusion of lithium ions serving as carrier ions was analyzed at the surface of lithium cobalt oxide.

The electrolyte of Sample 1 includes a chain-shaped molecule and a ring-shaped molecule; attention is focused on FEC, which is a ring-shaped molecule, to make a comparison with EC, which is a cyclic molecule, of the electrolyte of Reference Example 1.

The table below shows calculation software and calculation conditions.

TABLE 23

| Software | VASP | |
|---|---|---|
| Functional | GGA + U (DFT-D2) | |
| Pseudo-potential | PAW | |
| Cut-off energy | 600 | |
| (eV) | | |
| U potential | Co | 4.91 |

| | |
|---|---|
| Number of atoms | Li: 47, Co: 48, O: 96, |
| | EC: 1 molecule or FEC: 1 molecule |
| k-points | 1 × 1 × 1 |
| Calculation | Calculation of activation barrier for lithium ion |
| target | diffusion by NEB (Nudged Elastic Band) method |

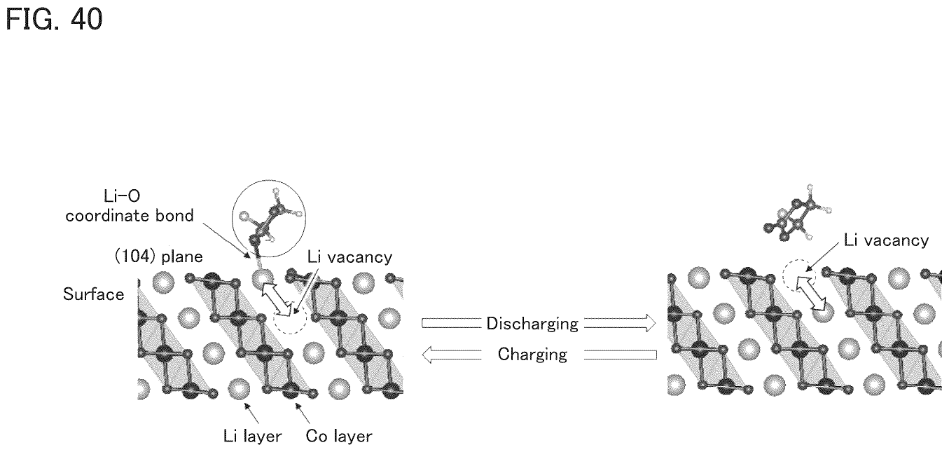

As a calculation model, a model of lithium cobalt oxide cut along the (104) plane was used, and a state where one ring-shaped molecule is adsorbed on the surface and the molecule is interacted with a lithium ion is illustrated in the left diagram of FIG. 40. The left diagram of FIG. 40 is referred to as an initial state. A state where the lithium ion has diffused to a vacancy in lithium cobalt oxide is illustrated in the right diagram of FIG. 40. The right diagram of FIG. 40 is referred to as a final state. From the initial state to the final state, lithium ions diffuse to the inside, which corresponds to discharging. From the final state to the initial state, lithium ions diffuse to the surface, which corresponds to charging.

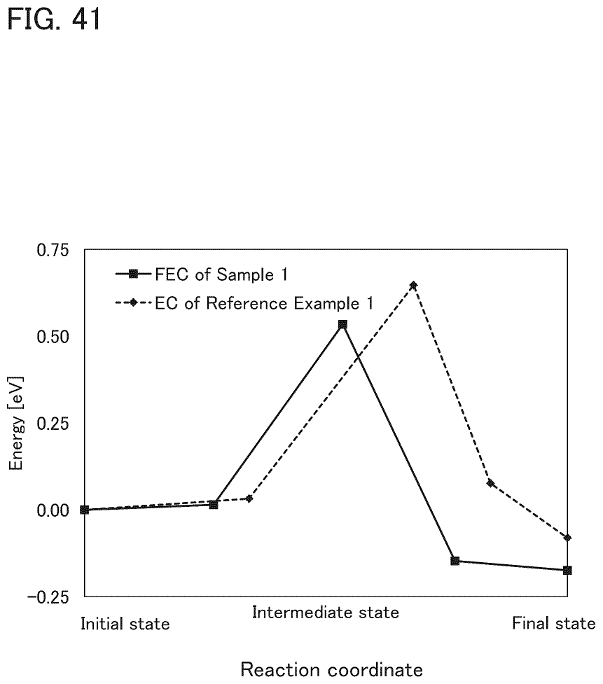

FIG. 41 shows the energies (eV) of the activation barrier for lithium ion diffusion on the (104) plane of lithium cobalt oxide in the initial state in the left diagram of FIG. 40, the final state in the right diagram of FIG. 40, and an intermediate state therebetween. The table below shows the activation barrier for lithium ion diffusion in each state.

TABLE 24

| | FEC | EC |
|---|---|---|
| Activation barrier [eV] in discharging | 0.53 | 0.65 |
| Activation barrier [eV] in charging | 0.71 | 0.73 |

As is clear from FIG. 41, FEC has a lower energy than EC in the intermediate state, and it can be found that this enables FEC to have a lower activation barrier for lithium ion diffusion in discharging by 0.12 eV and to be more likely to allow lithium ion diffusion. This can be considered to be also affected by the likelihood of cutting a Li-O coordinate bond formed in the initial state. In FEC, fluorine withdraws an electron of oxygen coordinated to a lithium ion, so that the Li-O coordinate bond is likely to be cut. In addition, a difference in the activation barrier for lithium ion diffusion in charging is small.

It can be found from this calculation result that FEC is more likely to allow lithium ions to diffuse from the surface to the inside of lithium cobalt oxide in discharging. It can be found that FEC with a low activation barrier for lithium ion diffusion is preferably used as the electrolyte at a low temperature such as a temperature below freezing.

### REFERENCE NUMERALS

10: positive electrode active material, 11: primary particle, 12a: secondary particle, 12b: secondary particle, 12: secondary particle, 13: space, 14: interface, 100: lithium-ion battery, 101: negative electrode current collector, 102: negative electrode active material layer, 104: positive electrode active material layer, 105: positive electrode current collector, 106: negative electrode, 107: positive electrode, 108: separator, 109: electrolyte

1. A lithium-ion battery comprising:
a positive electrode comprising a positive electrode active material; and an electrolyte,
wherein the positive electrode active material comprises a lithium cobalt oxide comprising magnesium, fluorine, nickel, and aluminum, and
wherein the electrolyte comprises a fluorinated cyclic carbonate and a fluorinated chain carbonate.

2. A lithium-ion battery comprising:
a positive electrode comprising a positive electrode active material; and an electrolyte,
wherein the positive electrode active material comprises a lithium cobalt oxide comprising magnesium, fluorine, nickel, and aluminum,
wherein the electrolyte comprises fluoroethylene carbonate and methyl trifluoropropionate, and
wherein a volume ratio of the fluoroethylene carbonate to the methyl trifluoropropionate is x:100−x when a total content of the fluoroethylene carbonate and the methyl trifluoropropionate is 100 vol % and the x is greater than or equal to 5 and less than or equal to 30.

3. The lithium-ion battery according to claim 1,
wherein the lithium cobalt oxide is represented by LiₓCoO₂,
wherein the lithium cobalt oxide has a layered rock-salt crystal structure belonging to a space group R-3m when x in the LiₓCoO₂ is 1, and
wherein the lithium cobalt oxide has a crystal structure of a space group P2/m with a lattice constant a=0.488±0.001 nm, a lattice constant b=0.282±0.001 nm, a lattice constant c=0.484±0.001 nm, α=90°, β=109.58±0.01°, and γ=90° when the x in the LiₓCoO₂ is greater than 0.1 and less than or equal to 0.24.

4. The lithium-ion battery according to claim 1,
wherein the lithium cobalt oxide is represented by LiₓCoO₂,
wherein the lithium cobalt oxide has a layered rock-salt crystal structure belonging to a space group R-3m when x in the LiₓCoO₂ is 1, and
wherein the lithium cobalt oxide has a diffraction peak at least at 2θ of greater than or equal to 19.37° and less than or equal to 19.57° and 2θ of greater than or equal to 45.570 and less than or equal to 45.67° when the x in the LiₓCoO₂ is greater than 0.1 and less than or equal to 0.24 and the lithium cobalt oxide is analyzed by X-ray diffraction.

5. The lithium-ion battery according to claim 1,
wherein a median diameter (D50) of the lithium cobalt oxide is greater than or equal to 10 μm and less than or equal to 14 μm.

6. The lithium-ion battery according to claim 1,
wherein a median diameter (D50) of the lithium cobalt oxide is greater than or equal to 5 μm and less than or equal to 9 μm.

7. A lithium-ion battery comprising;
a positive electrode active material comprising a lithium cobalt oxide comprising magnesium, fluorine, nickel, and aluminum; and an electrolyte comprising a fluorinated cyclic carbonate and a fluorinated chain carbonate,
wherein a discharge capacity value obtained by preparing a half cell comprising a positive electrode comprising the positive electrode active material, the electrolyte, and a counter electrode comprising lithium metal, placing the half cell at an ambient temperature of 25° C., performing constant current charging at a rate of 0.1 C until a voltage of 4.6 V, performing constant voltage charging at 4.6 V until a current value of 0.05 C, placing the half cell at an ambient temperature of −40° C., and performing constant current discharging at the rate of 0.1 C until a voltage of 2.5 V is greater than or equal to 50% of a discharge capacity value obtained by placing the half cell at the ambient temperature of 25° C., performing the constant current charging at the rate of 0.1 C until the voltage of 4.6 V, performing the constant voltage charging at 4.6 V until the current value of 0.05 C, and performing the constant current discharging at the rate of 0.1 C until the voltage of 2.5 V, and wherein 1 C is equal to 200 mA/g.

8. A lithium-ion battery comprising;
a positive electrode comprising a positive electrode active material comprising a lithium cobalt oxide comprising magnesium, fluorine, nickel, and aluminum; and an electrolyte,
wherein the electrolyte comprises fluoroethylene carbonate and methyl trifluoropropionate,
wherein a volume ratio of the fluoroethylene carbonate to the methyl trifluoropropionate is x:100−x when a total content of the fluoroethylene carbonate and the methyl trifluoropropionate is 100 vol % and the x is greater than or equal to 5 and less than or equal to 30,
wherein a discharge capacity value obtained by preparing a half cell comprising the positive electrode, the electrolyte, and a counter electrode comprising lithium metal, placing the half cell at an ambient temperature of 25° C., performing constant current charging at a rate of 0.1 C until a voltage of 4.6 V, performing constant voltage charging at 4.6 V until a current value of 0.05 C, placing the half cell at an ambient temperature of −40° C., and performing constant current discharging at the rate of 0.1 C until a voltage of 2.5 V is greater than or equal to 50% of a discharge capacity value obtained by placing the half cell at the ambient temperature of 25° C., performing the constant current charging at the rate of 0.1 C until the voltage of 4.6 V, performing the constant voltage charging at 4.6 V until the current value of 0.05 C, and performing the constant current discharging at the rate of 0.1 C until the voltage of 2.5 V, and
wherein 1 C is equal to 200 mA/g.

9. A lithium-ion battery comprising:
a positive electrode active material comprising nickel, cobalt, and manganese; and an electrolyte comprising a fluorinated cyclic carbonate and a fluorinated chain carbonate,
wherein a discharge capacity value obtained by placing a half cell comprising a positive electrode comprising the positive electrode active material, the electrolyte, and a counter electrode comprising lithium metal at an ambient temperature of 25° C., performing constant current charging at a rate of 0.1 C until a voltage of 4.5 V, performing constant voltage charging at 4.5 V until a current value of 0.05 C, placing the half cell at an ambient temperature of −40° C., and performing constant current discharging at the rate of 0.1 C until a voltage of 2.5 V satisfies greater than or equal to 50% of a discharge capacity value obtained by placing the half cell at the ambient temperature of 25° C., performing the constant current charging at the rate of 0.1 C until the voltage of 4.5 V, performing the constant voltage charging at 4.5 V until the current value of 0.05 C, and performing the constant current discharging at the rate of 0.1 C until the voltage of 2.5 V, and
wherein 1 C is equal to 200 mA/g.

10. A lithium-ion battery comprising:
a positive electrode active material comprising nickel, cobalt, and manganese; and an electrolyte,
wherein the electrolyte comprises fluoroethylene carbonate and methyl trifluoropropionate,
wherein a volume ratio of the fluoroethylene carbonate to the methyl trifluoropropionate is x:100−x when a total content of the fluoroethylene carbonate and the methyl trifluoropropionate is 100 vol % and the x is greater than or equal to 5 and less than or equal to 30,
wherein a discharge capacity value obtained by placing a half cell comprising a positive electrode comprising the positive electrode active material, the electrolyte, and a counter electrode comprising lithium metal at an ambient temperature of 25° C., performing constant current charging at a rate of 0.1 C until a voltage of 4.5 V, performing constant voltage charging at 4.5 V until a current value of 0.05 C, placing the half cell at an ambient temperature of −40° C., and performing constant current discharging at the rate of 0.1 C until a voltage of 2.5 V satisfies greater than or equal to 50% of a discharge capacity value obtained by placing the half cell at the ambient temperature of 25° C., performing the constant current charging at the rate of 0.1 C until the voltage of 4.5 V, performing the constant voltage charging at 4.5 V until the current value of 0.05 C, and performing the constant current discharging at the rate of 0.1 C until the voltage of 2.5 V, and
wherein 1 C is equal to 200 mA/g.

11. The lithium-ion battery according to claim 9,
wherein a ratio of nickel:cobalt:manganese in the positive electrode active material satisfies 8:1:1 or a neighborhood thereof.

12. The lithium-ion battery according to claim 9,
wherein a proportion of nickel is higher than a proportion of cobalt and a proportion of manganese in the positive electrode active material.

13. The lithium-ion battery according to claim 9,
wherein a median diameter (D50) of the positive electrode active material is greater than or equal to 4 μm and less than or equal to 7 μm.

14. The lithium-ion battery according to claim 9,
wherein a separator of the half cell comprises polyimide.

15. The lithium-ion battery according to claim 9,
wherein a separator of the half cell comprises polypropylene.
